(19) United States
(12) Patent Application Publication
(10) Pub. No.: US 2026/0170125 A1
(43) Pub. Date: Jun. 18, 2026

(54) SYSTEM AND METHODS FOR PROVABLY SECURE HIGH-ASSURANCE HARDWARE SOFTWARE CO-DESIGN

(71) Applicant: Uberspark Inc., Aledo, TX (US)

(72) Inventors: Amit Vasudevan, Aledo, TX (US); Michael J McCall, Pittsburgh, PA (US); Ajit Vasudevan, San Jose, CA (US)

(73) Assignee: Uberspark Inc., Aledo, TX (US)

(21) Appl. No.: 19/422,978

(22) Filed: Dec. 17, 2025

Related U.S. Application Data
(60) Provisional application No. 63/734,798, filed on Dec. 17, 2024.

(51) Int. Cl. G06F 21/55; G06F 21/62

(52) U.S. Cl. CPC G06F 21/55; G06F 21/62; G06F 2221/034

(57) ABSTRACT

Systems and methods are disclosed for modular, provably secure, high-assurance hardware and software co-design. The disclosed technology enables mathematically proven secure execution and communication pathways on safety-critical mission platforms by integrating both hardware and software layers. A modular architecture enforces foundational security properties, including memory safety, memory integrity, control-flow integrity, privilege separation, and non-interference, within a trusted path. The system supports secure execution of low-level privileged instructions and hardware device accesses, facilitating cyber-physical system sensing, mission processing, and actuation, while maintaining compatibility with legacy systems and supporting full-stack verification. Applications include information assurance for safety-critical domains such as healthcare, transportation, energy, and finance, ensuring that safety-critical code and communications execute without adversarial involvement.

### RELATED APPLICATIONS

This application claims the benefit under 35 U.S.C. 119(e) of U.S. Provisional Application No. 63/734,798 filed on Dec. 17, 2024, which is incorporated herein in its entirety.

### TECHNICAL FIELD

The present disclosure relates to at least the field of design of computer platforms including cybersecurity.

### BACKGROUND ART

The subject matter discussed in the background section should not be considered prior art merely because of its mention in the background section. Similarly, a problem mentioned in the background section or associated with the subject matter of the background section should not be considered to have been previously recognized in the prior art. The subject matter in the background section merely represents different approaches, which in and of themselves, may also correspond to claimed embodiments.

The current landscape of high-assurance operating systems and formally verified software is marked by a proliferation of fragmented solutions. Hardware-based security approaches, such as Intel's SGX, TXT, and Vt-x have made significant strides in implementing complex OS principles and protection logic directly within silicon. These approaches have been commercially available for some time, with notable examples including the 2014 release of a commercial microcontroller with a simple hardware-based operating system by Renesas.

On the other hand, formally verified software solutions such as SFI, Singularity, and seL4 have provided impressive feats of formal verification, taking around 20 person-years to mathematically verify that an OS kernel implementation matches a given specification. However, these current solutions come with significant shortcomings.

Hardware-based security approaches are prone to attacks faced by pure software but now in unchangeable silicon, rendering them vulnerable to various forms of exploitation. Furthermore, formally verified software solutions such as seL4 lack support for low-level privileged instructions and hardware device accesses, which is crucial for cyber physical system sensing, mission processing, and actuation functionality.

Additionally, these approaches often sacrifice legacy compatibility with a complete redesign of an OS in type-safe languages. Full-stack verification approaches, on the other hand, verify the entire OS, applications, and in some cases, the hardware platform. However, they come with their own set of drawbacks, including the adoption of esoteric instruction sets that lack support for tooling and co-existence with unverified components.

The unsustainable “Perimeter, Patch, Pray” Information Assurance strategy has become impractical for fielded safety-critical systems due to critical cyber vulnerabilities. Embedded system designs are typically based on commodity hardware and software optimized exclusively for size, weight, and power, leading to these cyber vulnerabilities.

It is therefore the objective of the present invention to develop a revolutionary approach to mathematically proven secure execution and communication pathways on existing safety-critical mission platforms, encompassing both the hardware and the software layers. This objective aims to provide a modular provably secure high-assurance hardware and software co-design system that ensures foundational security properties such as memory safety, control-flow integrity, and privilege-separation in a trusted path where safety-critical code and communications can execute without any adversarial involvement.

In U.S. Pat. No. 8,627,414 issued Jan. 7, 2014, inventors McCune et al. disclose a computer including a processor and a verification device. The processor in the computer performs the steps of authenticating a secure connection between a hypervisor and the verification device, measuring the identity of at least a portion of a select guest before the select guest executes any instruction, and sending a measurement of the identity of the select guest to the verification device. The verification device compares the policy stored in the verification device with the measurement of the select guest received by the verification device. The steps of authenticating, measuring, sending, and comparing are performed after receiving a signal indicative of a request to execute the selected guest and without rebooting the computer.

In U.S. Pat. No. 12,093,367 issued Sep. 17, 2024, inventor Amit Vasudevan discloses a system architecture that structures commodity heterogeneous interconnected computer platforms around universal object abstractions, which are a fundamental system abstraction and building block that provides practical and provable end-to-end guarantees of security, correctness, and timeliness for the platform.

In U.S. Pat. No. 12,367,328 issued Jul. 22, 2025, the entirety of which is incorporated herein by reference, inventors Amit Vasudevan et al., disclose systems and methods for mathematical modeling of the hardware and software stack of commodity computer platforms. The mathematical model provides provable guarantees on memory, device, and program execution. This approach addresses the technical problem of reliance on system agents that rely on implicit trust in the operating environment, which can be exploited by sophisticated attackers using complex threats such as memory access exploits and code/data integrity exploits. The solution provides a proactive, mathematically-backed security solution that eliminates entire classes of cyberattacks by design, ensuring provable guarantees on commodity computer platforms running hardware and software stack elements at the lowest operating level. This approach has significant advantages over reactive cybersecurity methods, including reduced complexity and overhead, and increased confidence in the integrity of the system. The solution's main uses include providing mathematically-backed security and availability guarantees for critical infrastructure, financial institutions, and other organizations vulnerable to cyberattacks.

In U.S. patent application Ser. No. 19/254,764 filed on Jun. 30, 2025, the entirety of which is incorporated herein by reference, inventors Amit Vasudevan et al., disclose systems and methods for providing unforgeable telemetry on computer platforms. Mathematical modeling and theorem proving are utilized to guarantee the integrity of telemetry probe execution flow and trigger, thereby preventing circumvention and tampering of logged probe data. In contrast to current state-of-the-art solutions that rely implicitly on the operating environment, this approach provides a sound and complete assurance of telemetry output. The system enables organizations to map unforgeable telemetry probe data to industry and government cybersecurity regulatory controls, ensuring compliance therewith. This invention addresses the shortcomings of existing solutions, including their vulnerability to sophisticated attacks, operational complexity, and inability to provide unforgeable telemetry data, thereby providing a reliable and accurate monitoring output in the presence of cyberattacks on computer platforms.

### SUMMARY

A system and method are disclosed for modular provably secure high-assurance hardware software co-design. The present invention addresses the shortcomings of current high-assurance operating systems and formally verified software by providing a novel approach to mathematically proven secure execution and communication pathways on existing safety-critical mission platforms, encompassing both the hardware and software layers. A modular framework is provided that ensures foundational security properties such as memory safety, memory integrity, control-flow integrity, and privilege-separation in a trusted path where safety-critical code and communications can execute without any adversarial involvement. This approach allows for safe execution of low-level privileged instructions and hardware device accesses, essential for cyber physical system sensing, mission processing, and actuation functionality, while also ensuring legacy compatibility and enabling full-stack verification approaches.

A first aspect relates to a system comprising (I) a set of hardware program execution elements (HWPEEs) for enforcing a trusted path security mechanism; (II) a computer platform having programmable hardware implemented as at least one processor by a first subset of the HWPEEs, the first subset of HWPEEs defining internal functionality and operations of the at least one processor; and at least one non-transitory computer-readable storage medium having stored thereon a set of program execution elements (PEEs), each PEE having a respective privilege level and a respective memory address space, the set of PEEs including the set of HWPEEs; and (III) a mathematical model of the computer platform, the mathematical model having a formal representation of the at least one processor, the at least one non-transitory computer-readable storage medium, and the set of PEEs; and defining and proving the trusted path security mechanism for the set of PEEs, the trusted path security mechanism enforcing permitted patterns of operations of the computer platform, the operations of the computer platform including at least one of (i) memory access operations; (ii) operations of the at least one processor including at least execution of processor instructions; and (iii) operations involving access to and manipulation of a state of the at least one processor (“processor state”), a state of the at least one non-transitory computer-readable storage medium (“memory state”), or a peripheral state.

In some embodiments of the system, the computer platform further comprises at least one peripheral implemented by a second subset of HWPEEs defining internal functionality and operations of the at least one peripheral, the first and second subsets of HWPEEs may overlap in whole or in part; the mathematical model further includes a formal representation of the at least one peripheral; the operations of the computer platform further include (iv) peripheral access operations; and the peripheral state is the state of the at least one peripheral.

In some embodiments of the system, the trusted path security mechanism comprises a privilege-separation mechanism that enforces access controls on the operations of the computer platform that involve peripheral access or the peripheral state; and the access controls ensure that each of said operations of the computer platform is executed with a respective required privilege level. In some embodiments, the privilege-separation mechanism is implemented using a subset of the set of PEE.

In some embodiments of the system, the set of PEEs further includes a set of software PEEs (SWPEEs) for enforcing the trusted path security mechanism, each SWPEE executable by the at least one processor.

In some embodiments of the system, the trusted path security mechanism comprises a privilege-separation mechanism that enforces access controls on the operations of the computer platform that involve access to and manipulation of the processor state or the memory state; and the access controls ensure that each of said operations of the computer platform is executed with a respective required privilege level.

In some embodiments of the system, the set of PEEs includes a first subset of PEEs and a second subset of PEEs; and the access controls enforced by the privilege-separation mechanism further comprise an access control policy; a caller PEE to initiate a privileged operation, the caller PEE in the first subset of PEEs and the respective memory address space of the caller PEE being a caller memory address space; a callee PEE to perform the privileged operation, the callee PEE in the second subset of PEE and the respective memory address space of the callee PEE being a callee memory address space; and an access control matrix utilized by the access controls to enforce caller PEE—callee PEE access control by allowing or denying calls per the access control policy.

In some embodiments of the system, the privilege separation mechanism is implemented using a subset of the set of PEE.

In some embodiments of the system, the operations of the computer platform include the memory access operations; and the trusted path security mechanism includes a memory-safety mechanism to ensure that all the memory access operations are valid.

In some embodiments, the at least one non-transitory computer-readable storage medium includes allocated memory; and the memory-safety mechanism has (i) a spatial memory safety mechanism to control memory layout and memory access boundaries and to ensure that the memory accesses operations are within valid bounds, and (ii) a temporal memory safety mechanism to ensure that the memory access operations are consistent with respect to a lifetime and state of the allocated memory.

In some embodiments, the spatial memory safety mechanism enforces memory protections for a subset of PEEs within the set of PEEs by utilizing (i) capabilities provided by a second subset of the set of HWPEEs to set guard memory regions and global offset table (GOT) as read-only, and/or (b) software-based verification and/or software fault isolation enforced within code of the PEEs within the subset of PEEs to set the guard memory regions and GOT as read-only (the first subset of HWPEEs and the second subset of HWPEEs may overlap in whole or in part).

In some embodiments, the spatial memory safety mechanism adds guard memory regions preceding and succeeding PEE global data variables for a subset of PEEs within the set of PEEs and enforces memory protections by utilizing (a) capabilities provided by a subset of the set of HWPEEs, within a higher-privileged PEE outside the subset of PEEs to set the guard memory regions as read-only, the higher-privileged PEE having a higher privilege level than any of the PEEs in the subset of PEEs; and/or (b) software-based verification and/or software fault isolation enforced within code of the PEEs within the subset to set the guard memory regions as read-only.

In some embodiments, the spatial memory safety mechanism has a data bounds safety mechanism for a subset of PEEs within the set of PEEs; and the data bounds safety mechanism (i) associates each of a plurality of PEE variables with information about size and alignment of said PEE variable and (ii) emits runtime checks in a PEE code region to ensure access to said PEE variables are always within the valid bounds.

In some embodiments, the temporal memory safety mechanism further comprises a heap safety mechanism to monitor allocations, deallocations and protection of pre-defined memory regions. In some embodiments, a total memory address space is a union of each of the respective memory address spaces of the PEEs in the set of PEEs; and the heap safety mechanism comprises (i) one or more heap manager PEEs in the set of PEEs to manage memory mappings within the total memory address space; (ii) said one or more heap manager PEEs execute at one or more privilege levels; and (iii) said one or more heap manager PEEs each have one or more functions that enforces memory protection against heap allocation and deallocation attacks. in some embodiments, the one or more functions are implemented using at least one of capabilities provided by (i) a second subset of the set of HWPEEs, (ii) software verification, and (iii) software fault isolation. When the one or more functions are implemented using at least the second subset of the set of HWPEEs, the first subset of HWPEEs and the second subset of HWPEEs may overlap in whole or in part.

In some embodiments of the system, the trusted path security mechanism comprises a control-flow integrity (CFI) mechanism to ensure that execution of PEEs follows the permitted patterns.

In some embodiments, a first PEE in the set of PEEs executes a sequence of operations including at least one of (i) hardware operations; and (ii) software operations, including execution of processor instructions; and the CFI mechanism comprises a code-safety mechanism to ensure that the executed sequence of operations is immutable and does not permit unauthorized modification in the first PEE's memory address space or a hardware state of the first PEE; and a stack-safety mechanism to enforce integrity of an execution context for the first PEE, including preservation of state information, the state information selected from the group consisting of processor stack state, micro-program stack state, finite state machine states, combinatorial logic outputs, return addresses, loop counters, and other control-flow data.

In some embodiments, the code-safety mechanism enforces memory protections for a subset of PEEs within the set of PEEs by utilizing (i) configuration of capabilities provided by a subset of the set of HWPEEs, within a higher-privileged PEE outside the subset of PEEs to set PEE code memory regions as read-only, the higher-privileged PEE having a higher privilege level than any of the PEEs in the subset of PEEs; and/or (ii) software-based verification and/or software fault isolation enforced within code of PEEs within the subset to set the PEE code memory regions as read-only.

In some embodiments, the stack-safety mechanism comprises a forward-edge CFI mechanism to ensure that a next operation in the sequence of operations is valid and authorized; and a backward-edge CFI mechanism to ensure that any return or restoration of a prior state occurs to a valid and authorized operation.

In some embodiments, the set of PEEs includes at least one additional PEE; the sequence of operations executed by the first PEE includes a control-transfer operation; the set of PEEs interacts with an external entity; and the forward-edge CFI mechanism further validates that a target operation or location to which the control-transfer operation transfers control (i) is within a valid region of the first PEE's memory or state space, including (a) a region containing executable code, (b) a region associated with a valid function, or (c) an interface to the external entity; (ii) meets alignment requirements; and (iii) matches an expected signature or pattern.

In some embodiments, the backward-edge CFI mechanism further validates that a target operation or location to which a first return or restoration operation transfers control (i) is within a valid first region of the first PEE's memory or state space containing executable code, (ii) meets alignment requirements, (iii) follows a prior control-transfer operation that invoked a target function, and (iv) is associated with a validation token that matches an expected pattern, including a hash value or other signature, of a prototype or template of the target function; and the first return or restoration operation is among the operations that transfer control back to a prior state.

In some embodiments, the backward-edge control-flow integrity (CFI) mechanism comprises a meta-stack mechanism to ensure that every executable unit in a Program Execution Element (PEE) among the set of PEEs (i) maintains separate storage for local data and control-flow information, (ii) uses the control-flow information storage to manage return or restoration operations, and (iii) uses the local data storage to manage access to local variables.

In some embodiments, the backward-edge CFI mechanism further comprises a stack-frame protection mechanism to ensure that each executable unit in a second PEE among the set of PEEs (i) stores a unique token at a predefined location within a local storage area associated with the respective executable unit, and (ii) verifies that the stored token remains unchanged before completing execution of the respective executable unit; and the second PEE is not required to be different from the first PEE.

In some embodiments, the forward edge CFI mechanism and backward edge CFI mechanism are implemented using at least one of (i) capabilities provided by a second subset of the set of HWPEEs, and (ii) software verification and/or software fault isolation, and when the forward edge CFI mechanism and backward edge CFI mechanism are implemented using at least the capabilities provided by the second subset of the set of HWPEEs, the first subset of HWPEEs and the second subset of HWPEEs may overlap in whole or in part. In some embodiments, the forward edge CFI mechanism and backward edge CFI mechanism are implemented on PEE code.

In some embodiments of the system, the set of PEEs includes a first PEE and a second PEE having first and second privilege levels, respectively, the first privilege level being a higher privilege level than the second privilege level; and the first PEE utilizes a first memory address space and the second PEE utilizes a second memory address space different from the first memory address space.

In some embodiments of the system, the mathematical model (i) defines operational aspects of hardware elements and software stack elements, (ii) defines predicates for security mechanisms on the computer platform that are translatable to proof obligations in a composable manner, and (iii) interprets and verifies the proof obligations; the hardware elements comprise a first subset of the set of PEEs; and the software stack elements comprise a second subset of the set of PEEs, the second subset not including any PEE in the set of HWPEEs.

In some embodiments of the system, a first subset of the set of PEEs are implemented in a low-level programming language; a second subset of the set of PEEs are implemented in a high-level programming language; the PEEs in the first subset enforce the trusted path security mechanism; and the PEEs in the second subset enforce the trusted path security mechanism.

In some embodiments of the system, the mathematical model (i) defines a first subset of the set of PEEs that are implemented in a low-level programming language; (ii) defines a second subset of the set of PEEs that are implemented in a high-level programming language; and (iii) defines and proves the trusted path security mechanism of the union of the PEEs of the first subset and the PEEs in the second subset.

In some embodiments of the system, the at least one non-transitory computer-readable storage medium has stored thereon the mathematical model.

In some embodiments of the system, each PEE in a subset of the set of PEEs includes one or more functions to form an atomic unit of functionality of the PEE; and a memory map in the respective memory address space, the memory map comprising one or more of the group consisting of code regions, global data variables, heaps, and stacks; the memory map is randomized at a time the respective PEE is loaded into its respective memory address space.

In some embodiments of the system, each PEE in the subset of the set of PEEs further includes operational semantics for the one or more functions, the operational semantics comprising one or more of the group consisting of semantics for reading and writing to global variables, stack, and heap; allocating and freeing heaps; calling other functions within the respective PEE; calling functions of another PEE; and returning to a parent PEE function.

A second aspect realtes to a system comprising (I) a set of hardware program execution elements (HWPEEs); (II) a computer platform having programmable hardware implemented as at least one processor by a first subset of the HWPEEs, the first subset of HWPEEs defining internal functionality and operations of the at least one processor; and at least one non-transitory computer-readable storage medium having stored thereon a set of program execution elements (PEEs) each having a respective privilege level in a respective memory address space, the set of PEEs including the set of HWPEEs, the set of PEEs enforcing security through an interface confined security mechanism (ICSM) comprising a subset of the set of PEEs (ICSM PEEs) that establish boundary limiting interactions (bastion interfaces) with resources of the computer platform for a second subset of the set of PEEs; and (III) a mathematical model of the computer platform having a formal representation of the at least one processor and the at least one non-transitory computer-readable storage medium, the mathematical model defining and proving the ICSM for the set of PEEs, and the mathematical model having at least one adversary model for each of the bastion interfaces, wherein the ICSM ensures security mechanisms of the computer platform by enforcing the bastion interfaces, and the first subset of HWPEEs, the second subset of PEEs and the ICSM PEEs may overlap in whole or in part.

In some embodiments of the system, the set of PEEs is a union of the set of HWPEEs and a set of software PEEs (SWPEEs); each PEE in the set of SWPEEs is executable by the at least one processor; and the mathematical model has a formal representation of the set of SWPEEs.

In some embodiments of the system, the resources of the computer platform include one or more of (i) the at least one processor, (ii) the at least one non-transitory computer-readable storage medium, (iii) the memory address space, (iv) the cache address space, and (v) peripherals.

In some embodiments of the system, the set of PEEs includes a first PEE and a second PEE, having first and second privilege levels, respectively, the first privilege level being a higher privilege level than the second privilege level; and the first PEE utilizes a first memory address space and the second PEE utilizes a second memory address space different from the first memory address space.

In some embodiments of the system, the computer platform further comprises at least one peripheral, and the formal representation in the mathematical model further includes HWPEEs that define and implement internal functionality and operations of the at least one peripheral.

In some embodiments of the system, the ICSM PEEs comprises a privilege-separation mechanism to enforce access controls on operations of the computer platform that involve peripheral access, or access to and manipulation of peripheral state; and the access controls ensure that each of the operations is executed with a privilege level required to perform the operation.

In some embodiments of the system, the mathematical model further (i) defines operational aspects of hardware elements and software stack elements, (ii) defines predicates for the security mechanisms of the computer platform that are translatable to proof obligations, and (iii) includes a theorem prover to interpret and verify the proof obligations; the hardware elements comprise a third subset of the set of PEEs; the software stack elements comprise a fourth subset of the set of PEEs that does not include HWPEEs; and the first-fourth subset and the ICSM PEEs may overlap in whole or in part.

In some embodiments of the system, the ICSM PEEs comprises a memory-safety mechanism to ensure that all memory access operations are valid.

In some embodiments of the system, the ICSM PEEs comprises a control-flow integrity mechanism to ensure that execution of ICSM PEEs follows authorized patterns.

In some embodiments of the system, the ICSM PEEs comprises a privilege-separation mechanism to enforce access controls on operations of the computer platform that involve access to and manipulation of processor state or memory state; and the access controls ensure that each of the operations is executed with a privilege level required to perform the operation.

A third aspect relates to a system for providing formal verification of a design and operation of a computer platform, the system comprising (I) a processor; and (II) a first non-transitory computer-readable storage medium having stored thereon instructions that, when executed, program the processor to perform acts of evaluating a mathematical model that (i) models the computer platform with a formal representation of a set of PEEs, each PEE in the set of PEEs modelled as having a respective privilege level in a respective memory address space of platform memory of the computer platform, the set of PEEs including a set of hardware PEEs (HWPEEs), the set of HWPEEs modelled as executable by a finite-state machine and as defining and implementing internal functionality and operations of one or more platform processors of the computer platform and one or more platform memory controllers of the computer platform; and (ii) specifies invariants to enforce an interface confined security mechanism (ICSM) with assume-guarantee interface-confined mathematical reasoning; and determining from the evaluating that the ICSM holds true for the computer platform.

In some embodiments of the system, the mathematical model has a formal representation of a set of software PEEs (SWPEE); the set of PEEs is a union of the set of HWPEEs and a set of SWPEEs; and each PEE in the set of SWPEEs is modelled as executable by the at least one platform processor.

In some embodiments of the system, wherein the ICSM comprises a trusted path security mechanism. In some embodiments, the ICSM comprises a non-interference security mechanism.

In some embodiments of the system, the act of determining comprises determining from the evaluation whether the ICSM holds true for the computer platform regardless of an organization of the PEEs in the set of PEEs of the computer platform.

In some embodiments of the system, the act of determining comprises determining from the evaluation whether the ICSM holds true for the computer platform regardless of a composition of the PEEs of the set of PEEs of the computer platform.

In some embodiments of the system, the formal representation in the mathematical model further includes a subset of the set of PEEs that are adversary-controlled and at least one adversary model for each of the adversary-controlled PEEs.

In some embodiments, the system further comprises a mathematical model implementation validation mechanism to validate that the set of PEEs implement the ICSM specified in the mathematical model.

In some embodiments of the system, the mathematical model implementation validation mechanism comprises a test generation mechanism to generate test cases from the mathematical model.

In some embodiments of the system, the mathematical model implementation validation mechanism comprises a trace capture mechanism to collect accurate and reliable traces of PEE execution.

In some embodiments of the system, the mathematical model implementation validation mechanism comprises a trace validation mechanism to evaluate if traces of PEE execution conform to the mathematical model.

In some embodiments of the system, a first subset of the set of PEEs are implemented in a low-level programming language; a second subset of the set of PEEs are implemented in a high-level programming language; and the mathematical model ensures a composition of the ICSM of the union of the PEEs of the first subset and the PEEs in the second subset.

In some embodiments of the system, the set of PEEs includes a first PEE and a second PEE, having first and second privilege levels, respectively, the first privilege level being a higher privilege level than the second privilege level; and the first PEE utilizes a first memory address space and the second PEE utilizes a second memory address space different from the first memory address space.

In some embodiments of the system, the formal representation further comprises (i) an interface defined for each PEE in the set of PEEs, wherein the interface includes conditions that must be met before and after execution of one or more PEE functions of the respective PEE; (ii) a specification of the platform memory and memory regions accessible for each PEE in the set of PEEs; (iii) a representation of conditions as predicates over one or more states of the platform memory and one or more states of the one or more platform processors, where the predicates indicate whether the one or more states of the platform memory and the one or more states of the one or more platform processors satisfy the conditions; and (iv) enforced invariants of the ICSM at a start and at an end of each PEE function execution.

In some embodiments of the system, the formal representation comprises first instructions, executable by the processor, for defining an initial configuration of the one or more platform processors and an initial global platform memory state; second instructions, executable by the processor, for executing a series of concurrent steps on each of the one or more platform processors, wherein each step is associated an operation being performed and a first PEE in the set of PEEs associated with the operation; and third instructions, executable by the processor, for managing an internal state of each of the one or more platform processors, starting new threads, and assigning memory addresses to each thread; and the ICSM is enforced by checking corresponding invariants for each PEE function call.

In some embodiments of the system, the mathematical model further comprises a formal representation and model of a lock on a PEE function, the lock preventing the PEE function from being called if it is active; the mathematical model requires waiting until the lock is released before proceeding with the PEE function call; and the model of the lock ensures that only one instance of the PEE function can be executed at a time across the platform processors.

In some embodiments of the system, the mathematical model contains a formal representation of interrupt handling on the computer platform, the formal representation of interrupt handling comprising fourth instructions, executable by the processor, for executing an interrupt handler function within a second PEE in the set of PEEs for each of the one or more platform processors in response to an interrupt, the interrupt handler function has its own assigned memory address space, the first PEE is not required to be different from the second PEE; fifth instructions, executable by the processor, for preemptively executing the interrupt handler function at any point in time with an assigned privilege level; and sixth instructions, executable by the processor, for returning control to an original interrupted PEE function after the interrupt handler function terminates.

In some embodiments of the system, the mathematical model includes a formal representation of the ICSM, and the ICSM further includes a memory-safety mechanism to ensure that all memory access operations on the computer platform are valid.

In some embodiments of the system, the formal representation of the memory-safety mechanism comprises a spatial memory safety mechanism that controls memory layout and memory access boundaries to ensure the memory accesses operations are within valid bounds, and a temporal memory safety mechanism that ensures that memory accesses are valid and consistent with respect to a lifetime and state of allocated memory, preventing unauthorized or erroneous memory accesses.

In some embodiments of the system, the mathematical model includes a formal representation of the ICSM, and the ICSM further includes a control-flow integrity mechanism that ensures that execution of PEEs by the one or more platform processors follows authorized patterns and do not compromise the integrity of the computer platform.

In some embodiments of the system, the formal representation of the control-flow integrity mechanism comprises a code-safety mechanism that ensures that PEE execution by one or more platform processors are immutable in a given memory address space, and a stack-safety mechanism that enforces the integrity of the platform processors'state(s) for PEE execution by the one or more platform processors.

In some embodiments of the system, the mathematical model includes a formal representation of the ICSM that further includes a privilege-separation mechanism that enforces access controls on operations of the computer platform that involve peripheral access, or access to and manipulation of the one or more platform processors'state or the platform memory's state; and the access controls ensure that each of said operations is executed with a privilege level required to perform the operation.

In some embodiments of the system, the formal representation in the mathematical model further includes a peripheral of the computer platform (“platform peripheral”).

In some embodiments of the system, the mathematical model includes a formal representation of the ICSM that further includes a privilege-separation mechanism that enforces access controls on operations of the computer platform that involve peripheral access or access to and manipulation of the platform peripheral's state; and the access controls ensure that each of said operations is executed with a privilege level required to perform the operation.

In some embodiments of the system, the mathematical model further defines predicates for the ICSM on the computer platform that are translatable to proof obligations; and the evaluating comprises interpretation and verification of the proof obligations via a theorem prover included in the mathematical model.

In some embodiments of the system, the mathematical model further defines predicates for the ICSM on the computer platform that are translatable to proof obligations; and the evaluation comprises interpretation and verification of the proof obligations via a model checker included in the mathematical model.

In some embodiments of the system, the mathematical model further comprises an idiomatic representation of the PEE code that describes the operation of the PEE code and allows proving composition of ICSM across the PEEs in the set of PEEs. In some embodiments, the idiomatic representation consists of a high-level language representation of a low-level programming language. In some embodiments, the idiomatic representation further comprises emulated functionality of an operation of PEE code of a first PEE in the set of PEEs. In some embodiments, the mathematical model further defines predicates for the ICSM on the computer platform that are translatable to proof obligations; and the evaluation comprises interpretation and verification of the proof obligations via a theorem prover included in the mathematical model. In some embodiments, the mathematical model further defines predicates for the ICSM on the computer platform that are translatable to proof obligations; and the evaluation comprises interpretation and verification of the proof obligations via a model checker included in the mathematical model.

A fourth aspect relates to a non-transitory computer-readable storage medium storing computer-executable instructions that, when executed by programmable hardware, cause the programmable hardware to perform a respective operation, the computer-executable instructions comprising a set of program execution elements (PEEs), each PEE of the set of PEEs, when executed, having a respective privilege level, is in a respective memory address space, the set of PEEs including a set of hardware PEEs (HWPEEs), the set of HWPEEs including a first subset of the HWPEs that define internal functionality and operations of a platform processor; and an interface confined security mechanism (ICSM) through which the set of PEEs enforce security, the ICSM comprising a subset of the set of PEEs (ICSM PEEs) that establish boundary limiting interactions (bastion interfaces) with resources of a computer platform for a second subset of the set of PEEs, the ICSM ensuring security mechanisms of the computer platform by enforcing the bastion interfaces, wherein the first subset of HWPEEs, the second subset of PEEs, and the ICSM PEEs may overlap in whole or in part.

A fifth aspect relates to a computer platform comprising a set of hardware program execution elements (HWPEEs); programmable hardware implemented as at least one platform processor by a first subset of the HWPEEs, the first subset of HWPEEs defining internal functionality and operations of the at least one platform processor; at least one non-transitory computer-readable storage medium having stored thereon a set of program execution elements (PEEs) each having a respective privilege level in a respective memory address space, the set of PEEs including the set of HWPEEs; and an interface confined security mechanism (ICSM) through which the set of PEEs enforce security, the ICSM comprising a subset of the set of PEEs (ICSM PEEs) that establish boundary limiting interactions (bastion interfaces) with resources of the computer platform for a second subset of the set of PEEs, the ICSM ensuring security mechanisms of the computer platform by enforcing the bastion interfaces, wherein the first subset of HWPEEs, the second subset of PEEs, and the ICSM PEEs may overlap in whole or in part. In some embodiments, the computer platform is implemented as a system on a chip (SoC).

A sixth aspect relates to a non-transitory computer-readable storage medium having stored thereon instructions that, when executed, program at least one processor to perform acts of (I) evaluating a mathematical model that (i) models the computer platform with a formal representation of a set of PEEs, each PEE in the set of PEEs modelled as having a respective privilege level in a respective memory address space of platform memory of a computer platform, the set of PEEs including a set of hardware PEEs (HWPEEs), the set of HWPEEs modelled as executable by a finite-state machine and as defining and implementing internal functionality and operations of one or more platform processors of the computer platform and one or more platform memory controllers of the computer platform; and (ii) specifies invariants to enforce an interface confined security mechanism (ICSM) with assume-guarantee interface-confined mathematical reasoning; and (II) determining from the evaluating that the ICSM holds true for the computer platform.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures may be represented by a numeral. For purposes of clarity, not every component may be labeled in every drawing. In the drawings:

FIG. 1 shows a system 100 for provably secure hardware and software co-design, according to some embodiments;

FIG. 2 shows a system 200 comprising program execution elements (PEE) 113 that execute on a computer platform 105 in a memory address space 201 and consists of multiple functions 208, according to some embodiments;

FIG. 3 shows a system 300 for enforcing code safety where PEE code regions 305 are protected in a given memory address space 201, according to some embodiments;

FIG. 4 shows a system 400 for enforcing data safety where data regions 407 containing variables 409 are protected in a given memory address space 201, according to some embodiments;

FIG. 5 shows a system 500 for enforcing stack safety where code regions 305 of program execution elements 113 are protected with forward-edge CFI 504, backward-edge CFI 505 and stack canary 508, according to some embodiments;

FIG. 6 shows a time sequence diagram depicting a method 600 for stack safety with Forward Edge CFI, according to some embodiments;

FIG. 7A shows a time sequence diagram depicting a method 700 for stack safety with Backward edge CFI, according to some embodiments;

FIG. 7B shows a time sequence diagram depicting a method 700 for stack safety with Backward edge CFI, according to some embodiments;

FIG. 8 shows a system 800 for enforcing privilege separation among multiple caller PEE 801 and Callee PEE 804 via sentinels 802 and access control matrix 805, according to some embodiments;

FIG. 9 shows a system 900 for providing heap safety 903 consisting of hardened heap management 901 to protect heap memory 902, according to some embodiments;

FIG. 10 shows a system 1000 for Interface Confined Security Mechanism according to some embodiments;

FIG. 11 shows a system 1100 for a Mathematically Verified System-on-Chip computer platform composed of HWPEEs and SWPEEs according to some embodiments;

FIG. 12 shows a system 1200 for a Mathematically Verified System-on-Chip computer platform with an in-order processor implementation according to some embodiments;

FIG. 13 shows a system 1300 for a Mathematically Verified System-on-Chip computer platform implemented with multi-processor, memory protection, IOMMU, privileged-modes and direct-mapped Instruction/Data Caches according to some embodiments;

FIG. 14 shows a system 1400 for mathematical model implementation validation mechanism according to some embodiments;

FIG. 15 shows a system 1500 for mathematical model ICSM Verification Mechanism according to some embodiments;

FIG. 16 shows an embodiment 1600 for conversion of PEE code into idiomatic representation for ICSM verification according to some embodiments;

FIG. 17 shows an embodiment 1700 for verifying ICSM on PEE code using idiomatic representation according to some embodiments;

FIG. 18 shows a system 1800 for verifying PEE functional correctness according to some embodiments;

FIG. 19 shows an embodiment 1900 for verifying PEE functional correctness according to some embodiments; and

FIG. 20 shows, schematically, an illustrative computer system 1800 on which aspects of the present disclosure may be implemented.

### DETAILED DESCRIPTION

The inventors have recognized and appreciated the need for a system and methods for provably securing a hardware and software co-designed computing platform for high-assurance computing. The system security mechanisms (SSMs) are defined and proven in the mathematical model of the computer platform at design time, and enforced at runtime on individual functions of the underlying computer platform hardware and software stack implementation composed of program execution elements (PEEs).

In some embodiments, the PEEs may include a set of hardware program execution elements (HWPEEs) that can be implemented using various technologies such as Field-Programmable Gate Arrays (FPGAs), digital circuits, combinatorial circuits, or other suitable hardware architectures. The HWPEEs can define and implement internal functionality and operations of various components within the computer platform, including processors (CPU, GPU, NPU etc.), non-transitory computer-readable storage media controllers, and peripherals.

In another embodiment, the PEEs may include a set of software PEEs (SWPEEs), each of which are executable by the at least one processor that is implemented via one or more HWPEEs, and have a respective privilege level, and in a respective memory address space.

The systems and methods may include a trusted path security mechanism (TPSM) that enforces intended patterns of computer platform operations without adversarial influence. Such computer platform operations can be one or more of cache and memory access operations, peripheral access operations, processor operations including execution of processor instructions, and operations involving access and manipulation of processor, memory or peripheral state. TPSM therefore establishes secure code execution and reliable data communication pathways between PEEs in the computer platform.

TPSM encompasses four key mechanisms-temporal memory safety, which ensures that memory accesses are valid and do not compromise the integrity of the system, handled via heap safety mechanisms; spatial memory safety, which ensures that data is accessed and manipulated in a secure and controlled manner, handled via data safety mechanisms; control flow integrity, which ensures that the execution of code follows a predictable and authorized path, handled via code safety and stack safety mechanisms; and privilege separation, which ensures that different components of the system operate with the appropriate level of privilege and access control.

TPSM may be implemented in various embodiments, including combinations of hardware and software components embodied as PEEs. For example, a TPSM may be established between two software processes (e.g., Process A and Process B) that communicate via shared memory. Alternatively, a process may invoke a set of system calls provided by the kernel to establish a TPSM. Additionally, a process may write data to a storage device (such as a disk) and read from it, with the storage device being one example of a peripheral implemented by a set of HWPEEs, that can be used to establish a TPSM. Other peripherals, such as networks, keyboards, or other input/output devices, may also be used.

Furthermore, a TPSM may be applied to virtual machines communicating via a hypervisor, containers communicating with each other or the host kernel, or other similar configurations. In general, a TPSM can include either pure software components or a combination of hardware and software components, such as storage devices, peripherals, or other hardware elements. The TPSM is established on the computer platform, providing a secure foundation for computing.

The system and methods may include an “Interface Confined Security Mechanism (ICSM)” that regulates interactions between PEEs. In one embodiment, the ICSM regulates interactions between potentially malicious PEEs and the rest of the PEEs in the computer platform. ICSM achieves this by designating a subset of the set of PEEs (called “Bastion PEEs (BPEE)”), to act as gatekeepers and enforce strict boundaries (called “bastion interfaces”) around computer platform resources. Bastion interfaces prevent unauthorized access to computer platform resources by other (potentially malicious) PEEs. A key aspect of ICSM is the use of mathematical adversary modeling, which involves creating detailed models of potential attackers and their possible actions, allowing for the anticipation and mitigation of all possible non-deterministic adversarial inputs that could be directed at each bastion interface. By tying each bastion interface to a comprehensive set of potential adversarial scenarios, the ICSM can ensure that the system is resilient to even the most sophisticated and unpredictable attacks including zero-day attacks. BPEEs operate at a higher level of privilege than the potentially malicious components, ensuring that they can effectively control and monitor interactions. The overall security of the system is formally proven using a rigorous mathematical model that takes into account the complex interplay between the system's components and the potential adversaries.

The Interface Confined Security Mechanism (ICSM) can be embodied in various forms to protect different layers of a computer platform. For example, in a hypervisor-based embodiment, the ICSM can be implemented as a module within the hypervisor, allowing it to regulate interactions between virtual machines and the hardware components, which may include hardware program execution elements (HWPEEs) such as Field-Programmable Gate Arrays (FPGAs), digital circuits, or combinatorial circuits. In another embodiment, the ICSM can be implemented in a processor or peripheral, providing an additional layer of security against malicious attacks targeting the processors'and peripheral's low-level interfaces, and interacting with HWPEEs to enforce secure communication protocols. In this case, the HWPEE may provide a set of processor instructions in order for other PEEs to execute and manipulate processor state. Additionally, the ICSM can be implemented as a kernel module within an operating system, enabling it to enforce strict boundaries around platform resources and prevent malicious applications from compromising the platform, while also coordinating with software program execution elements (SWPEEs) to ensure secure execution of system calls.

In other embodiments, an ICSM can be applied to virtualization and containerization technologies to enhance the security of a computer platform. For instance, in a virtual machine-based embodiment, the ICSM can be used to regulate interactions between the guest operating system and the host environment, preventing malicious code from escaping the virtual machine and compromising the host, by leveraging HWPEEs such as ASICs or digital circuits to monitor and control communication between the guest and host. Similarly, in a container-based embodiment, the ICSM can be used to enforce strict boundaries around container interfaces, preventing malicious containers from accessing sensitive data or disrupting other containers within the same host, and interacting with SWPEEs to ensure secure execution of containerized applications. The ICSM can also be used to coordinate the interactions between HWPEEs and SWPEEs, ensuring that the hardware and software components work together seamlessly to provide a robust security framework for the computer platform. By applying the ICSM to these various technologies, it is possible to create a comprehensive security framework that protects computer platforms against a wide range of threats, and ensures secure cooperation between HWPEEs and SWPEEs.

A subset of the set of PEEs may be implemented in low-level programming languages such as Verilog, System-Verilog, C, C++ and Assembly that offer fine-grained control over hardware resources and performance optimization capabilities, suited for programming functionality of hardware components and software components such as kernels and high-performance applications. A subset of the set of PEEs may be implemented in a high-level programming language such as Python, Rust and Java that have designed-in features of memory safety guarantees and type systems that help prevent common vulnerabilities and ensure integrity of code execution.

In some embodiments, the subset of the set of PEEs that are implemented in low-level programming languages may enforce one or more TPSM and optionally one or more of ICSM.

In some embodiments, the subset of the set of PEEs that are implemented in high-level programming languages may enforce a subset of the TPSM such as temporal memory safety and spatial memory safety.

In other embodiments, the subset of the set of PEEs that are implemented in high-level programming languages may enforce one or more TPSM and optionally one or more ICSM.

In one embodiment, a combination of the subset of PEEs implemented in low-level programming language and the subset of PEEs implemented in high-level programming language may enforce one or more TPSM and optionally one or more ICSM.

In some embodiments, the system comprises a computer platform including HWPEEs and SWPEEs modeled mathematically. The SSMs comprise stack safety with PEEs, data safety within PEEs, code safety within PEEs, heap safety within PEEs, privilege separation between PEEs.

In some embodiments, the subset of the set of PEEs that are implemented in low-level programming languages may utilize a mathematical model of the computer platform to define and prove the enforcement of one or more TPSM and optionally one or more ICSM.

In other embodiments, the subset of the set of PEEs that are implemented in high-level programming languages may utilize a mathematical model of the computer platform to define and prove the enforcement of one or more TPSM and optionally one or more ICSM.

In one embodiment, a combination of the subset of PEEs implemented in low-level programming language and the subset of PEEs implemented in high-level programming language may utilize a mathematical model of the computer platform including the PEEs to define and prove the enforcement of a one or more TPSM and optionally one or more ICSM.

The mathematical model specification of a computer platform may define operational aspects of the platform's hardware elements and software stack elements via PEEs running on the computer platform. The PEEs may be composed of functions as execution units. Additionally, the mathematical model further specifies the composition of the subset of PEEs implemented in low-level programming language and the subset of PEEs implemented in high-level programming language to collectively enforce one or more TPSM.

Proving the SSMs comprises analyzing the mathematical invariants to determine whether the SSMs for the computing platform are satisfied, and upon a determination that the SSM are not satisfied, analyzing the mathematical invariants to generate a counter-example that shows that the SSMs do not hold for the computing platform PEEs. In cases where the SSMs do not hold for the computer platform, the counter-example may be used to correct the mathematical model specification such that the SSMs hold for the computer platform. Analyzing the mathematical invariants to determine whether the SSMs of the computer platform are satisfied can be achieved by encoding the SSM into a computer-assisted theorem proving system and using the computer-assisted theorem proving system to analyze the mathematical invariants to determine if the SSM are satisfied.

The system can encompass a plurality of software stack entities such as firmware, hypervisor, operating system kernel, application, libraries, and extensions thereof. The SSMs can be realized on the PEEs'implementation via modifications to the program element source code which is eventually compiled to the program element binary operations.

The system can also store platform configuration data and PEE on a non-volatile medium as system packages, which may further comprise one or more PEE source code files, one or more PEE binary executable files (“PEE binaries”), one or more PEE script executable files (“PEE scripts”), one or more configuration files that provide data for PEE and/or platform functionality, and other platform-specific configuration files. Violation of an SSM at runtime can be logged in a secure memory region and transmitted periodically using a platform signing agent to a local or remote machine.

The system and methods described herein may be implemented on various platforms, including but not limited to, Linux, Microsoft Windows, and other operating system environments. The hardware program execution elements (HWPEEs) can be embodied in a variety of forms, such as Field-Programmable Gate Arrays (FPGAs), digital circuits, combinatorial circuits, Application-Specific Integrated Circuits (ASICs), or other suitable hardware architectures. The system and methods described herein ensures that a computer platform is built with security in mind from the start. This reduces the risk of vulnerabilities and improves the overall trustworthiness of the computer platform.

The system can be used in various industries where security is paramount, such as finance, healthcare, and government. The use of this technology will provide an added layer of protection for integrity of critical code and sensitive data and ensure that it remains confidential and secure at all times.

The following nomenclature is used herein:
Formal Representation: In the context of mathematical modeling, a formal representation refers to a mathematical or logical description of a system, process, or concept that is expressed using a rigorous, unambiguous, and well-defined syntax and semantics, allowing for automated analysis, verification, and validation. A formal representation typically involves the use of mathematical logic such as propositional logic, first-order logic or temporal logic, or other mathematical structures like graphs, automata, or algebraic equations, to describe the behavior, properties, or relationships within a system. This representation is “formal” in the sense that it adheres to a set of predefined rules, axioms, and inference mechanisms, enabling machine-based processing, reasoning, and verification, thereby ensuring accuracy, consistency, and reliability in the modeling and analysis of complex systems.
Predicate: In the context of mathematical modeling, a predicate refers to a propositional or first-order logical statement that assigns a property or attribute to an object, system, or state. Predicates are used to express conditions, relations, or constraints that must hold true for a particular situation or set of circumstances, and are often used in formal specifications, models, and proofs to reason about the behavior and properties of systems.
Proof obligations: In the context of mathematical modeling, proof obligations refer to the set of conditions or properties that must be formally proven or verified to ensure the correctness, consistency, and validity of a mathematical model or specification. These obligations typically arise from the axioms, definitions, and inference rules used in the model, and are often discharged using formal proof techniques, such as deductive reasoning, model checking, or theorem proving
Theorem prover: In the context of mathematical modeling, a theorem prover refers to a software tool or system that assists in the formal proof and verification of mathematical statements or theorems. Theorem provers use logical and mathematical rules to check the validity of a proof, ensuring that it is correct and rigorous, and providing a high degree of confidence in the results. They are often used to verify the correctness of mathematical models, specifications, and algorithms, and to establish the soundness and completeness of formal systems. Theorem provers can be completely automated (i.e., require no user intervention) or interactive (i.e., require some amount of user intervention).
Model Checker: In the context of mathematical modeling, a model checker refers to a software tool or system that automatically verifies whether a given mathematical model or system specification satisfies certain properties or requirements. Model checkers use algorithms to exhaustively explore all possible states or behaviors of the system, checking if the desired properties hold true in every case. They are often used to detect errors, inconsistencies, or flaws in system designs, protocols, or software code, and to ensure that the system behaves as intended under various operating conditions. Like theorem provers, model checkers can also be completely automated or interactive.
Assume-guarantee interface confined mathematical reasoning: a way of mathematical reasoning about a computer platform by: (a) defining what each hardware element and software stack element of the computer platform expects from other hardware elements and software stack elements (assumptions); (b) defining what each hardware element and software stack element of the computer platform promises to deliver (guarantees); and (c) ensuring these assumptions and guarantees are clearly defined at the interfaces between hardware elements and software stack elements of the computer platform.
Invariant: In the context of mathematical modeling, an invariant refers to a property or quantity that remains unchanged or constant despite transformations, changes, or perturbations to the computer platform (an “immutable property”). Invariants are used to describe and analyze the behavior of complex systems, and can include quantities such as security, liveness, energy, time or symmetry, which remain preserved over time or under different conditions.
Trace: A trace refers to a record or log of the sequence of events, such as function executions, that occur during the execution of a computer program, allowing for the observation and analysis of the program's behavior. Traces are useful in testing and verification, as it enables comparison of the actual program behavior with a mathematical model, helping to ensure that the implementation conforms to the permitted functionality.
Security Mechanism: In the context of cybersecurity, a security mechanism refers to a specific technique, protocol, or control implemented to enforce or ensure a particular security attribute or characteristic of a system, network, or asset, such as encryption for confidentiality, access controls for integrity, or firewalls for availability. Security mechanisms are designed to protect against threats or vulnerabilities and are often evaluated based on their ability to enforce desired security behavior or constraints, which may be codified in a mathematical model or specification.
Operational aspects: The fundamental capabilities for each of the hardware elements and the software stack elements. The operational aspects of a memory may include, for example, read, write, and execute. The operational aspects of a processor may include executing instructions and manipulating hardware registers, The operational aspects of a peripheral may include input from a keyboard, mouse, camera etc. and output to a printer, disk or other forms of storage media. The operational aspects of a program execution element may include reading file, writing to a file and read/write from/to memory and peripherals.
Programmable Hardware Component (PHC): Refers to a hardware element that can be configured or programmed to perform a specific function or task. PHCs can be implemented using various technologies, such as Field-Programmable Gate Arrays (FPGAs), Application-Specific Integrated Circuits (ASICs), digital circuits, or other programmable hardware devices. In some cases, these components can be reconfigured or reprogrammed to change their behavior or functionality, allowing for flexibility and adaptability in a wide range of applications.
Fixed Hardware Component (FHC): Refers to a hardware element that is designed to perform a specific function or task and cannot be changed or programmed. FHCs can include components such as connectors (e.g., RJ-45, USB, HDMI), interfaces (e.g., SD card slot), peripherals (e.g., keyboard, display), volatile and non-volatile storage media, memory or other non-programmable hardware devices. These components are typically designed to provide a specific function or interface and do not have the ability to be reconfigured or reprogrammed.
Program Execution Element (PEE): A Program Execution Element (PEE) refers to a self-contained unit of execution on the computer platform that represents a discrete environment for running code and managing computer platform resources, and enforcing security policies. A PEE can comprise a range of components, including applications, libraries, or other executable entities such as functions and objects, and may be implemented in various forms, such as a programmable hardware element, process, thread, container, virtual machine, or other isolated environment. PEEs can be composed of other PEEs, allowing for hierarchical organization and nested execution environments. Each PEE operates within its own defined boundaries, with its own set of resources, permissions, and security attributes.
HWPEE (Hardware Program Execution Element): Is a type of PEE that implements hardware component functionality or task. HWPEEs can be implemented using various PHC technologies, such as Field-Programmable Gate Arrays (FPGAs), Application-Specific Integrated Circuits (ASICs), digital circuits, or other programmable hardware devices. HWPEEs are designed to provide low-level hardware component functionality on the computer platform such as: bus processing, data processing, control logic, interface protocols, processors (processor and GPU), and peripheral functionality including network, storage and display management functionality. HWPEEs are often optimized for performance, power consumption, and area efficiency.
SWPEE (Software Program Execution Element): Is a type of PEE that implements a software component functionality or task. SWPEEs run on top of HWPEEs, and typically use HWPEEs that implement processors (processor and GPU) to carry out their functionality. SWPEEs are designed to provide high-level functionality, such as application logic, operating system services, libraries, or user interfaces.
Program Code or Code: Program code or simply code refers to the set of operations written in a programming language that are executed to perform a specific task or achieve a desired outcome. Code can either be in binary format (encoded instructions interpreted by a processor or encoded operations within a digital circuit) or source format (encoded in a specific programming language such as Verilog, Spinal-HDL, C, Assembly, Java, Python or Shell scripts)
PEE code region: A PEE code region or simple code region refers to a specific section or module within a PEE where certain functionality is implemented, such as data processing, authentication, or encryption, and can be defined by boundaries like functions, classes, objects, or namespaces.
Memory address: Refers to a unique identifier for a specific location in a storage resource where data can be stored or retrieved, essentially representing a single point of storage. This concept applies to various types of storage resources, including those implemented in HWPEEs using PHCs, as well as those managed by SWPEEs through physical and virtual memory mechanisms.
Memory region: Is a contiguous range of storage locations that are allocated for a particular purpose or set of data, effectively grouping multiple individual storage locations together. This concept is applicable to both HWPEEs and SWPEEs, where memory regions can be defined within the storage resources managed by PHCs or physical and virtual memory systems, respectively.
Memory address space: The entire collection of storage locations available to a PEE, encompassing all the possible storage addresses it can access, thereby defining its operational boundary. This concept applies to both HWPEEs and SWPEEs, where the memory address space can be defined by the storage resources implemented in PHCs or managed through physical or virtual memory mechanisms.
Memory: The overarching concept that encompasses all storage resources and address spaces available across an entire system or device, representing the total capacity for storing and retrieving data. This includes all forms of storage, such as physical storage media (e.g., RAM, ROM, flash), virtual storage areas (e.g., virtual memory, caching mechanisms), and storage resources implemented in PHCs (e.g., FPGA-based storage, ASIC-based storage). The concept of memory is generic and applies to both HWPEEs and SWPEEs, encompassing all types of storage resources and mechanisms used to manage data within a system or peripheral.
Domain PEE (DPEE): A Domain PEE refers to a program execution element that operates within a contained environment, potentially executing code that is not entirely trustworthy. Domain PEEs may execute a wide range of code, including applications, services, or other programs, and are designed to be isolated from sensitive system components to prevent potential security breaches.
Bastion PEE (BPEE): A Bastion PEE (BPEE) refers to a program execution element that is designed to be highly secure and trustworthy, responsible for enforcing system security mechanisms and protecting against adversarial tampering. A BPEE acts as a robust guardian of the system, ensuring the integrity and confidentiality of sensitive data and computations. BPEEs are typically responsible for managing and overseeing other program execution elements, including Domain PEEs.
Keystone PEE (KPEE): A Keystone PEE refers to a specialized program execution element within the set of Bastion PEEs that is responsible for establishing the fundamental security mechanisms of the system. KPEEs perform critical functions such as setting up memory protections, configuring digital circuit states, configuring processor state, and initializing other essential security mechanisms. These PEEs provide the base layer of security upon which the rest of the system relies, ensuring the integrity and trustworthiness of the environment.
Trusted Path Security Mechanism (TPSM): A security mechanism that enforces intended patterns of computer platform operations without adversarial influence. Such computer platform operations can be one or more of memory access operations, peripheral access operations, processor operations including execution of processor instructions, and operations involving access and manipulation of processors (processor or GPU), memory or peripheral state. TPSM therefore establishes secure code execution and reliable data communication pathways between PEEs and computer platform hardware, ensuring adversary-free, reliable and trustworthy interaction.
Interface Confined Security Mechanism (ICSM): An interface confined security Mechanism (ICSM) regulates interactions between PEEs including PEEs that may be potentially malicious. ICSM achieves this by designating a subset of the set of PEEs, to act as gatekeepers and enforce strict boundaries (called “bastion interfaces”) around computer platform resources. A key aspect of ICSM is the use of mathematical adversary modeling, which involves creating detailed models of potential attackers and their possible actions, allowing for the anticipation and mitigation of all possible non-deterministic adversarial inputs that could be directed at each bastion interface.
Low-level programming language: Low-level programming languages, such as C, C++, and Assembly, offer fine-grained control over hardware resources and performance optimization capabilities, making them well-suited for systems programming, embedded systems, and high-performance applications. Additionally, low-level programming languages also encompass Hardware Description Languages (HDLs) like Verilog and VHDL, which are used to design and program PHC. However, this level of control also comes with inherent security risks due to the lack of built-in memory safety features, type checking, and error handling mechanisms, making them more susceptible to vulnerabilities like buffer overflows, data corruption, and exploitation by malicious code.
High-level programming language: High-level programming languages such as Rust, Python and Java provide a foundation for building secure software systems by offering features such as memory safety guarantees, type systems, and formal verification mechanisms that help prevent common vulnerabilities and ensure the integrity of code execution. Additionally, many high-level programming languages also incorporate low-level programming language runtime components, such as C or Assembly code, to optimize performance, interact with hardware resources, or leverage existing libraries and frameworks, which can introduce potential security risks if not properly managed and isolated.
System Package: System packages refer to collections of PEEs, including executables, libraries, scripts, and configuration files, that are necessary for the execution of a program or application on a computer platform. These PEEs may include FPGA bitstreams, operating system components, device drivers, firmware, and other software elements that enable the execution of a program or application. System packages provide a structured way to manage and distribute these PEEs, ensuring that all necessary elements are present and correctly configured for PEE execution.

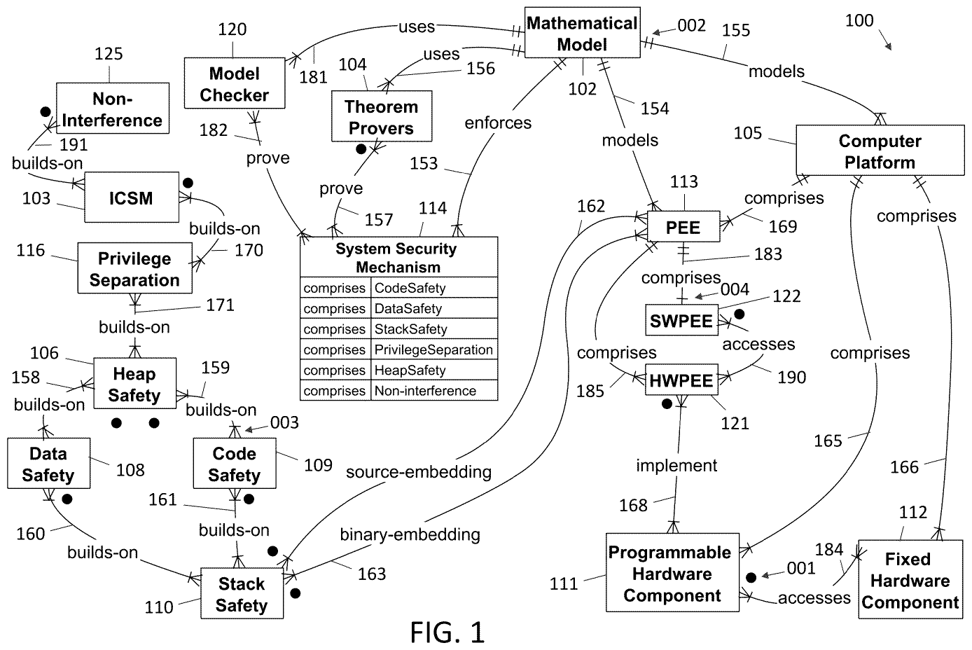

Some of the disclosed embodiments provide advantages over traditional systems and methods of securing computer platforms:
1. Provably secure execution: By enforcing SSMs at runtime, the technology ensures that there are secure execution and communication pathways across both hardware and software elements on the computer platform that ensure: memory safety, control flow integrity, privilege separation and trusted path security mechanism. This provides immunity against a broad class of memory and data ex-filteration based attacks by design.
2. Mathematical Modeling and Provable Security: The use of mathematical modeling incorporating adversarial modeling and computer-assisted theorem proving and model checking enables formal verification and validation of the SSMs, ensuring that they are satisfied at runtime in the presence of a sophisticated adversary. This provides a high level of confidence in the correctness and security of the system, reducing the risk of vulnerabilities and improving overall trustworthiness.
3. Fine-grained control over code execution and data access: The use of PEEs enables fine-grained control over code execution and data access, allowing for more precise enforcement of SSMs and reducing the attack surface. This provides a high level of flexibility and customization in implementing security policies, making it easier to adapt to changing threat landscapes and regulatory requirements.
4. Compositionality and Scalability: The system of the present invention enables compositionally verified systems that can be rapidly and independently implemented, allowing new PEEs to be added without requiring complete re-verification to establish SSMs.
5. Centralized management and configuration of system settings: The technology enables centralized management of authorized configuration of system settings, making it easier to maintain consistency across multiple systems and reduce the risk of misconfiguration. FIGS. 1-20 show diagrams for some embodiments of the systems and methods described herein. For purposes of discussion each of the diagrams is referred to as a system, however, it should be appreciated that discussed systems may also be implemented through corresponding methods. Some embodiments of the disclosed diagrams (whether through systems or methods) may not include all of the blocks shown in the corresponding diagram, or may include other blocks/steps not represented in the diagrams.

Each of the diagrams include blocks (e.g., blocks 102 and 104 in FIG. 1) and connecting lines (e.g., connecting line 154 in FIG. 1). Each block may represent, for example, stored information (e.g., a definition for a peripheral), an aspect of a method (e.g., a method step), or a module of the corresponding system. A module comprises the hardware and/or software, to implement a defined capability (e.g., the corresponding method step). For example, such a capability may be implemented through a module having one or more processors executing computer code stored on one or more non-transitory computer-readable storage medium. In some embodiments, a capability is implemented at least in part through a module having dedicated hardware (e.g., an ASIC, an FPGA). In some embodiments modules may share components. For example, a first function module and a second function module may both utilize a common processor (e.g., through time-share or multithreading) or have computer executable code stored on a common computer storage medium (e.g., at different memory locations). In some instances, a module may be identified as a hardware module or a software module. A hardware module includes or shares the hardware for implementing the capability of the module. A hardware module may include software, that is, it may include a software module. A software module comprises information that may be stored, for example, on a non-transitory computer-readable storage medium. In some embodiments, the information may comprise instructions executable by one or more processors. In some embodiments, the information may be used at least in part to configure hardware such as an FPGA. The capability of a software module may be implemented, for example, by reading the software module from a storage medium and executing it with one or more processors, or by reading the software module from a storage medium and using the information to configure hardware. “Mechanism” is used herein synonymously with module.

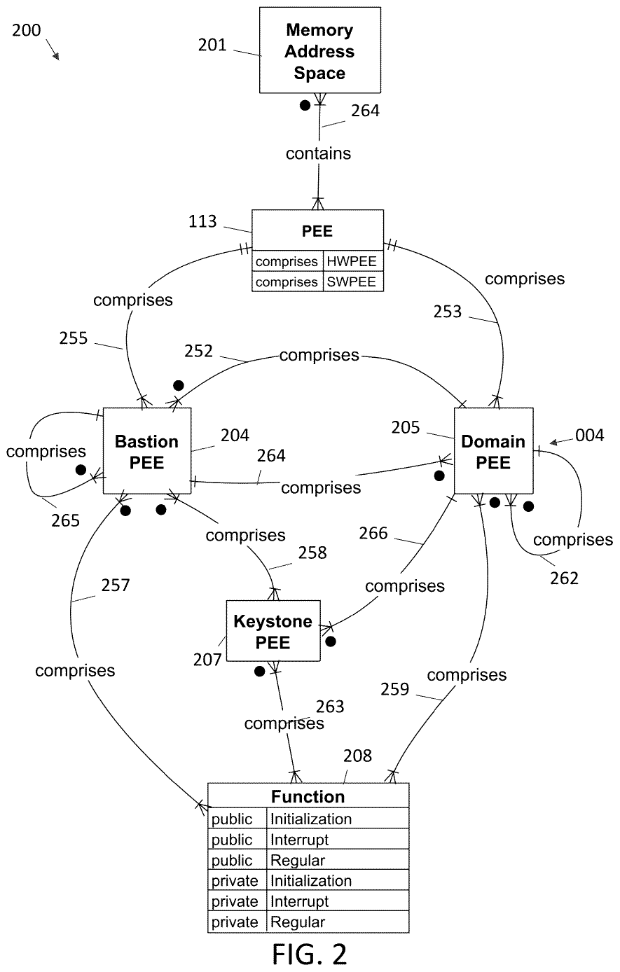

The relationship between blocks is illustrated by connecting lines. The termination of a connecting line indicates whether there may be multiple instances of a block present in the illustrated embodiment. Specifically, the symbol 002 (FIG. 1) indicates that the connection is to a single functional block while the symbol 003 indicates that the connection may be to multiple functional blocks. For example, connecting line 154 connects a single mathematical model 102 to one or more Program Execution Elements (PEE) 113. Unless explicitly stated otherwise, a connection with the symbol 002 is the starting point of the flow while the symbol 003 is the ending point of the flow for a given connecting line. For example, the flow of connecting line 154 is from the mathematical model 102 to PEE 113. For some connecting lines, the starting point of the flow is indicated via a shaded circle symbol 001. For example, connecting line 184 connects Programmable Hardware Component (PHC) 111 to Fixed Hardware Component (FHC) 112 and is read as one or more PHC 111 accesses one or more FHC 112. Solid connecting lines such as connection line 155 represent flow, interaction and dependency between various functional blocks. The symbol 004 (FIG. 1 and FIG. 2) indicates that the connection is to zero or more of a nested functional block. For example, in FIG. 2, connecting line 262 connects Domain PEE 205 to Domain PEE 205 and is read as one or more Domain PEE 205 comprises zero or more nested Domain PEE 205. Similarly, in FIG. 1 connecting line 183 connects PEE 113 to Software PEE (SWPEE) 122 and is read as a PEE 113 comprises zero or more SWPEE 122.

There are several types of connection lines. A “builds-on” connecting line (e.g., connecting line 171, FIG. 1) indicates that one component (e.g., a software module or cryptographic primitive) utilizes, extends, or relies on the functionality, security guarantees, or trust assumptions provided by another component, establishing a dependency or inheritance relationship between them. An “enforces” connecting line (e.g., connecting line 153, FIG. 1) indicates that one component (e.g., a security policy or access control mechanism) imposes restrictions, constraints, or rules on another component, ensuring compliance with specific security requirements or regulations. A “models” connecting line (e.g., connecting line 154, FIG. 1) indicates that one component (e.g., a formal specification or mathematical representation) provides an abstract or conceptual representation of another component, capturing its behavior, properties, or characteristics. An “accesses” connecting line (e.g., connecting line 184, FIG. 1) indicates that one component (e.g., a software process or thread) interacts with, retrieves data from, or manipulates another component, establishing a communication or data exchange relationship between them. A “uses” connecting line (e.g., connecting line 181, FIG. 1) indicates that one component (e.g., an application or service) utilizes, invokes, or depends on the functionality, services, or resources provided by another component, establishing a dependency or utilization relationship. A “prove” connecting line (e.g., connecting line 157, FIG. 1) indicates that one component (e.g., a formal proof or verification tool) demonstrates, validates, or establishes the correctness, soundness, or security of another component, providing a guarantee or assurance about its properties or behavior. A “source-embedding” connecting line (e.g., connecting line 162, FIG. 1) indicates that one component (e.g., a software library, capability or framework) is integrated, embedded, or incorporated into the source code of another component, establishing a tight coupling or integration relationship between them. A “binary-embedding” connecting line (e.g., connecting line 163, FIG. 1) indicates that one component (e.g., a cryptographic key, watermark or capability) is embedded, inserted, or encoded into the binary representation of another component, establishing a binding or tamper-evidence relationship between them. A “comprises” connecting line (e.g., connecting line 183, FIG. 1) indicates that one component (e.g., a system, module, or framework) is composed of, consists of, or is made up of another component, establishing a whole-part or aggregation relationship between them, where the comprising component is the container or aggregate and the comprised component is the contained part. An “implement” connecting line (e.g., connecting line 168, FIG. 1) indicates that one component (e.g., a software module or system) provides a concrete realization or execution of another component's specifications, interfaces, or requirements, establishing a relationship where the implementing component puts into practice or carries out the functionality or behavior defined by the implemented component.

A “contains” connecting line (e.g., connecting line 264, FIG. 2) indicates that one component (e.g., a data structure, container, or repository) holds, encompasses, or includes another component, establishing a relationship where the containing component provides a scope, boundary, or enclosure for the contained component, which may be a subset, element, or part of the containing component's overall content or composition.

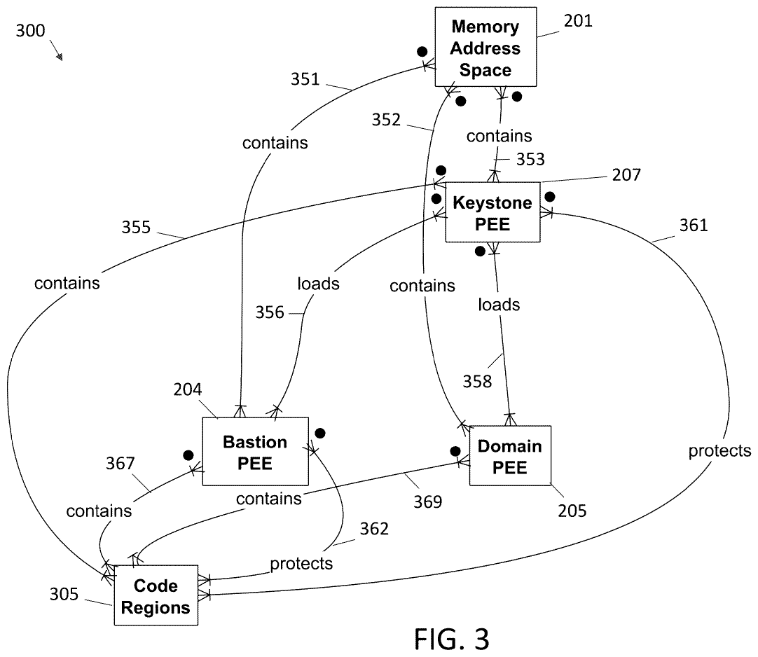

A “loads” connecting line (e.g., connecting line 358, FIG. 3) indicates that one component (e.g., a loader or bootstrapper) initializes, instantiates, or brings into memory another component, such as a software module, library, or executable, making it available for execution or use. A “protects” connecting line (e.g., connecting line 361, FIG. 3) indicates that one component (e.g., a security mechanism, encryption algorithm, or access control system) safeguards, shields, or defends another component from unauthorized access, tampering, or other potential threats, ensuring its confidentiality, integrity, or availability.

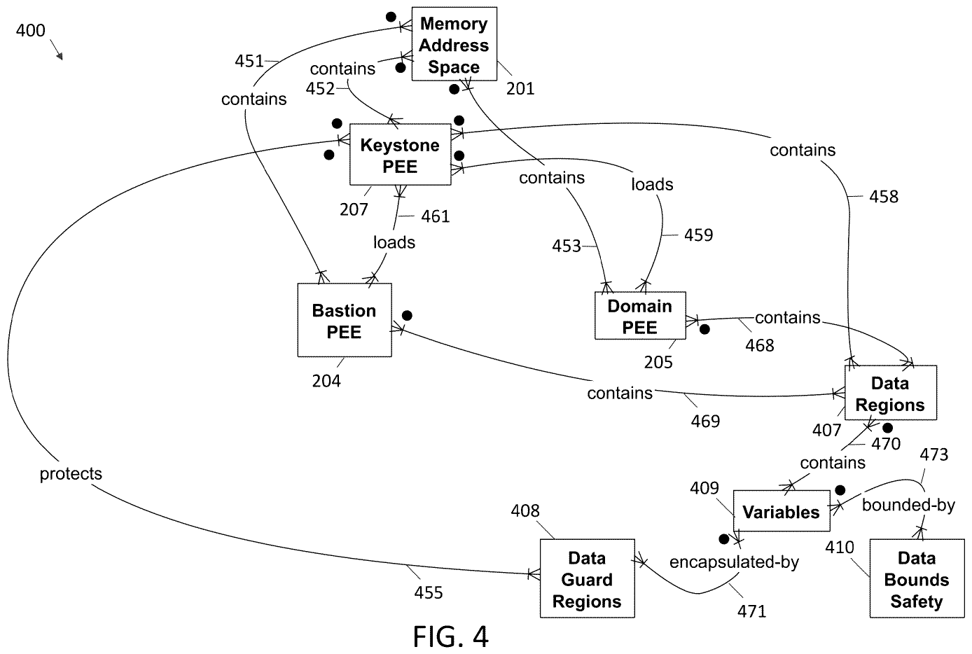

An “encapsulated-by” connecting line (e.g., connecting line 471, FIG. 4) indicates that one component (e.g., a data object, software module, or cryptographic key) is wrapped, enclosed, or hidden by another component, which controls access to it, manages its interactions, and provides a layer of abstraction or isolation, thereby shielding the encapsulated component from external interference or unauthorized access. A “bounded-by” connecting line (e.g., connecting line 473, FIG. 4) indicates that one component (e.g., a data variable or array) is limited or constrained in access by another component (e.g., a security mechanism or an enforcement mechanism).

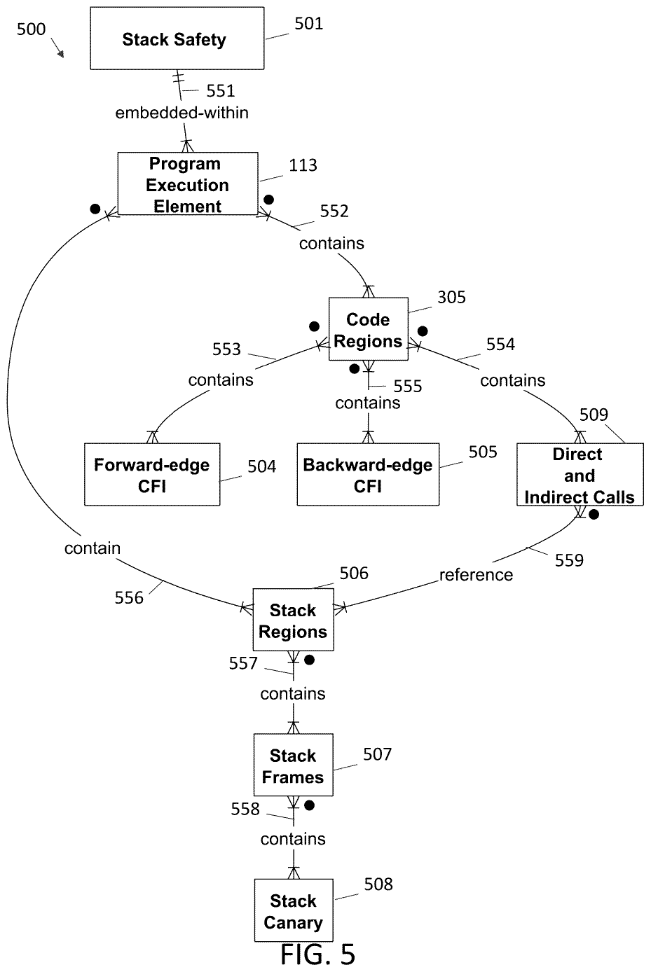

A “reference” connecting line (e.g., connecting line 559, FIG. 5) indicates that one component (e.g., a software module, document, or knowledge base) makes a citation, allusion, or pointer to another component, establishing a connection or relationship between them, where the referencing component acknowledges, relies on, or provides additional context about the referenced component. An “embedded-within” connecting line (e.g., connecting line 551, FIG. 5) indicates that one component (e.g., a software library, data object, or cryptographic primitive) is intimately integrated, inserted, or interwoven into the internal structure or implementation of another component, such that the embedded component becomes an integral part of the containing component, and its presence is essential to the overall functionality or security of the container.

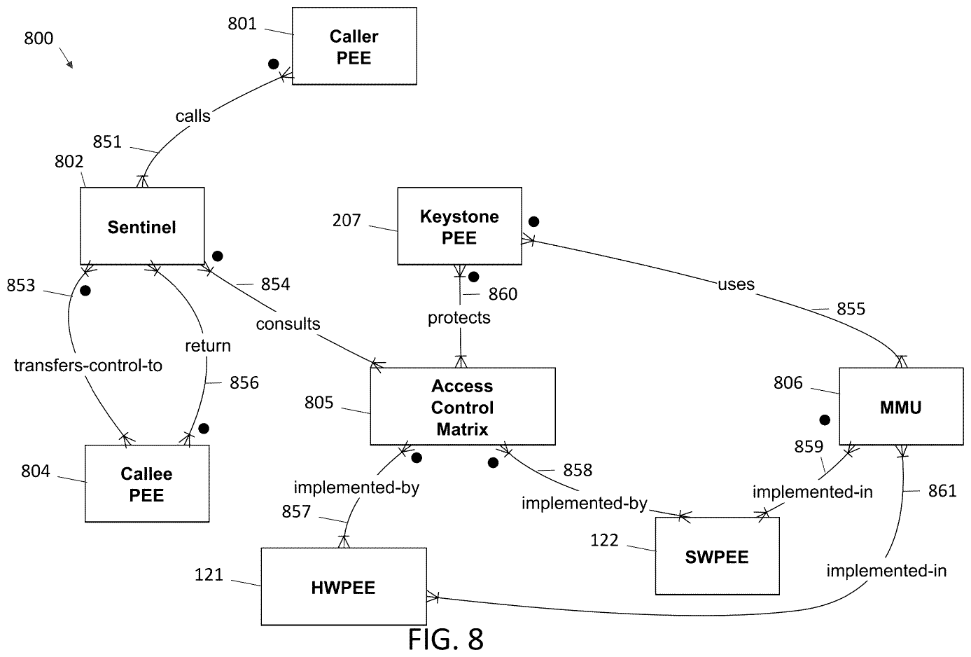

A “calls” connecting line (e.g., connecting line 851, FIG. 8) indicates that one component (e.g., a software routine, function, or method) invokes, requests, or triggers the execution of another component, passing control and potentially data to it, in order to leverage its functionality or services. A “transfers-control-to” connecting line (e.g., connecting line 853, FIG. 8) indicates that one component (e.g., a program counter, exception handler, or interrupt handler) relinquishes control or redirects the flow of execution to another component, which then assumes responsibility for continued processing or handling. A “return” connecting line (e.g., connecting line 856, FIG. 8) indicates that one component (e.g., a function, subroutine, or method) passes control back to another component that had previously invoked it, potentially also returning data or results, in order to resume execution or complete a task. An “implemented-by” connecting line (e.g., connecting line 857, FIG. 8) indicates that one component (e.g., a specification, interface, or abstract concept) is concretely realized, instantiated, or put into practice by another component, which provides a tangible implementation or embodiment of the specified behavior or functionality. A “consults” connecting line (e.g., connecting line 854, FIG. 8) indicates that one component (e.g., a decision-making process, expert system, or query engine) seeks guidance, advice, or information from another component, which provides input, expertise, or data to inform or influence the consulting component's actions or decisions. An “implemented-in” connecting line (e.g., connecting line 859, FIG. 8) indicates that one component (e.g., an algorithm, protocol, or data structure) is put into practice, coded, or expressed using another component, such as a programming language, hardware platform, or software framework, which provides the underlying infrastructure or medium for implementation.

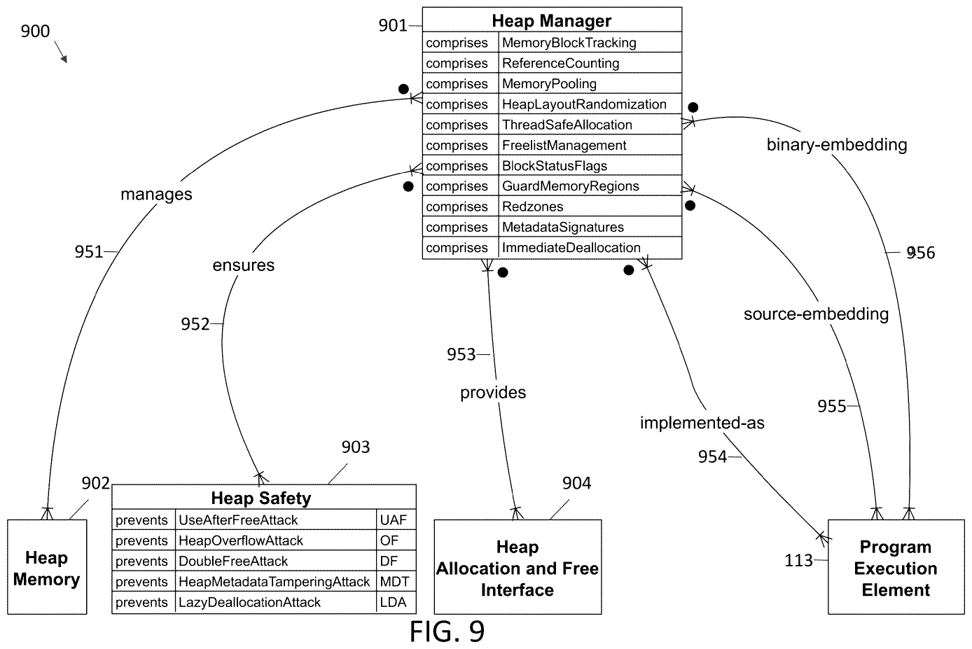

A “manages” connecting line (e.g., connecting line 951, FIG. 9) indicates that one component (e.g., a controller, administrator, or orchestrator) oversees, directs, or regulates another component, exercising control over its behavior, configuration, or resources to achieve specific goals or ensure proper functioning. A “provides” connecting line (e.g., connecting line 953, FIG. 9) indicates that one component (e.g., a service, supplier, or repository) makes available, offers, or furnishes something of value, such as data, functionality, or capabilities, to another component, which can then utilize or benefit from the provided resource. An “implemented-as” connecting line (e.g., connecting line 954, FIG. 9) indicates that one component (e.g., an abstract concept, specification, or high-level design) is realized or instantiated in a specific form or manifestation, such as a software implementation, hardware embodiment, or concrete data structure, which embodies the essential characteristics and behaviors of the original component. An “ensures” connecting line (e.g., connecting line 952, FIG. 9) indicates that one component (e.g., a security mechanism, validation protocol, or quality assurance process) guarantees, certifies, or makes certain that another component meets specific requirements, standards, or properties, such as correctness, safety, or compliance, thereby providing confidence or trust in the ensured component's behavior or output.

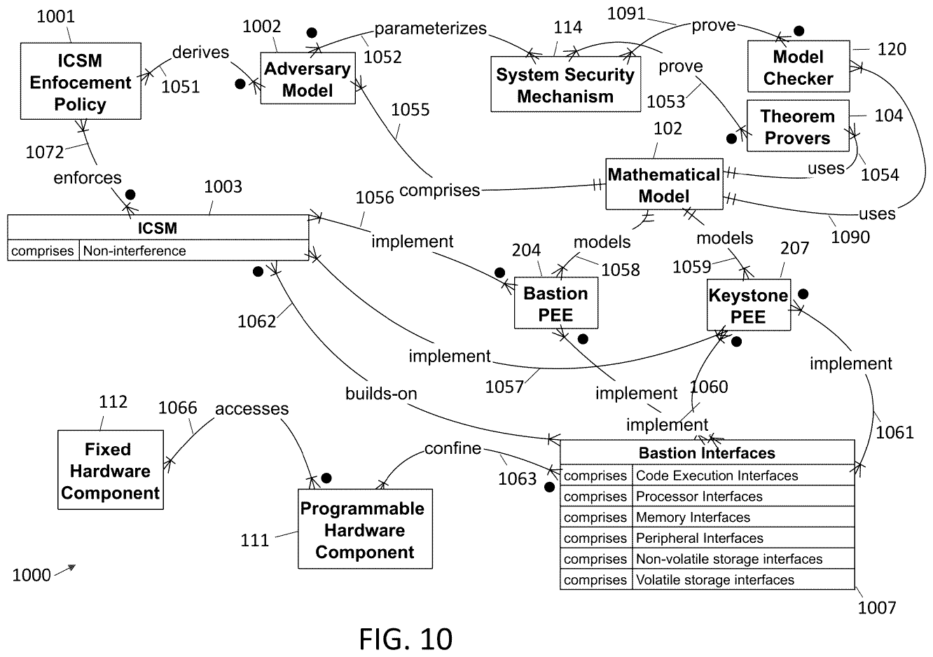

A “derives” connecting line (e.g., connecting line 1051, FIG. 10) indicates that one component (e.g., a data object or value) is obtained, calculated, or inferred from another component, which serves as its basis, source, or foundation. A “parameterizes” connecting line (e.g., connecting line 1052, FIG. 10) indicates that one component (e.g., a software module, mathematical model or algorithm) is configured, customized, or controlled by another component, which provides input values, settings, or constraints that influence its behavior or output. A “confine” connecting line (e.g., connecting line 1063, FIG. 10) indicates that one component (e.g., a security mechanism, access control system, or sandbox) restricts, limits, or bounds another component's scope, behavior, or interactions, establishing a relationship where the confining component imposes constraints or isolation on the confined component, preventing it from accessing, modifying, or interacting with other components or resources outside of its designated boundaries.

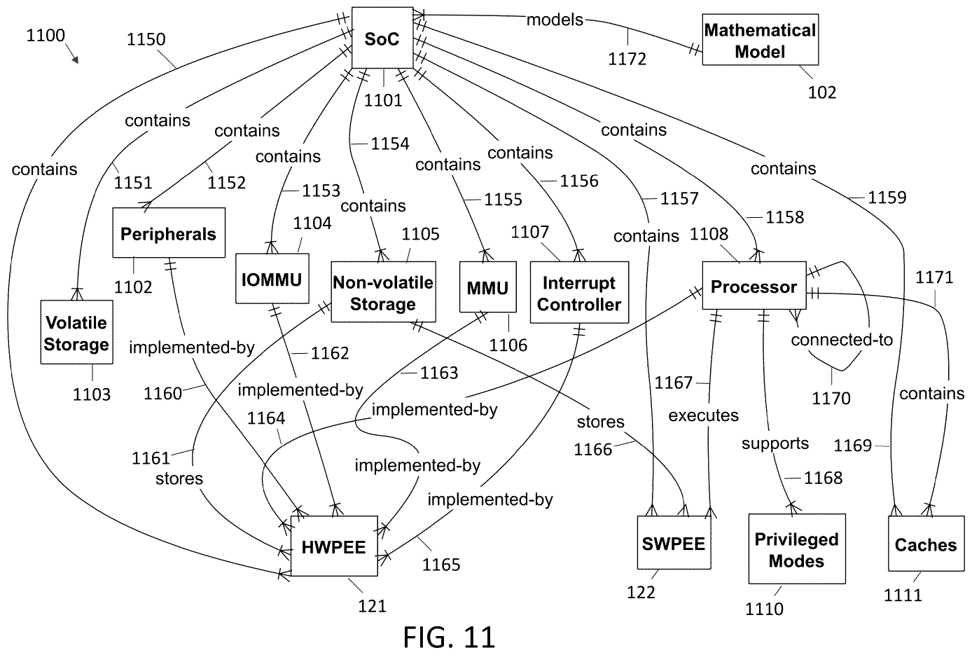

A “stores” connecting line (e.g., connecting line 1166, FIG. 11) indicates that one component (e.g., a database, file system, or memory) holds, retains, or preserves another component (e.g., data, information, or content), establishing a relationship where the storing component provides a repository or container for the stored component, allowing it to be retrieved or accessed later. An “executes” connecting line (e.g., connecting line 1167, FIG. 11) indicates that one component (e.g., a processor, interpreter, or runtime environment) performs, runs, or carries out the instructions, code, or functionality of another component, establishing a relationship where the executing component puts into action or brings to life the executed component's behavior or logic. A “supports” connecting line (e.g., connecting line 1168, FIG. 11) indicates that one component (e.g., a framework, library, or service) provides assistance, resources, or functionality that enables, facilitates, or enhances another component's operation, performance, or usability, establishing a relationship where the supporting component helps to maintain, improve, or optimize the supported component's capabilities or outcomes. A “connected-to” connecting line (e.g., connecting line 1170, FIG. 11) indicates that one component (e.g., a device, node, or endpoint) is linked, coupled, or associated with another component, establishing a relationship where the connected components can exchange information, communicate, or interact with each other, either directly or indirectly, through a shared interface, network, or medium.

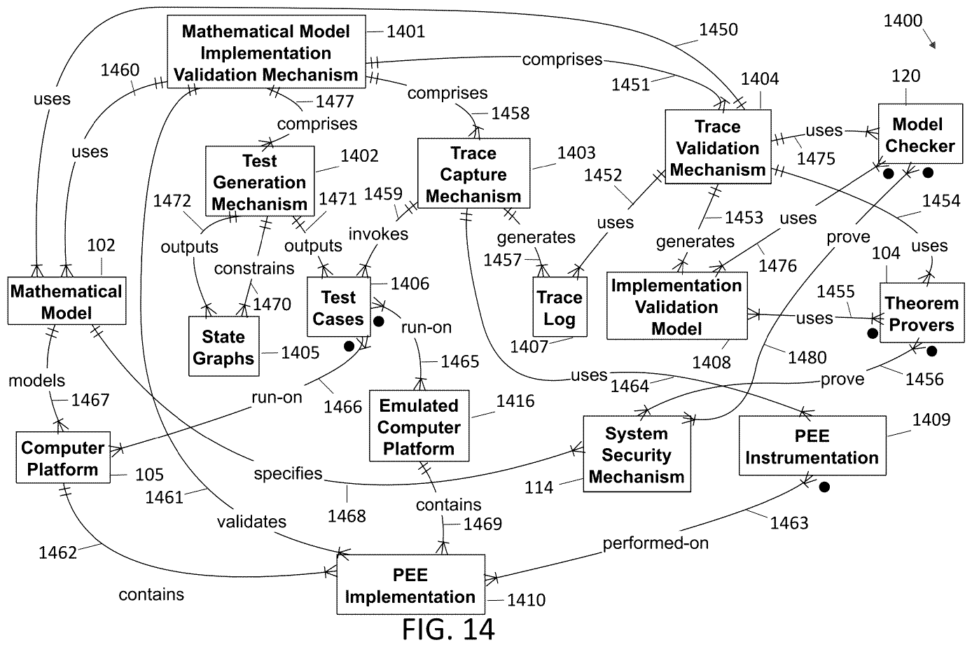

An “outputs” connecting line (e.g., connecting line 1472, FIG. 14) indicates that one component produces or provides data, results, or information to another component, which can then use or process this output for further computation or decision-making. An “invokes” connecting line (e.g., connecting line 1459, FIG. 14) indicates that one component activates, triggers, or calls upon another component to perform a specific task, operation, or function, potentially passing input parameters or data to it. A “constrains” connecting line (e.g., connecting line 1470, FIG. 14) indicates that one component limits, restricts, or imposes conditions on the behavior, functionality, or performance of another component, which must then operate within these constraints to achieve its objectives. A “run-on” connecting line (e.g., connecting line 1466, FIG. 14) indicates that one component is executed or operates on a specific platform, infrastructure, or environment provided by another component, which enables the running component to function correctly and efficiently. A “generates” connecting line (e.g., connecting line 1457, FIG. 14) indicates that one component creates, produces, or synthesizes new data, content, or information from input parameters, algorithms, or other sources, which can then be used by other components for further processing or analysis. A “validates” connecting line (e.g., connecting line 1461, FIG. 14) indicates that one component checks, verifies, or ensures the correctness, accuracy, or consistency of data, information, or results produced by another component, which helps to maintain data integrity and prevent errors. An “specifies” connecting line (e.g., connecting line 1468, FIG. 14) indicates that one component defines, describes, or prescribes the requirements, characteristics, or behavior of another component, which must then conform to these specifications to meet its intended purpose or functionality.

FIG. 1 shows a system 100 for provably secure hardware and software co-design. In system 100 computer platform 105 comprises one or more Fixed Hardware Component (FHC) 112, one or more Programmable Hardware Components (PHC) 111 and one or more Program Execution Elements (PEE) 113 (see connecting lines 166, 165 and 169 respectively). PEE 113 comprises one or more Software PEEs (SWPEE) 122 and one or more Hardware PEEs (HWPEE) 121 (see connecting lines 183 and 185 respectively). One or more SWPEE 122 accesses one or more HWPEE 121 (see connecting line 190). One or more HWPEE 121 implement one or more PHC 111 (see connecting line 168). One or more PHC 111 accesses one or more FHC 112 (see connecting line 184). A mathematical model 102 models one or more Computer Platform 105 and one or more PEE 113 (see connecting line 155 and 154 respectively). Mathematical model 102 enforces one or more System Security Mechanisms (SSM)s 114 (see connecting line 153) and uses one or more theorem provers 104 or one or more Model checkers 120 (see connecting lines 156 and 181 respectively) to prove SSMs 114 (see connecting line 157 and 182 respectively). SSMs 114 consist of stack Safety 110, code Safety 109, data safety 108, heap safety 106, Privilege separation 116, and Non-interference 125 (For the sake of readability of FIG. 1, no connecting lines are drawn for these relationships.). Stack safety 110 may be embedded in source into PEE 113 (see connecting line 162) or embedded in binary into PEE 113 (see connecting line 163). Code safety 109 and data safety 108 build on stack safety 110 (see connecting lines 161 and 160, respectively) and the corresponding source or binary embeddings. Heap safety 106 further builds on code safety 109 and data safety 108 (see connecting lines 159 and 158, respectively). Privilege separation 116 builds on heap safety 106 (see connecting line 171). Interface Confined Security Mechanism (ICSM) 103 builds on Privilege separation 116 (see connecting line 170). Finally, Non-interference 125 builds on ICSM 103 (see connecting line 191).

PEEs 113 are self-contained units of code that execute independently within their own memory address space, providing a sandboxed environment to isolate application code from firmware, hypervisors, and other PEEs. This separation of concerns enables robust security, fine-grained control over code execution, and efficient management of program execution, making it an ideal solution for developing secure by design software applications.

Code Safety 109 ensures that programming instructions constituting the execution flow of the PEE are immutable and cannot be modified or altered after they have been loaded into memory, thereby preventing accidental or malicious modifications that could compromise PEE execution integrity.

Data safety 108 protects sensitive information stored in PEEl data variables, by surrounding each variable definition with guard memory regions, which serve as a protective layer against unauthorized modifications.

Stack safety 110 protects PEEs from stack-based attacks by introducing a function hash comparison, meta-stack mechanism, validating control-flow targets, and aligning them correctly to prevent attackers from exploiting misaligned control-flow.

Privilege separation 116 ensures secure execution by segregating and controlling all function calls within a PEE domain, enforcing strict access control policies and validating each function call to prevent unauthorized access or escalation of privileges.

Heap safety 106 provides a robust defense against malicious activities aimed at compromising the integrity and security of the computer system's heap memory management by implementing various protection mechanisms, including memory block tracking, reference counting, memory pooling, and heap layout randomization. These measures collectively prevent common heap-related vulnerabilities such as use-after-free (UAF), heap overflow (OF), double-free (DF), heap metadata tampering (MDT), and lazy deallocation (LDA) attacks.

These aspects may make some embodiments an attractive solution for use in a wide range of applications, including but not limited to financial services, healthcare, education, government, and e-commerce.

### Program Execution Elements (PEE)

In modern computing systems, multiple software components coexist and interact with one another to provide a seamless user experience. At the lowest level, firmware is responsible for initializing and configuring hardware components, such as memory management, I/O operations, and clocking. Firmware executes directly on the hardware, providing a bridge between the physical components and the operating system.

The next layer up is the hypervisor, also known as a virtual machine monitor, which creates and manages multiple virtual machines that run isolated OS instances. A hypervisor can be thought of as a “host” for multiple OS guests, allowing them to share the same physical hardware resources while maintaining separate execution environments. Above the hypervisor, one or more operating systems are installed, which provide a runtime environment for applications and system services. Within these operating systems, additional isolation mechanisms such as containers and namespaces can be used to further segregate applications and services, providing an extra layer of security and resource management.

However, current computing systems have several limitations and vulnerabilities due to their layered architecture. For instance, firmware and hypervisors can be vulnerable to attacks, as they often rely on outdated code and lack robust security features. Moreover, the complexity of modern operating systems makes it challenging to develop secure and efficient software applications.

FIG. 2 shows a system 200 comprising PEEs 113 that executes on a computer platform 105 (see FIG. 1) in a memory address space 201. PEEs 113 consist of Hardware PEEs (HWPEE) 121 and Software PEEs (SWPEE) 122 (For the sake of readability of FIG. 2, no connecting lines are drawn for these relationships.). In system 200 each PEE 113 executes across one or more memory address spaces 201 (see connecting line 264). PEE 113 may comprise one or more of Bastion PEE (BPEE) 204 (see connecting line 255) and one or more of Domain PEE (DPEE) 205 (see connecting line 253). DPEEs 205 are PEEs that operate within a memory address space 201 potentially executing code that is not entirely trustworthy. BPEEs 204 are PEEs that are designed to be highly secure and trustworthy, responsible for enforcing system security mechanisms and protecting against adversarial tampering. BPEEs act as a robust guardian of the system, ensuring the integrity and confidentiality of sensitive data and computations. BPEEs are typically responsible for managing and overseeing other program execution elements, including DPEEs 205.

DPEEs 205 are typically managed and overseen by Bastion PEEs 204, which provide protection and oversight to prevent malicious behavior. Domain PEEs may execute a wide range of code, including applications, services, or other programs, and are designed to be isolated from sensitive system components to prevent potential security breaches.

One or more BPEEs 204 comprises one or more Keystone PEE (KPEE) 207 (see connecting line 258). KPEEs are PEEs that ensure fundamental security mechanisms of the system. KPEEs perform critical functions such as setting up memory protections, configuring processor state, and initializing other essential security mechanisms. KPEEs provide the base layer of security upon which the rest of the system relies, and establish and maintain the constrained environment of DPEEs 205, ensuring the integrity and trustworthiness of the environment.

One or more BPEEs 204, DPEEs 205 and KPEEs 207 may further comprise (see connecting lines 257, 259 and 263 respectively) one or more functions 208 that addresses the aforementioned limitations. PEE functions 208 comprise public and private functions that perform initialization, service interrupts and handle regular processing.

In addition to containing functions, program execution elements (PEEs) can also be composed of other nested PEEs, allowing for a hierarchical organization of execution environments. One or more DPEEs may comprise zero or more nested DPEEs (see connecting line 262) and may comprise zero or more nested BPEEs (see connecting line 264). One or more BPEE may comprise zero or more nested BPEEs (see connecting line 265) and may comprise zero or more nested DPEEs (see connecting line 252). Similarly, one or more KPEE may comprise zero or more nested DPEEs (see connecting line 266). This nested structure enables complex scenarios where a PEE acts as a host or container for other PEEs, each potentially executing its own set of functions or further nested PEEs. An exemplary embodiment of such an organization is a PEE that represents a host kernel executing another PEE, which in turn is a container under the Linux operating system. This container PEE can then host a set of process PEEs that execute within the confines of the container, illustrating a layered approach to program execution where each layer is a distinct PEE. This capability to embed PEEs within one another facilitates flexible and efficient management of computational resources, enabling the present invention to support a wide range of application scenarios, from simple function executions to complex, distributed computing environments.

In system 200, each PEE 113 provides a sandboxed environment that isolates application code from firmware, hypervisors, and other PEEs. This separation of concerns enables robust security.

KPEEs 207 have the highest privilege in a given memory address space 201. BPEE 204 has a lower privilege than a KPEE 207 and may house operating kernels or hypervisors as well as dependent libraries in a given memory address space. Finally, DPEE 205 has a lower privilege level than both KPEE and BPEE and may house applications and supporting libraries. KPEEs 207 are responsible for loading other PEEs in a given memory address space.

PEEs 113 may further comprise one or more functions 208, which form the unit of functionality of the PEE. Each function can be a standalone entity that performs specific tasks or operations within the PEE. PEE functions 208 further comprises one or more initialization functions that are responsible for initializing the PEE, one or more interrupt functions to handle platform device interrupts, providing a way to interact with hardware elements and a set of regular functions that together accomplish PEE functionality. Public functions can be called from functions of other PEE objects, enabling inter-PEE communication and collaboration. Private functions are only callable from functions within the said PEE object, ensuring secure access control.

PEE functions 208 can be embodied in various forms depending on the type of PEE. For example, if the PEE is a container, the public initialization function may be the container's first process main function, the public interrupt function may be the namespace interrupt handler, and the public regular functions may be container sockets providing services or named pipes or shared memory for inter-container communication. Similarly, if the PEE is a virtual machine (VM), the public initialization function can be the VM entry point, the public interrupt function can be the VM interrupt handler stubs, and the public regular functions can be VM downcalls or socket endpoints or shared memory. If the PEE is an operating system (OS) kernel, the public initialization function may be the kernel init function, the public interrupt functions may be kernel interrupt handlers, and the public regular functions may be kernel-provided system calls. If the PEE is a hypervisor, then the public initialization function may be the hypervisor init function, the public interrupt functions may be hypervisor interrupt handlers, and the public regular functions may be hypervisor-provided hypercalls. If the PEE is a HWPEE and is implementing a processor in the computer platform, then the public initialization function may be the function that initializes the PHC clocks and power systems, the public interrupt function may be the function that implements processor interrupt and trap handling mechanisms, and the regular functions may be processor-provided instructions that are available to use by other HWPEEs and SWPEEs. Finally, if the PEE is firmware, the public initialization function may be the firmware init function, the public interrupt functions may be firmware machine interrupt handlers, and the public regular functions may be firmware support calls (e.g., BIOS calls). In all cases, the PEE's private functions are isolated to be only invoked within the PEE and may be a single monolithic function or a group of functions spanning applications, libraries, etc.

PEE memory regions in a given memory address space 201 comprises one or more code regions that contain PEE functions. PEE global data variables can be accessed by all parts of the PEE, retaining their values even after function execution has completed. Heaps provide dynamic memory areas for allocating memory to store variables whose size may vary. Stacks store temporary data that may be quickly used and discarded such as function parameters, local variables, and return addresses.

The operational semantics of a PEE functions further comprise reading and/or writing to global variables, reading and/or writing to stack, reading and/or writing to heap, allocating and freeing heaps, calling other PEE functions within the PEE or across PEEs within a memory address space and across memory address spaces, and returning to parent PEE function.

The PEE memory map is the layout of PEE components in a given memory address space. The PEE memory map may be randomized to ensure that the placement of the PEE components in a given memory address space is different each time the PEE loads into memory. This randomization mitigates various types of attacks and vulnerabilities by making it challenging for attackers to predict and exploit specific memory locations.

The system may comprise a set of HWPEEs that implement processors of various architectures including x86, ARM, and RISC-V architectures. Further the system may comprise a set of SWPEEs and HWPEEs running various operating systems such as Windows, Linux, FreeBSD etc. For example, with a set of HWPEEs and SWPEEs implementing an x86 processor running Windows, the KPEE 207 can provide a secure boot-strapping environment for the Windows operating system and the BPEE 204 can house the Windows kernel, while the KPEE ensures that other applications are loaded and executed in respective DPEEs.

In some embodiments, the DPEE comprises a banking application that requires secure data storage and retrieval mechanisms. The BPEE provides the secure base operating environment and provides additional security features for the banking application, such as encryption and decryption services. The KPEE can ensure that only authorized DPEEs are loaded into memory to prevent unauthorized access to sensitive data.

In a further embodiment of the invention, the system can be used to develop distributed applications. For example, a DPEE can comprise a web browser application that requires secure communication mechanisms with a server-side DPEE to retrieve and display web content. The BPEE provides the secure base operating environment on both server and client and provides additional security features for the web browser application, such as encryption and decryption services.

In some embodiments of the invention, the memory and memory address space may include both volatile and non-volatile memory storage mediums including but not limited to Static Random-Access Memory (SRAM), Dynamic Random-Access Memory (DRAM). Read-only memory (ROM), logic gates, digital circuits that implement storage such as flip-flops etc.

In other embodiments of the invention, a set of HWPEEs can implement various peripheral or computer platform device functionality ranging from USB, HDMI, Ethernet, WiFi, serial devices and memory and storage controllers.

The system architecture may provide a more secure, efficient, and flexible way to develop secure by design software applications. By separating program execution into different PEEs, mathematically modeling their operational semantics, and ensuring each component's isolation, the proposed system addresses several limitations and vulnerabilities inherent in traditional computing systems.

### Trusted Path Security Mechanism (TPSM)

The systems and methods may include a Trusted Path Security Mechanism (TPSM) that enforces permitted patterns of computer platform operations without adversarial influence. Such computer platform operations can be one or more of memory access operations, peripheral access operations, processor operations including execution of processor instructions, and operations involving access and manipulation of processor, memory or peripheral state. TPSM therefore establishes secure code execution and reliable data communication pathways between PEEs and between PEEs and computer platform hardware.

TPSM may be embodied in various configurations involving PEEs 113, offering a flexible and robust security solution. In different embodiments, TPSM can span multiple PEEs, both within and across individual PEEs, as well as between PEEs and computer platform hardware. For instance, TPSM can be established between public and private functions 208 of Keystone PEEs (KPEEs) 207 or Bastion PEEs (BPEEs) 204, enabling secure communication within these trusted environments either in PHC, software or a combination of both PHC and software. Additionally, TPSM can facilitate secure interactions between public functions 208 of KPEEs 207, BPEEs 204, and Domain PEEs (DPEEs) 205, allowing for protected data exchange across different types of PEEs. Furthermore, TPSM can be implemented between DPEEs 205 themselves, ensuring secure communication among these elements. The scope of TPSM is not limited to interactions between PEEs, as it can also be established between PEE functions 208 and computer platform Programmable Hardware Components (PHC) 111, providing an end-to-end security solution that bridges the gap between software and hardware components. By supporting various configurations and spanning multiple PEEs and hardware components, TPSM provides a comprehensive security mechanism that can be tailored to meet the specific needs of different applications and systems.

TPSM encompasses four key mechanisms-temporal memory safety, which ensures that memory accesses are valid and do not compromise the integrity of the system, handled via heap safety mechanisms; spatial memory safety, which ensures that data is accessed and manipulated in a secure and controlled manner, handled via data safety mechanisms; control flow integrity, which ensures that the execution of code follows a predictable and authorized path, handled via code safety and stack safety mechanisms; and privilege separation, which ensures that different components of the system operate with the appropriate level of privilege and access control. These mechanisms may be implemented, for example, in any suitable combination of hardware and software.

TPSM may be implemented in various embodiments, including combinations of hardware and software components. For example, TPSM may be established between two PEEs (e.g., PEE A and PEE B) that communicate via shared memory regions. Alternatively, a PEE at a lower privilege level may invoke a set of functions provided by a PEE executing at a higher privilege level to establish a TPSM. Additionally, a PEE may write data to a storage device (such as a disk) and read from it, with the storage device being one example of a peripheral that can be used to establish a TPSM. Other peripherals, such as networks, keyboards, or other input/output devices, may also be used.

In one embodiment, TPSM may involve PEEs that house virtual machines communicating via a hypervisor and containers communicating with each other or the host kernel.

A subset of the set of PEEs may be implemented in low-level programming languages such as Verilog, System-Verilog, C, C++ and Assembly that offer fine-grained control over hardware resources and performance optimization capabilities, suited for programming functionality of hardware components and software components such as kernels and high-performance applications. A subset of the set of PEEs may be implemented in a high-level programming language such as Python, Rust and Java that have designed-in features of memory safety guarantees and type systems that help prevent common vulnerabilities and ensure integrity of code execution.

In some embodiments, the subset of the set of PEEs that are implemented in low-level programming languages may enforce one or more TPSM. In other embodiments, the subset of the set of PEEs that are implemented in high-level programming languages may enforce one or more TPSM. In some embodiments, the subset of the set of PEEs that are implemented in high-level programming languages may enforce a subset of the TPSM such as temporal memory safety and spatial memory safety. In one embodiment, a combination of the subset of PEEs implemented in low-level programming language and the subset of PEEs implemented in high-level programming language may enforce one or more TPSM.

### PEE Code Safety Mechanism

PEE code safety mechanism ensures that the programming instructions constituting the execution flow of the PEE cannot be modified or altered after they have been loaded into memory. This mechanism ensures that the original code remains unchanged, preventing accidental or malicious modifications that could compromise PEE execution integrity. PEE code-safety mechanism also facilitates auditing and debugging, as any errors or issues can be traced back to their original source without fear of subsequent modifications obscuring the problem.

FIG. 3 shows a system 300 for enforcing code safety. System 300 includes code regions 305 that are protected in a given memory address space 201. In system 300, one or more memory address space 201 contains one or more Keystone PEE (KPEE) 207 (see connecting line 353), one or more Bastion PEEs (BPEE) 204 (see connecting line 351), and one or more Domain PEEs (DPEE) 205 (see connecting line 352). One or more KPEE 207 protects one or more code regions 305 (see connecting line 361), loads one or more DPEEs 205 (see connecting line 358), and loads one or more BPEEs 204 (see connecting line 356).

In system 300, the one or more DPEEs 205 contain one or more code regions 305 (see connecting line 369). The one or more BPEEs 204 similarly contain one or more code regions 305 (see connecting line 367) and protects one or more code regions 205 (see connecting line 362).

System 300 ensures that only authorized code is loaded and executed from memory and that their code regions 305 are marked read-only. This is accomplished through the use of memory protections for various PEEs 113 (see FIGS. 1 and 2), including both HWPEEs 121 and SWPEEs 122 and their corresponding KPEEs 207, BPEEs 204, and DPEEs 205.

The memory protections may be implemented using HWPEEs that implement a computer platform memory management unit (MMU) and/or one or more I/O memory management unit (IOMMU) and DMA controllers. IOMMUs are special purpose MMUs that help setting memory protections against Direct Memory Access (DMA) from peripherals. Similarly, DMA controllers are special purpose peripherals accessed from the platform processor that controls DMA from the rest of the peripherals in the computer platform. The memory protections may also be implemented by using features of the PHC 111 such as e-fuses or combinatorial logic.

In some embodiments of system 300, a higher privileged KPEE 207 configures the MMU, IOMMU and DMA controllers at a different memory address space to set code regions 305 as read-only, thereby preventing unauthorized modifications to the code regions 305.

Alternatively, software based verification and/or software fault isolation may be used within the PEE 113 source code or binary code to enforce these protections. This ensures that only authorized modifications are made to the code regions, thereby preventing malicious activities such as malware execution or code tampering.

The same approach is applied to the BPEEs 204 and DPEEs 205, where either HWPEEs that implement computer platform MMU, IOMMU and/or DMA controller configuration set by KPEE 207 within the same memory address space 201 or a higher-privileged KPEE 207 within a different memory address space 201 are used to set code regions 305 as read-only. Alternatively, software based verification and/or software fault isolation is enforced within BPEE 204 and DPEE 205 source code or binary code. The aforementioned approach may be applied, for example, to all PEEs 113 in system 300.

### PEE Data Safety Mechanism

The data variables are critical components of a PEE memory layout, playing a vital role in the execution of functions and access to shared data. Global data variables may be shared among multiple functions within the same PEE, storing valuable information such as configuration settings, authentication credentials, or sensitive user data. Securing these components is essential because they represent a high-value target for attackers seeking to compromise the integrity of a PEE execution or gain unauthorized access to sensitive information. By tampering with global data variables, an attacker can manipulate function control flow, inject malicious code, or steal confidential data, highlighting the importance of protecting these critical memory regions

FIG. 4 shows a system 400 for enforcing data safety where data regions 407 containing variables 409 are protected in a given memory address space 201. In system 400, one or more memory address spaces 201 contain one or more KPEEs 207 (see connecting line 452), one or more BPEEs 204 (see connecting line 451), and one or more DPEEs 205 (see connecting line 453). The one or more KPEEs 207 contain one or more data regions 407 (see connecting line 458), load one or more DPEE 205 (see connecting line 459), load one or more BPEEs 204 (see connecting line 461), protect one or more GOT regions 406 (see connecting line 457), and protect one or more data guard regions 408 (see connecting line 455).

In system 400, one or more DPEEs 205 contain one or more data regions 407 (see connecting line 468). In system 400, one or more BPEEs 204 similarly contain one or more data regions 407 (see connecting line 469).

In system 400, one or more data regions 407 contain one or more variables 409 (see connecting line 470). The one or more variables 409 is encapsulated by one or more data guard regions 408 (see connecting line 471) and bounded by one or more data bounds safety mechanisms 410 (see connecting line 473).

System 400 may employ distinct mechanisms to protect global data variables 409 in the PEEs 113, providing a robust defense against unauthorized data modifications.

In some embodiments HWPEEs and SWPEEs are used to memory-protect data regions 407 by making them read-only, ensuring that attackers cannot modify or manipulate entries in data regions 407. A first mechanism leverages HWPEE (that implement computer platform's MMU, IOMMU and/or DMA controller) configuration by KPEE 207 within the same memory address space 201 or a higher-privileged KPEE 207 within a different memory address space 201. By configuring the MMU, system 400 ensures that any attempts to write to data regions 407 will be trapped and prevented, thereby protecting the integrity of data regions 407. A second mechanism involves software-based verification and enforcement of the read-only protection of the data regions 407 within the PEE 113 source code or binary code. By using code analysis and validation techniques, the system ensures that any modifications to the data regions 407 are detected and prevented, maintaining their security and integrity.

Another mechanism involves protecting global data variables 409 by surrounding each global variable definition with data guard regions 408 which are essentially dedicated guard memory regions. Each global variable 409 definition is preceded and succeeded by these guard memory regions, which serve as a protective layer around the sensitive data. By adding these guard regions, system 400 ensures that any modifications outside of the bounds of the global variables will be detected and prevented. The protection of guard memory regions 408 involves combining both hardware and software mechanisms, ensuring that they are marked read-only via: (a) leveraging the computer platform's MMU (implemented by a set of HWPEEs) configuration by KPEE 207 within the same memory address space 201 or a higher-privileged KPEE 207 within a different memory address space 201; and/or (b) relying on software-based mechanisms to verify and enforce the read-only protection of guard memory regions 408 within PEE 113 source code or binary code.

Data bounds safety mechanism 410 ensures that all memory accesses of variables 409 are performed within the valid bounds of the variable, preventing common errors such as buffer overflows and other spatial memory safety violations. Data bounds safety mechanism 410 associates each variable with a bounds metadata structure, which contains information about the variable's size and alignment. For both global and local variables, specific metadata is generated at compile-time and stored in the PEE's binaries. At runtime checks are emitted in the PEE code region to consult the metadata and ensure safe variable memory access. In addition, data bounds safety mechanism 410 handles pointer variables by tracking the pointer's provenance and ensuring that it points to a valid variable within the program's memory space.

Data bounds safety mechanism 410 provides strong guarantees about the safety of memory accesses for all types of variables, including local, global, and pointer variables. For local variables, mechanism 410 ensures that all accesses are bounded by the variable's stack frame, preventing overflows into adjacent stack frames or other sensitive areas of memory. For global variables, mechanism 410 checks that all accesses are within the bounds of the variable's allocated storage, preventing buffer overflows or other spatial memory safety violations. For pointer variables, mechanism 410 includes a series of checks to ensure that the pointer is valid and points to a legitimate variable, including checking the pointer's type, provenance, and bounds. This mechanism can be applied to a wide range of programming languages including low-level languages such as Verilog, System-verilog, C, C++ and Assembly.

By employing the aforementioned distinct mechanisms, system 400 provides a robust defense against unauthorized modifications to PEE variables 409, thereby ensuring the data integrity and security of PEEs 113. The system's flexibility allows different embodiments to adopt a subset of these data safety mechanisms based on the specific requirements of each PEE. For instance, a DPEE that is implemented as a virtual machine or container may only utilize data guard regions mechanisms, whereas a BPEE that is part of a secure kernel may employ both data guard regions and data protections. In contrast, a KPEE may employ all three data safety mechanisms—data guard regions, data protections, and data bounds safety—to provide comprehensive protection. This tiered approach enables PEE data safety to be enforced at a desired level of granularity, tailored to the trustworthiness of each PEE. For example, a DPEE running untrusted software may only require data guard regions to be enforced, thereby protecting other PEEs from potential security breaches, while a more trusted PEE may warrant additional protections to ensure its integrity and security.

In some embodiments of the present invention, a PEE operating at a lower privilege level may have its data safety mechanism enforced by a higher privileged PEE. In this embodiment, the first PEE to get control in the computer platform may have the highest privilege level and the PEE data safety mechanism implemented using the data bounds safety mechanism for its initialization function. This highest privileged PEE may in turn set the data guard memory regions of the PEE with a lower privilege level as read-only. Further, the highest privileged PEE may use HWPEEs that implement computer platform Memory Management Unit (MMU), IOMMU and/or DMA controller configuration to set the read-only protection of memory regions. Alternatively, software verification and/or software fault isolation mechanisms can be directly employed in the PEE with the lower privilege to set the read-only protection of memory regions.

### PEE Stack Safety Mechanism

The PEE function call stack, or simply “the stack”, is a region of memory where function calls may be stored during PEE execution. It's a Last-In-First-Out (LIFO) data structure that keeps track of the functions that have been called but not yet returned, allowing the program to properly manage its execution flow and prevent unexpected behavior. Securing the stack is crucial because it can be vulnerable to exploitation by malicious attackers through buffer overflow attacks, which involve overflowing a buffer with more data than it's designed to hold, potentially overwriting sensitive information or executing arbitrary code on the stack. This can lead to security breaches, privilege escalation, or even complete system crashes.

PEE indirect calls refer to function calls where the destination function's memory address is not directly specified, but rather retrieved from another location in memory, such as a table or an array of function pointers. This mechanism allows for dynamic dispatching and polymorphism in programming languages used to program the PEE. However, indirect calls can also introduce security vulnerabilities if not properly secured. If an attacker can manipulate the contents of the target memory location, they may be able to redirect control flow to malicious code, leading to unauthorized execution of functions or even arbitrary code injection. Securing indirect calls is crucial because it prevents attackers from hijacking program flow and executing malicious payloads.

FIG. 5 shows a system 500 for enforcing stack safety where code regions 305 of PEEs 113 are protected with forward-edge control flow integrity (CFI) 504, backward-edge CFI 505 and stack canary 508 and ensures that PEEs execute safely and securely by preventing unauthorized control flow, modifying return memory addresses or PHC state space, or exploiting misaligned jumps. In system 500 a stack safety security mechanism 501 is embedded within one or more PEEs 113 (see connecting line 551). One or more PEEs 113 contains one or more code regions 305 (see connecting line 552) and one or more stack regions 506 (see connecting line 556). One or more code regions 305 in turn contain one or more forward-edge CFI mechanisms 504 (see connecting line 553), one or more backward-edge CFI mechanisms 505 (see connecting line 555), and one or more direct and indirect calls 509 handlers 509 (see connecting line 554). One or more direct and indirect calls handlers 509 in turn reference one or more stack regions 506 (see connecting line 559). One or more stack regions 506 contains one or more stack frames 507 (see connecting line 557) and finally one or more stack frames 507 contains one or more stack canaries 508 (see connecting line 558).

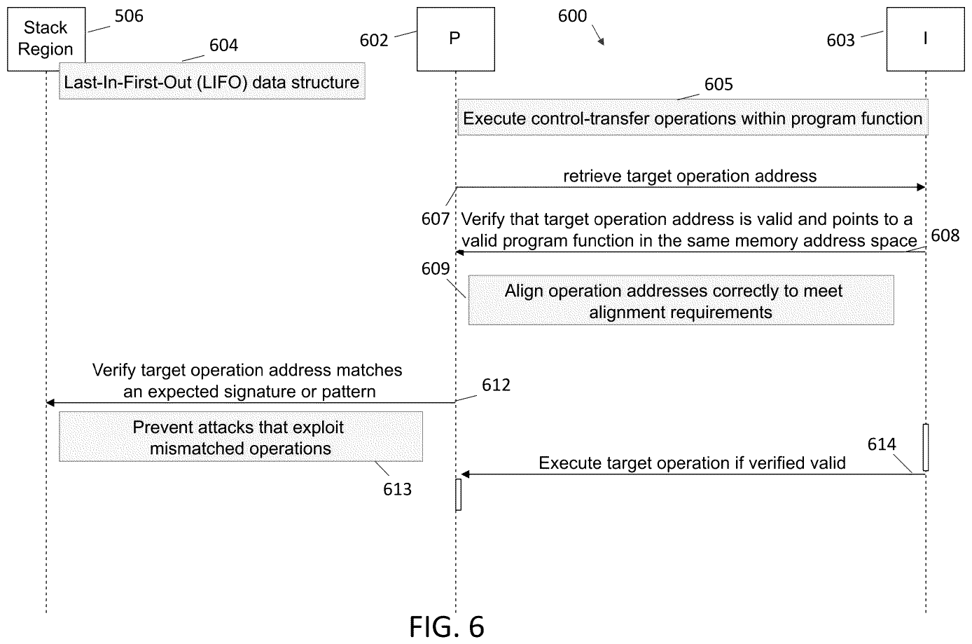

Some embodiments include forward edge CFI mechanism 504 for protecting PEE 113 functions. FIG. 6 depicts a method 600 as a time sequence diagram according to some embodiments. Method 600 may be executed, for example, by systems 100, 200, 300, 400, 500, and/or combinations thereof. Though, method 600 may be implemented in any suitable way. In method 600 time flow increases from top to bottom. As mentioned previously a LIFO data structure 604 is used for stack region 506. LIFO data structure 604 ensures that control-transfer operations within a program function point to valid memory addresses or PHC state-space states. When a control-transfer operation is executed (step 605), method 600 retrieves target operation address (which may be an instruction memory address or PHC state address) at function call (step 607) and validates whether the target operation address is within the valid PEE code region or points to a valid PEE function of an external PEE in the same memory address space 201. This scheme also aligns target function operation addresses correctly to meet alignment requirements (step 609) and verifies that operation targets match expected signature or pattern (e.g., function code hash or a hash of the function prototype) (step 612), preventing attacks that exploit mismatched operations (step 613). If the operation targets match the expected signature or pattern, then the target operation is executed (step 614).

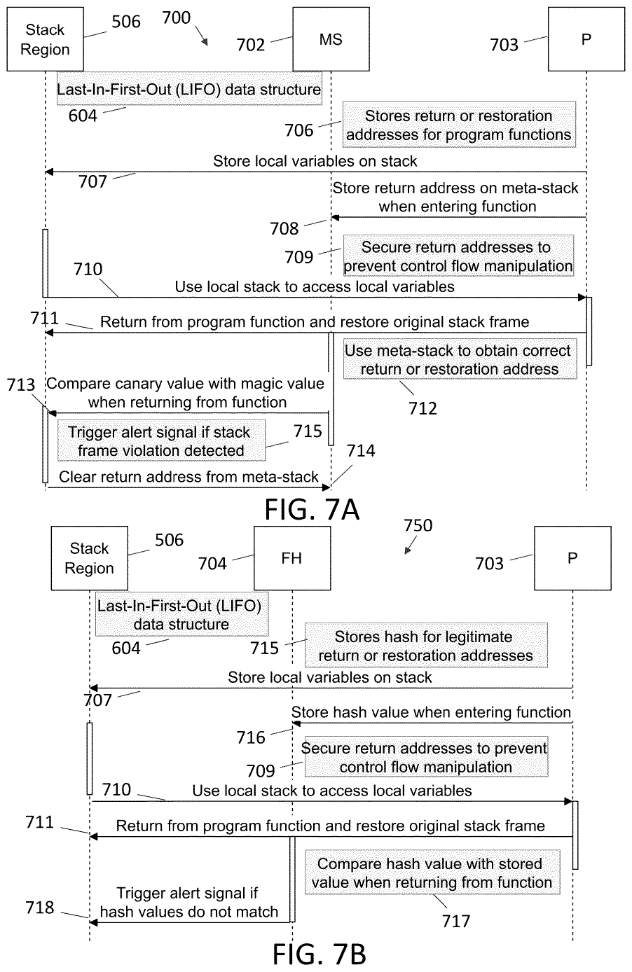

FIG. 7A shows a method 700 that uses a backward edge CFI 505 protection mechanism for PEE 113 functions. This mechanism prevents attackers from modifying return memory addresses or PHC state-space addresses on the stack, ensuring that control flow returns to a valid memory address or PHC state-space in the PEE code upon execution of a return or restoration operation. A valid memory address or PHC state-space address is a memory address or PHC state-space address of the operation following a prior branch operation or to a set of memory addresses or PHC state-space addresses that is set up by the PEE to which a return or restoration operation is permitted to transfer control to.

In one embodiment the system achieves backward edge CFI by introducing a meta-stack (MS) mechanism 702, where every PEE 113 function has a local stack memory region 506 for storing local variables and a meta-stack mechanism 702 for storing return memory addresses or PHC state-space addresses. As mentioned previously, LIFO data structure 604 is used for the stack region 506. The meta-stack mechanism 702 works by storing return memory addresses or PHC state-space addresses for PEE 113 functions (step 706) on meta-stack mechanism 702 and local variables (step 707) on local stack region 506.

In some embodiments, when a PEE 113 function is called, it stores its return memory address or PHC state-space address on the meta-stack mechanism 702 (step 708). Upon return or restoration from the function, method 700 uses meta stack mechanism 702 to obtain the correct return address 712 and returns from the PEE 113 function to restore the original stack frame 507 (step 711). The PEE 113 function writes to local variables using local stack region 506 (step 710).

The system may include a stack-frame 507 protection mechanism that prevents attackers from modifying the contents and layout of each stack frame. This is achieved by storing magic stack canary 508 values at predetermined locations within the stack frames 507, specifically at the beginning of the stack frames 507 before the memory location of the first local variable (FIG. 7). In some embodiments the stack canary 508 can be a randomized value initialized when a PEE is loaded into a memory address space.

When a return or restoration operation is executed in the program function, the system compares the canary value associated with the current stack frame to a predetermined magic value (step 713) stored in association with each stack canary value. If the compared values do not match, the system triggers an alert signal to log the stack frame violation (step 715). If the compared values match the system clears the return or restoration address from meta-stack mechanism 702 and returns back to the caller.

In some embodiments of the system, the stack canary 508 is a random value generated once per PEE execution and stored in a dedicated memory address that is again randomly selected once per PEE execution. The stack canary is then loaded from the dedicated memory address and stored at the memory address at the beginning of stack frame when a PEE function starts execution. When the return instruction is executed in the PEE function, the system compares the canary value stored at the memory address at the beginning of the stack frame with the value in the dedicated memory address.

Another embodiment of the system is illustrated by method 750 shown in FIG. 7B which achieves backward edge CFI 505 using function hashes 704. Every PEE 113 function has a local stack region 506 for storing local variables which is a LIFO data structure 604. The scheme stores function hashes for legitimate return or restoration addresses (step 715). Local variables are stored in the local stack region (step 707) and accessed from there (step 710). The location of the return hash value is stored in the code region 305 which secures return or restoration addresses to prevent control flow manipulation (step 709). When a function returns, the hash value at the return location in the code region is compared with the stored value on function entry (step 717). If there is a mismatch an alert is triggered (step 718). If the hash values match the original stack frame is restored and control is transferred back to the caller (step 711).

The aforementioned mechanisms may ensure that control flow is executed correctly within PEE source code or binary code and can be implemented using various techniques, including (a) solely via PHC capabilities and HWPEEs, (b) solely via software capabilities and SWPEEs and (c) in a hybrid fashion that combines both hardware and software capabilities and HWPEEs and SWPEEs. In some embodiments the forward edge CFI mechanism and backward edge CFI mechanism can be implemented on the PEE source code leveraging the corresponding programming language constructs (e.g., Verilog, C, C++ and Assembly). In some embodiments the forward edge CFI mechanism and the backward edge CFI mechanism can be implemented directly on the PEE binary without access to the PEE source code. In this embodiment, binary rewriting mechanisms are used to embed the CFI protections directly into the PEE binary.

The system ensures that function safety is enforced within the program's code, regardless of whether it's executed from source or compiled into binaries. This is achieved by validating control-flow targets, aligning them correctly, protecting stack frames, and verifying call targets against hashes.

The stack safety mechanism and control flow integrity mechanism can manifest in various embodiments, ensuring safety of function calls across different types of PEEs. For instance, in a Bastion PEE (BPEE) 204, which has a set of functions, each function can be equipped with a stack safety mechanism, providing fine-grained protection against control flow attacks. Similarly, in a Keystone PEE (KPEE) 207, which also comprises multiple functions, each function can have a built-in stack safety mechanism, ensuring robust defense against control flow corruption. In contrast, a Domain PEE (DPEE) 205 can implement function safety at a coarser granularity, where a single logical function encapsulates the entire functionality of the DPEE, including nested PEEs and their associated functions running at a lower privilege level. This logical function can be protected using stack safety mechanisms enforced via HWPEEs that implement Memory Management Unit (MMU), IOMMU and DMA controllers and privilege levels, ensuring that even if the DPEE has only coarse-grained protection, it will not compromise the overall system's control flow integrity. For example, a higher-privilege KPEE or BPEE with fine-grained per-function stack safety mechanism can invoke a lower-privilege DPEE with coarse-grained single logical function stack safety, and the system as a whole will still preserve the stack safety mechanism.

To illustrate this, consider a scenario where the DPEE is a container with multiple processes, the KPEE is the host kernel, and the BPEE is the host OS container runtime and supporting libraries. In this case, the KPEE and BPEE can enforce fine-grained stack safety for each function, while the DPEE, as a container, ensures coarse-grained stack safety for its single logical function, which encompasses all its processes. Similarly, on the hypervisor front, a KPEE can be the hypervisor itself, a BPEE can be a device model or a virtual firmware interface, and a DPEE can be a guest operating system or a virtual machine, with each PEE type implementing control flow integrity mechanisms at varying granularities. Furthermore, in the context of firmware, a KPEE can be the firmware code itself, a BPEE can be a firmware component such as a device driver or a system management module, and a DPEE can be a boot loader or an operating system loader, with each PEE type enforcing control flow integrity mechanisms at different levels of granularity. In the context of a PHC, the KPEE can be a HWPEE implementing a processor, a BPEE can be a processor functional component such as a MMU. By allowing for this flexibility in implementation, the stack safety mechanism and control flow integrity mechanism ensures that safety of function calls is preserved across various PEE types and embodiments, providing robust protection against control flow attacks in a wide range of scenarios.

### PEE Privilege Separation Mechanism

PEE function call privilege separation is a critical aspect of software execution that refers to the mechanism by which different PEE functions are executed with varying levels of privileges or access rights. In conventional computer platform architectures, function calls often involve invoking a specific function from within another function, potentially escalating privileges or accessing sensitive data. However, this privilege separation can be exploited by malicious code to gain unauthorized access to system resources, leading to security vulnerabilities such as privilege escalation and other types of access control exploits.

To secure function call privilege separation, some embodiments segregate and control all function calls within and across PEEs, enforcing strict access control policies and validating each function call to prevent unauthorized access or escalation of privileges. This ensures that even if a malicious actor were to gain access to a specific function, they would still be unable to execute arbitrary code or access sensitive data without explicit permission.

FIG. 8 shows a system 800 for enforcing privilege separation among multiple caller PEE 801 and callee PEE 804 via sentinels 802 and access control matrix 805. In system 800, one or more caller PEEs 801 calls one or more sentinels 802 (see connecting line 851). Sentinel 802 in turn transfers control to one or more callee PEEs 804 (see connecting line 853). One or more callee PEEs 804 return back to the sentinel 802 (see connecting line 856) which finally resumes PEEs 113 (e.g., FIG. 1) execution after the call. Sentinel 802 consults one or more access control matrices 805 to see if the call to callee PEE 804 is authorized (see connecting line 854). In this system 800, one or more Keystone PEEs (KPEEs) 207 protect one or more access control matrices 805 (see connecting line 860) and use one or more MMUs 806 (see connecting line 855) to do so. One or more access control matrices 805 can be implemented by one or more HWPEEs 121 (see connecting line 857) or can be implemented by one or more SWPEEs 122 (see connecting line 858). One or more MMUs 806 can similarly be implemented in one or more HWPEEs 121 (see connecting line 861) or can be implemented in one or more SWPEEs 122 (see connecting line 859).

In some embodiments, sentinel 802 may be implemented as direct calls where calls to PEE 113 functions from PEE 113 functions within the same PEE can be direct. This means that if a PEE function needs to call another one within the same PEE, it can do so directly without needing to consult an external table.

In some other embodiments, sentinel 802 can be implemented as calls through PEE code regions where calls to PEE 113 functions from a caller PEE in its own memory address space 201 to a callee PEE within a caller PEE happen via the caller PEE's code regions 306. This ensures that the calling context and privileges are properly maintained.

In yet some other embodiments, sentinel 802 is implemented as calls through KPEE 207 (FIG. 2). Calls to PEE functions to a callee PEE 804 in a callee memory address space 201 from caller PEE 801 functions within a caller PEE 801 memory address space 201 happen via KPEE 207 of the caller PEE process. This means that when transitioning between processes, KPEE 207 takes responsibility for enforcing privileges and ensuring proper function call behavior.

Some embodiments further comprise a call access control matrix 805, which enforces appropriate caller-callee access control and privilege separation. Call access control matrix 805 dictates whether calls to PEE 113 functions 208 are permitted or denied based on pre-defined access control policies. By enforcing caller-callee access control, access control matrix 805 ensures that privilege separation is maintained across function calls within and across PEEs.

In some embodiments, access control is implemented through dedicated HWPEEs 121, which provides a secure and efficient mechanism for enforcing privileges. In some other embodiments, access control matrix 805 is implemented via SWPEEs 122 embedded within the source or binary code of the PEE 113. In yet other embodiments, access control matrix 805 is implemented through one or more dedicated PEEs, which serve as a separate and isolated environment for enforcing privileges and controlling function calls.

In summary, system 800 may ensure that privilege separation is enforced throughout the system at all times by (a) providing multiple methods for controlling and validating function calls within the PEE and (b) implementing an access control matrix to enforce caller-callee access control and privilege separation. By combining these features, system 800 may ensure that function calls are properly validated and privileged, preventing unauthorized access or escalation of privileges within and across PEEs.

### PEE Heap Safety Mechanism

The PEE heap is a region of memory where dynamically allocated data is stored, allowing PEEs to manage large blocks of data efficiently. The heap serves as a temporary storage area for variables, objects, and other data structures, enabling PEEs to allocate and deallocate memory as needed. However, the program heap also presents a significant security risk due to its dynamic nature, making it vulnerable to attacks such as buffer overflows, use-after-free, and double-free vulnerabilities. If left unsecured, an attacker can exploit these weaknesses to inject malicious code, execute arbitrary commands, or even take control of the entire system.

FIG. 9 shows a system 900 for providing heap safety 903 consisting of hardened heap management to protect heap memory 902. In system 900, one or more heap managers 901 manage one or more heap memories 902 (see connecting line 951) and ensure one or more heap safety mechanisms 903 (see connecting line 952). Additionally, one or more heap managers 901 provide one or more heap allocation and free interfaces 904 (see connecting line 953) and is implemented as one or more PEEs 113 (see connecting line 954). Finally, one or more heap managers 901 capabilities are embedded in binary in one or more PEEs 113 (see connecting line 956) and embedded in source code in one or more program execution element 113 (see connecting line 955).

Some embodiments relate to a system for managing physical and virtual memory mappings within a given memory address space 201, where said system further comprises one or more heap managers 901 per memory address space 201 (see FIGS. 1 and 9). Each heap manager 901 can be a stand-alone PEE 113 invoked by other PEEs 113 or embedded within another PEE 113 via source code modification or binary rewriting.

This system provides heap allocation and free interface 904 which are a collection of functions 208 that enable various operations on heap memory 902 such as heap configuration, heap allocation, as well as freeing, and re-allocation of heap memory 902 blocks. Heap manager 901 implements base heap protection mechanisms to prevent various types of attacks on the heap by ensuring heap safety 903.

Base heap protection is a set of measures designed to safeguard against common heap-related vulnerabilities. This includes memory block tracking, reference counting, memory pooling, and heap layout randomization (HLR). Memory block tracking involves marking each dynamically allocated memory block with a unique identifier, allowing the system to track ownership of the memory blocks and verify whether a block has been freed or not. Reference counting ensures that each reference to a memory block is incremented when acquired and decremented when released, preventing dangling pointers. Memory pooling allocates memory in contiguous blocks, reducing fragmentation and hardening heap allocation against attacks. HLR randomizes the layout of the heap memory region, making it more difficult for attackers to predict the location of heap elements.

The system also includes thread-safe memory allocation, which ensures that allocation and deallocation of heap memory 902 are thread-safe, preventing multiple threads from accessing or modifying the same heap memory location simultaneously.

Furthermore, the system provides freelist management, block status flags, guard memory regions, redzones, metadata signatures, and immediate deallocation to enforce heap safety property 903 and to prevent various types of attacks such as Use-After-Free (UAF), Over-Flow (OF), Double-Free (DF), Metadata Tampering (MDT), and Lazy Deallocation Attack (LDA). Mitigation of these attacks is described below.

A UAF attack occurs when an attacker manipulates a program to access memory that has already been freed, resulting in arbitrary code execution. To mitigate this, the system may implement thread-safe memory allocation, which ensures that heap memory allocation and deallocation are thread-safe, preventing multiple threads from accessing or modifying the same heap memory location simultaneously.

An OF attack occurs when an attacker exploits a buffer overflow vulnerability in a program to overwrite adjacent memory blocks on the heap. To mitigate this, the system may implement guard memory regions and redzones. Guard memory regions use dedicated read-only memory regions to ensure that each heap allocation cannot be accessed under or over the heap object size. Redzones populate unused memory regions within a given heap memory block allocation with special magic values that are checked during allocation and deallocation to detect random heap spray attacks.

A DF attack occurs when an attacker frees the same memory block twice, resulting in arbitrary code execution. To mitigate this, the system may implement freelist management and block status flags. Freelist management manages a list of freed memory blocks to prevent allocating the same block again before it's actually freed. Block status flags use flags or bitfields to indicate whether a memory block has been freed, deallocated, or recycled, preventing multiple frees on the same block.

A MDT attack occurs when an attacker manipulates metadata associated with each memory block to compromise its integrity. To mitigate this, the system may implement metadata signatures, which generate and verify signatures for metadata associated with each memory block to ensure its integrity.

An LDA attack occurs when an attacker exploits a delay in deallocating memory blocks to execute arbitrary code. To mitigate this, the system may implement immediate deallocation, which implements a mechanism to immediately deallocate memory blocks when they are no longer needed, rather than waiting until the program's runtime or garbage collection cycle.

These measures collectively provide a robust defense against malicious activities aimed at compromising the integrity and security of the system's heap memory management.

The described system is designed to operate in various computer platforms ranging from embedded systems, desktop, servers to cloud platforms. Some embodiments may be implemented using programming languages such as Verilog, C++, Java, or other high-level languages that support memory allocation and deallocation. Though, embodiments may be implemented in any suitable way.

The system 900 can have various embodiments, providing flexibility in deployment and integration with existing software frameworks. For instance the heap manager 901 can be implemented as a set of HWPEEs 121, a set of SWPEEs 122 or a union of the set of HWPEEs 121 and SWPEEs 122. In other embodiments, the heap manager 901 can be implemented as a Keystone PEE (KPEE) 207, responsible for managing memory allocation and deallocation for multiple Domain PEEs (DPEEs) 205. Alternatively, it can be implemented as a Bastion PEE (BPEE) 204, providing an additional layer of security and isolation for the heap management functionality. In some cases, multiple DPEEs can share a single heap manager 901, while in others, each DPEE may have its own heap managers. Furthermore, for untrustworthy DPEEs, heap managers may not be required, as the data safety mechanism is sufficient to ensure that memory issues within these DPEEs do not compromise the overall system security. For example, in a host/container scenario, the host can be implemented as a BPEE, with its own heap manager, while containers, which are DPEEs, are free to use their own heap management or rely on the host's heap manager. Similarly, in a hypervisor/VMs embodiment, the hypervisor can be a BPEE, implementing a heap manager for itself and optionally for the VMs, which are DPEEs, while each VM may also have its own heap management mechanism. Additionally, the heap manager 901 can be invoked by other PEEs or embedded within a PEE via source code modification or binary rewriting, allowing for flexibility in deployment and integration with existing software frameworks. This enables various organizational structures, such as a single heap manager serving multiple DPEEs, each DPEE having its own heap manager, or a combination of both. The choice of implementation depends on the specific use case, security requirements, and performance considerations, highlighting the versatility of the heap management mechanism in supporting diverse embodiments, including host/container, hypervisor/VMs, and other scenarios where multiple PEEs coexist and interact with each other.

Overall, embodiments may provide an innovative solution to enhance the security of heap memory management on computer platforms, protecting against various types of attacks that exploit weaknesses in heap allocation and deallocation.

### Interface Confined Security Mechanism (ICSM)

The system and methods may include an “Interface Confined Security Mechanism (ICSM)” that regulates interactions between PEEs. In one embodiment, the ICSM regulates interactions between potentially malicious PEEs and the rest of the PEEs in the computer platform. ICSM achieves this by designating a subset of the union of the set of Keystone PEEs (KPEEs) 207 and Bastion PEEs (BPEEs) 204 (called “ICSM PEE”), to act as gatekeepers and enforce strict boundaries (called “bastion interfaces”) around computer platform resources. Bastion interfaces are essentially a subset of the union of the set of PEE functions 208 of KPEEs 207 and BPEEs 204 which prevent unauthorized access to computer platform resources by other potentially malicious PEEs. A key aspect of ICSM is the use of mathematical adversary modeling, which involves creating detailed models of potential attackers and their possible actions, allowing for the anticipation and mitigation of all possible non-deterministic adversarial inputs that could be directed at each bastion interface. By tying each bastion interface to a comprehensive set of potential adversarial scenarios, the ICSM can ensure that the system is resilient to even the most sophisticated and unpredictable attacks including zero-day attacks. ICSM PEEs operate at a higher level of privilege than the potentially malicious PEEs, ensuring that they can effectively control and monitor interactions. The overall security of the system is formally proven using a rigorous mathematical model that takes into account the complex interplay between the system's components and the potential adversaries.

ICSM can be embodied in various forms to protect different layers of a computer system, with each layer represented as a Keystone PEE (KPEE), Bastion PEE (BPEE), or Domain PEE (DPEE). For example, in a hypervisor-based embodiment, the hypervisor can be implemented as a KPEE 207, serving as a trusted environment for regulating interactions between virtual machines, which are represented as DPEEs 205, and the physical hardware. The ICSM can be integrated into the KPEE 207, allowing it to enforce strict boundaries around system resources and prevent malicious DPEEs 205 from compromising the system.

In another embodiment, the firmware of a device can be represented as a BPEE 204, providing an additional layer of security against malicious attacks targeting the device's low-level interfaces. The ICSM can be integrated into the BPEE 204, enabling it to regulate interactions between the firmware and other components of the system, such as DPEEs 205 representing kernel modules or applications.

Additionally, the ICSM can be implemented as a KPEE 207 within an operating system, which is represented as a DPEE 205, enabling it to enforce strict boundaries around system resources and prevent malicious applications, also represented as DPEEs 205, from compromising the system. In this embodiment, the KPEE 207 operates at a higher level of privilege than the DPEEs 205, ensuring that it can effectively control and monitor interactions.

In some embodiments, ICSM can be implemented as: (i) a collection of HWPEEs; (ii) a collection of SWPEEs; or (iii) a collection of both HWPEEs and SWPEEs. In one embodiment, a first HWPEE implementing a processor and a second HWPEE implementing a memory controller can together implement ICSM and execute an application as a SWPEE.

In other embodiments, the Interface Confined Security Mechanism (ICSM) can be applied to virtualization and containerization technologies to enhance their security. For instance, in a virtual machine-based embodiment, the guest operating system can be represented as a DPEE 205, and the host environment can be represented as a KPEE 207 or BPEE 204. The ICSM can be used to regulate interactions between the DPEE 205 and the KPEE 207 or BPEE 204, preventing malicious code from escaping the virtual machine and compromising the host.

Similarly, in a container-based embodiment, each container can be represented as a DPEE 205, and the host environment can be represented as a KPEE 207 or BPEE 204. The ICSM can be used to enforce strict boundaries around container interfaces, preventing malicious DPEEs 205 from accessing sensitive data or disrupting other DPEEs 205 within the same host. By applying the ICSM to these various technologies, it is possible to create a robust and comprehensive security framework that protects computer systems against a wide range of threats.

FIG. 10 shows a system 1000 for Interface Confined Security Mechanism (ICSM). In system 1000 a mathematical model 102 models one or more Bastion PEE 204 (see connecting line 1058) and one or more Keystone PEE 207 (see connecting line 1059). The mathematical model 102 uses one or more theorem provers 104 and one or more model checkers 120 (see connecting lines 1054 and 1090 respectively) to prove system security mechanism 114 (see connecting lines 1053 and 1091 respectively). One or more Bastion PEE 204 implement one or more bastion interfaces 1007 (see connecting line 1060). Similarly, one or more Keystone PEE 207 implement one or more bastion interfaces 1007 (see connecting line 1061). One or more Bastion PEE 204 and one or more Keystone PEE 207 implement one or more Interface confined security mechanism (ICSM) 1003 (see connecting lines 1056 and 1057 respectively). One or more ICSM 2003 build on one or more Bastion Interfaces 1007 (see connecting line 1062). One or more Bastion Interfaces 1007 confine one or more Programmable Hardware Components (PHC) 111 (see connecting line 1063). One or more PHC 111 accesses one or more Fixed Hardware Components (FHC) 112 (see connecting line 1066).

### Non-Interference ICSM

The Non-interference Interface Confined Security Mechanism (NI-ICSM) ensures the absence of interference between two or more Program Execution Elements (PEEs) in a system, based on their interfaces. This mechanism guarantees that the execution of one PEE does not affect the behavior or results of another PEE, thereby maintaining the integrity and security of the system.

NI-ICSM relies on the Trusted Path Security Mechanism (TPSM), which establishes secure communication pathways between PEEs and ensures the enforcement of permitted patterns of computer platform operations as described previously. In addition to TPSM, NI-ICSM involves proving invariants on PEE functions that ensure the absence of side-effects on shared resources, including:
Shared memory: NI-ICSM ensures that one PEE's access to shared memory does not affect the behavior or results of another PEE.
Programmable hardware states: NI-ICSM guarantees that changes to programmable hardware states, such as registers or configuration settings, do not interfere with the execution of other PEEs.
Processor state: NI-ICSM ensures that modifications to processor state, including registers, do not affect the behavior or results of other PEEs.

In some embodiments the aforementioned invariants can be specified in mathematical logic such as concurrent separation logic, hoare logic or relational logic and can be proven using theorem provers 104 and model checkers 120.

Furthermore, NI-ICSM also addresses the issue of caches and side-channel elimination. In a system with multiple PEEs, caches can be a source of interference between PEEs, as changes to cache contents by one PEE can affect the execution of another PEE. To mitigate this, NI-ICSM ensures that:
Cache coherence: NI-ICSM maintains cache coherence across PEEs, ensuring that changes to cache contents are properly propagated and do not interfere with other PEEs.
Cache isolation: NI-ICSM provides cache isolation between PEEs, preventing one PEE from accessing or modifying the cache contents of another PEE.

In some embodiments these aforementioned cache isolation and cache coherence mechanisms can be implemented as n-way set associative caches and using a combination of HWPEEs and SWPEEs.

The NI-ICSM can be embodied in various configurations involving Hardware PEEs (HWPEEs) and Software PEEs (SWPEEs).

In one embodiment, NI-ICSM is implemented using HWPEEs, which provide a hardware-enforced separation between PEEs. The TPSM is used to establish secure communication pathways between HWPEEs, and invariants are defined to ensure the absence of side-effects on shared memory, programmable hardware states, and processor state.

In another embodiment NI-ICSM is implemented using SWPEEs, which provide a software-enforced separation between PEEs. The TPSM is used to establish secure communication pathways between SWPEEs, and invariants are defined to ensure the absence of side-effects on shared memory, programmable hardware states, and processor state.

In yet another embodiment, NI-ICSM is implemented using a combination of HWPEEs and SWPEEs. The TPSM is used to establish secure communication pathways between PEEs, and invariants are defined to ensure the absence of side-effects on shared memory, programmable hardware states, and processor state.

In other embodiments, NI-ICSM is implemented using Keystone PEEs (KPEEs), which provide a high level of security and trustworthiness. The TPSM is used to establish secure communication pathways between KPEEs, and invariants are defined to ensure the absence of side-effects on shared memory, programmable hardware states, and processor state.

In one embodiment NI-ICSM is implemented using Bastion PEEs (BPEEs), which provide a high level of security and isolation. The TPSM is used to establish secure communication pathways between BPEEs, and invariants are defined to ensure the absence of side-effects on shared memory, programmable hardware states, and processor state.

In each of the aforementioned embodiments, NI-ICSM ensures that the execution of one PEE does not interfere with the behavior or results of another PEE allowing for securely composing multiple PEEs in the computer platform each with its mathematically verified security guarantees.

### Mathematically Verified System-on-Chip (SoC)

The system of the present invention consists of a provably Secure high-assurance hardware and software co-design System-on-Chip (SoC). The disclosed SoC has support for multiple hardware privileged modes, Physical Memory Protection (PMP), I/O Memory Management Unit (IOMMU), multi-core processing, and instruction/data cache partitioning. The SoC provides mathematically backed guarantees for memory integrity, control-flow integrity, privilege separation and is hardened against cache-based attacks.

FIG. 11 shows a system 1100 for a mathematically verified SoC computer platform according to some embodiments. In system 1100, the SoC contains one or more HWPEEs 121, one or more SWPEEs 122, one or more volatile storage 1102, one or more peripherals 1102, one or more IOMMU 1104, one or more Non-volatile storage 1105, one or more MMU 1106, one or more Interrupt controller 1107, one or more caches 1111, and one or more processors 1108 (see connecting lines 1150, 1157, 1151, 1152, 1153, 1154, 1155, 1156, 1159 and 1158 respectively). Peripherals 1102, IOMMU 1104, MMU 1106, Interrupt controller 1107 and processor 1108 are implemented-by one or more HWPEEs 121 (see connecting lines 1160, 1162, 1163, 1165 and 1164 respectively). Non-volatile storage 1105 stores one or more SWPEEs 122 (see connecting line 1166) and one or more HWPEEs 121 (see connecting line 1161). Processor 1108 is connected to one or more processors 1108 (see connecting line 1170) and contains caches 1111 (see connecting line 1171). Processor 1108 supports one or more privileged modes 1110 (see connecting line 1168) and executes one or more SWPEEs 122 (see connecting line 1167). Mathematical model 102 models one or more SoCs 1101 (see connecting line 1172).

In some embodiments of system 1100 the SoC 1101 consists of a JTAG debug logic for debugging purposes. In this embodiment, the SoC processor is embedded in a Symmetric Multiprocessing Processor (SMP) organization based on a secure mesh organization. The processor is implemented using a RISC-V instruction set architecture. The SoC then integrates a I/O Memory Management Unit (IOMMU) that provides efficient DMA protection and isolation. The SoC processor has its own Memory Management Unit (MMU) that allows for secure partitioning of system memory for running programs in the form of secure enclaves. Further, the SoC includes a secure interrupt architecture where dedicated interrupts are allocated to desired enclaves for secure event processing. All the aforementioned SoC components are integrated with a common system bus with relevant master/slave functionality.

In another embodiment of system 1100, the SoC 1101 allows running a stack of formally verified hardware and software components as a set of PEEs along with unverified components while preserving the formally verified guarantees of the entire system.

In one embodiment, the system 1100 comprises a method to mathematically model 102 the SoC 1101 components and functionality in mathematical logic and define SSM, TPSM and ICSM which are then proven using an ensemble of theorem provers and model checkers. In this embodiment, the mathematical modeling method comprises: (i) IOMMU Modeling; (ii) MMU modeling; (iii) processor modeling; (iv) Cache modeling; (v) Interrupt Modeling; and (vi) peripheral modeling using the Temporal Logic of Actions (TLA+). In this embodiment TPSM and ICSM are proven, even in the presence of an active adversary using a computer-assisted theorem proving and model checking system.

### SoC Secure Processor Embodiments

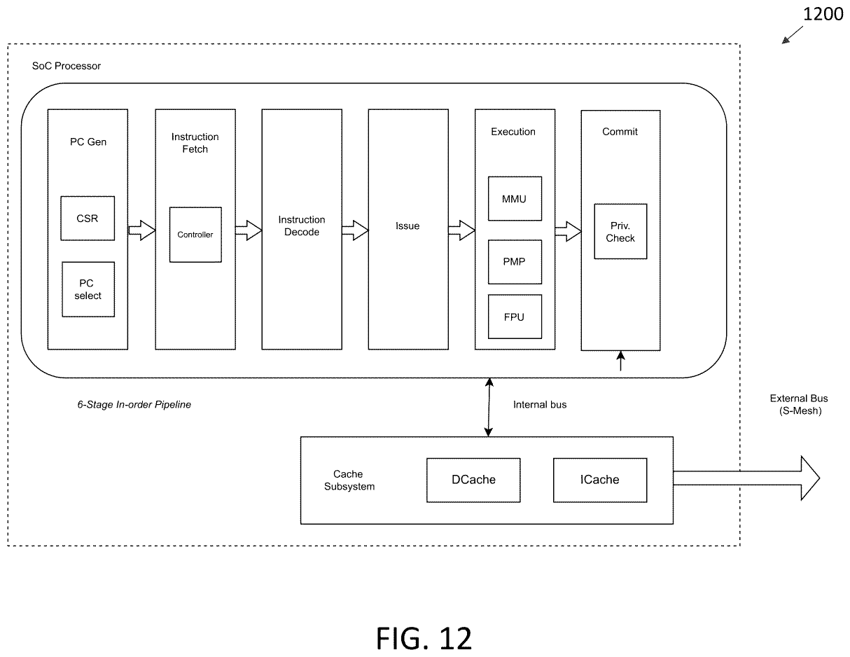

FIG. 12 illustrates an embodiment of the secure processor in system 1100 described herein. In this embodiment, the SoC processor has a 6-stage in-order pipeline. This pipeline consists of the following stages: Program Counter (PC) Generation (PC Gen), Instruction Fetch (IF), Instruction Decode (ID), Issue, Execution, and Commit. In the PC Gen stage the current instruction's address is updated and the program counter is updated accordingly allowing the next instruction to be fetched and executed. In the IF stage, instructions are fetched from memory and decoded in the ID stage to determine the operation to be performed. In the issue stage, the decoded instructions are retrieved from the instruction cache and sent to the execution pipeline, where they are checked for dependencies with other instructions that have not yet been retired, and only those that are ready to execute are issued to the execution units. In the execution stage, the fetched instructions are executed by the corresponding execution units (such as arithmetic logic units, load/store units, etc.) using the operands and resources provided, producing results that will be used by subsequent instructions. Finally, in the commit stage, the completed instruction's results are written back to the register file or memory, and any necessary dependencies with other instructions are resolved, allowing the instruction to be retired and freeing up resources for subsequent instructions. This 6-stage in-order pipeline provides a good balance between complexity and performance, making it suitable for various processor architecture implementations.

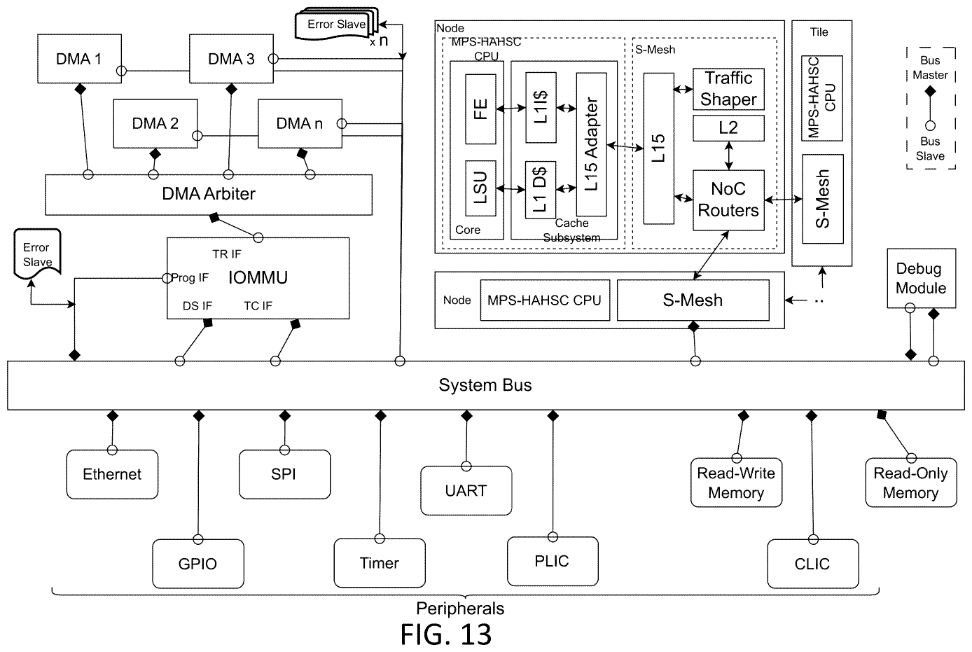

FIG. 13 illustrates another embodiment of system 1100 which shows a secure multi-processor implementation using a secure mesh described herein. A Network on Chip (NoC) mechanism is employed to support multi-processing with multiple processors on the SoC. The NoC secure mesh (S-mesh) is a scalable and flexible interconnect fabric designed for multi-core systems. It provides a high-bandwidth, low-latency communication infrastructure that enables secure and efficient data exchange between processing elements. At its core, the S-mesh is a 2D mesh network, where each node represents a processing unit or a group of processing units. The nodes are connected to their neighbors through a set of high-speed links. The NoC uses a packet-switched approach to route data packets between nodes, ensuring that each packet takes the most efficient path to its destination. Each processor is assigned to a separate node on the mesh, allowing for independent execution of tasks without interference from other processors. In this embodiment, the S-mesh provides access control to enable each processor to securely exchange data with its neighbors while preventing unauthorized access. The mesh is then finally connected to the system bus as a bus-master device.

In some embodiments of system 1100, the secure multi-processor implementation using S-mech enables easy integration of new features or technologies as they become available. For example, additional security features or advanced interconnect fabrics can be seamlessly integrated into the existing architecture without requiring significant redesign or reimplementation.

### SoC Privileged Modes Embodiments

In some embodiments of system 1100, the SoC processor privileged modes comprises multiple privilege levels such as Monitor Mode (M-mode), Hypervisor Mode (H-mode), Supervisor Mode (S-mode), and User Mode (U-mode). These modes are designed to provide varying degrees of access to system resources, each with its own set of privileges and responsibilities.

In one embodiment of system 1100, the SoC privileged mode comprises a Monitor Mode which is the highest-level privileged mode. It has the most extensive access to system resources and is used as a boot-up and management layer. In this embodiment the monitor mode may run system firmware and house debugging services. In Monitor Mode, all instructions are allowed to execute, regardless of their privilege level, and there are no restrictions on memory access. The monitor program can inspect and modify any register values, control flow, and memory state, including that of the other modes.

In another embodiment of system 1100, the SoC privileged mode comprises a Hypervisor Mode that serves as an interface between the monitor and supervisor modes (see below). It allows for virtualization tasks, where one or more guest hypervisors can run within the Hypervisor Mode. These hypervisors themselves manage other operating systems in their respective supervisor modes. The main program running in Hypervisor Mode has full control over all system resources and is responsible for managing these guest hypervisors. It can access and modify the state of any virtual machine, supervise memory allocation, and monitor or intercept instructions from those VMs to ensure system integrity.

In yet another embodiment of system 1100, the SoC privileged mode comprises a Supervisor Mode that sits below the hypervisor and above user mode in terms of privilege hierarchy. It's where most operating systems run, handling user requests for services like process creation, memory management, I/O operations, etc. The supervisor program has control over its own memory address space but does not have direct access to all system resources or other modes'memory states. This is because Supervisor Mode still lacks the unrestricted privileges of Monitor and Hypervisor Modes, ensuring a separation between user and kernel code execution.

In some embodiments of system 1100, the SoC privileged mode comprises a User Mode with the least privileged access to system resources. It's where applications or users execute their programs, confined within virtual memory spaces managed by the operating system running in Supervisor Mode. In User Mode, most instructions are not allowed if they try to access directly restricted areas of memory or resources. The program executing in User Mode cannot control process scheduling, memory mapping, device I/O operations, and other sensitive functions that require supervisor privileges. User Mode is considered safe but resource-limited compared to higher-level modes.

In some embodiments of system 1100, the SoC privileged mode comprises a set of Monitor modes, Hypervisor modes, Supervisor modes and User modes. In this embodiment the elements of the set of Monitor modes, hypervisor modes, supervisor modes and user modes can have distinct logical privilege levels within their respective sets. This allows for fine-grained privilege separation within a given mode. For example, there can be three PEEs all within monitor mode but having different logical privilege levels (higher to lower).

In other embodiments of system 1100, the SoC privileged mode comprises transitions between modes. The transitions from one mode to another are governed by specific processor instructions, such as those that invoke the M-mode (Monitor) or S-mode (Supervisor), depending on the current mode and the destination. The Down-call instructions move execution from a higher-privilege level into a lower-privilege level and the Up-call instructions move execution from a lower-privilege level to a higher-privilege level. In one embodiment of the present invention, a program running in User Mode might transition into Supervisor Mode through system calls for accessing resources not available at its privilege level, while a Monitor program would be responsible for managing transitions between the Hypervisor and Supervisor Modes as part of its virtualization duties.

In one embodiment of system 1100, the SoC privileged mode allows caller PEEs invoking other callee PEEs. This can involve the caller and callee being in the same address space, or the caller and callee being in different address spaces and different privilege levels (monitor, hypervisor, supervisor and user). The call between a caller and a callee PEE is governed by one or more calling access control matrix which either allow or deny the call.

### SoC Memory Management Unit (MMU) Embodiments

In some embodiments of system 1100, the Memory Management Unit (MMU) provides secure and isolated memory accesses between program execution elements (PEEs) within the SoC computer platform. The MMU provides a layer of protection by controlling which PEEs can access specific regions of memory, thereby preventing malicious or unauthorized access to sensitive data and ensuring that hardware program execution elements (HWPEEs) and software program execution elements (SWPEEs) operate within their designated memory boundaries.

In one embodiment of system 1100, the MMU comprises a Physical Memory Protection (PMP) feature in the SoC processor. PMP is a security mechanism embedded in the processor that allows for fine-grained control over memory access, providing a robust and efficient way to protect against unauthorized memory accesses. It provides a set of registers that can be programmed by SWPEEs to define regions of memory that are protected from access. The PMP feature operates at the physical memory address level, meaning it controls access to specific ranges of physical memory addresses. In this embodiment, the PMP software programmable registers consists of: (a) PMP base address, which is the base address of the region of physical memory to be protected; (b) PMP size, which is the size of the region of physical memory to be protected; (c) PMP protection mode which is the protection mode for the physical memory region referenced by the PMP base address and PMP size.

In another embodiment of system 1100 the SoC processor is implemented using the RISC-V architecture with support for 32 PMP regions for seL4 high assurance kernel, Linux kernel, and device resource constraining. This embodiment enables adding PMP region checks on instruction, data, and page-table accesses.

In yet another embodiment of system 1100, the MMU PMP protection mode register defines an access control matrix with hardware privilege levels, identification of the PEE and the types of protection which can be: (i) read-only (ro); (ii) read-write (rw); (iii) no-access (na), and (iv) execute-only (xo). This allows a given PEE memory region to be protected from other PEEs with appropriate privilege separation and memory access control.

In one embodiment of system 1100, the MMU is employed to configure the seL4 high assurance kernel PEE such that the PMP corresponding to the memory regions occupied by the seL4 high assurance kernel has its PMP protection mode to be (ro) from other PEEs in the system including the PEE running a Linux operating system.

In other embodiments of system 1100, the MMU consists of an access control matrix that enables fine-grained control over memory regions at given address spaces and privilege levels. This feature is particularly useful for ensuring the secure execution of programs within PEEs on the SoC computer platform. In this embodiment, the MUU includes translation look-aside buffers (TLBs), which allow for efficient caching of memory region addresses.

### SoC I/O Memory Management Unit (IOMMU) Embodiments

In some embodiments of system 1100 the IOMMU provides secure and isolated memory access between devices within the SoC computer platform. The IOMMU provides a layer of protection by controlling which devices can access specific regions of memory, thereby preventing malicious or unauthorized access to sensitive data.

In another embodiment of system 1100 the IOMMU may consist of four functional system interfaces: (i) Programming Interface (Prog IF): This interface is used by the SoC processors to program and monitor the memory-mapped registers of the IOMMU. These registers are located within a naturally aligned 4-KiB region of a memory address space. The registers control various aspects of the IOMMU translation logic as well as interrupt functionality. This interface is connected as a slave to the SoC primary bus; (ii) Data Structures Interface (DS IF): Master interface used by IOMMU modules that generate implicit memory accesses during the translation process. Arbitration and routing logic is used to control the access to this interface. The IOMMU modules are as follows: (a) page-table walker, (b) context directory walker, (c) command queue handler, (d) fault queue handler; and (e) interrupt generation system. The corresponding data structures include (a) first and second stage page-tables including interrupt page tables; (b) device directory and process directory tables; (c) command queue; (d) fault queue; and (e) IOMMU generated interrupts; (iii) Translation Request Interface (TR IF): Slave interface to which bus master devices connect to issue DMA requests. A request is initiated by setting a valid bit and the input IO memory address is read from the address bus. Translation requests are processed individually, i.e., subsequent requests are stalled until the current one is finished; and (iv) Translation Completion Interface (TC IF): Master interface used to forward permitted requests to the system interconnect. On a successful translation, the translated address is placed in the address bus of this interface, and the valid bit is set to continue the transaction. On an error, an error is generated on the bus and the valid bit is clear.

In other embodiments of system 1100, the IOMMU is configured to generate interrupts on errors and translation completion as desired. For this purpose, a set of external signals are sent to a Platform-Level Interrupt Controller (PLIC).

In one embodiment of system 1100, the IOMMU HWPEE is implemented in SystemVerilog Register Transfer Language (RTL) low-level programming language and is compliant with the RISC-V IOMMU Specification. The IOMMU performs permission checks, address translation, and interrupt remapping on requests originated by bus master devices and provides DMA isolation and protection. In this embodiment the IOMMU RTL includes support for 16 devices (which encompasses all system peripherals). The Programming Interface is a slave interface used by RISC-V processors to program and monitor memory-mapped registers of the IOMMU. In contrast, the Data Structures Interface is a master interface used by modules that generate implicit memory accesses during translation, with arbitration and routing logic controlling access to this interface. The Translation Request Interface is utilized by DMA devices connected through a DMA arbiter, which enables multiple DMAs to access the IOMMU's translation request port. Finally, the Translation Complete Interface indicates the completion of the translation process on the AXI bus.

### SoC Side-Channel Resistant Instruction and Data Caches Embodiments

In some embodiments of system 1100 the side-channel resistant instruction and data caches may comprise a memory cache mechanism to enhance the security and performance of the SoC while being resistant to side-channel attacks. In this embodiment, the L1 instruction and data caches are configured as write-through, immediately writing data to both the cache and main memory. Additionally, a pseudo-random cache eviction policy is implemented to make it difficult to predict cache states. The cache system also features a direct-mapped cache configuration, which provides a high level of resilience against cache-based side-channel attacks. To further enhance this security, the data cache is composed of two physical memory cells called banks, with every cache line split into two parts. This design ensures that sensitive information is not stored in a single location for an extended period, making it more difficult to compromise.

In other embodiments of system 1100, the side-channel resistant instruction and data caches may be constructed such that the L1 instruction and data caches are connected through the mesh L1.5 cache adapter into the S-mesh shared L2 cache. The NoC routers are set up to use the L2 cache for packet-switching purposes. The S-mesh NoC architecture uses a 4 way set associative shared caching for its L2 cache which is by design resilient to side-channel attacks. The instruction cache is configured to be a direct-mapped write-through cache. When an instruction cache receives data requests from its frontend module, it checks if the requested address is present in the cache. If it finds a match, known as a cache hit, the controller can proceed to accept any additional data requests. However, if the address is not found in the cache, the controller triggers a translation request to the Memory Management Unit (MMU), assuming caching is enabled. To manage this process, the instruction cache employs a corresponding state machine.

When the system resets or receives a flush command, such as via a processor instruction, the cache controller empties its contents. This operation involves resetting all valid bits without performing any write-back, since the instruction cache does not modify data. The state machine's behavior is governed by four primary states: IDLE, READ, MISS, and KILL. From the IDLE state, the controller transitions to the READ state upon receiving a data request from the frontend unit. In this state, it checks whether the requested address is already present in the cache. If there's a hit, the controller can accept any subsequent data requests. However, if there's a miss, the controller enters the MISS state and waits for the main memory to provide the required data. Once the data from the main memory is received, the controller transitions back to the IDLE state. Notably, since kill operations (e.g., caused by exceptions) can occur asynchronously while memory operations are in progress, the controller must wait for the completion of address translation or bus transactions before becoming idle again.

As with the instruction cache, the data cache is configured to be direct-mapped and write-through. When a write request is made to an address that is already present in the cache, it results in a cache hit. In this case, the cache controller simply updates the cached value with the new written data and writes the updated data directly to main memory at the same time. This ensures that both the cache and main memory have the most up-to-date copy of the data. The write operation completes as soon as both the cache and main memory have been updated. When a write request is made to an address that is not present in the cache, it results in a cache miss. In this case, the cache controller fetches the old value from main memory, updates the cached line with the new written data, and writes the updated data directly to main memory. The cache controller then stores the updated cache line in the cache for future read requests. This process ensures that both the cache and main memory have a coherent view of the data, even when a write operation is performed on an address that was not previously cached.

The L2 is the point of coherence for all cacheable memory requests in multi-processor operations. All cacheable memory operations (including atomic operations such as compare-and-swap) are ordered, and the L2 strictly follows this order when servicing requests. The L2 also keeps the instruction and data caches coherent. To ensure deadlock-free operation, the L1.5 cache, L2 cache, and memory controller give different priorities to different NoC channels; NoC3 has the highest priority, next is NoC2, and NoC1 has the lowest priority. Thus, NoC3 will never be blocked. Classes of coherence operations are mapped to NoCs based on state machines. NoC1 messages are initiated by requests from the private cache (L1.5) to the shared cache (L2). NoC2 messages are initiated by the shared cache (L2) to the private cache (L1.5) or memory controller, and NoC3 messages are responses from the private cache (L1.5) or memory controller to the shared cache (L2).

### SoC Secure Interrupt Controller Embodiments

In some embodiments of the system 1100 the secure interrupt controller comprises a Platform Level Interrupt Controller (PLIC) and a Core Level Interrupt Controller (CLIC). The PLIC manages interrupts at the platform level (global interrupts), handling interrupts from various sources across the entire system including peripherals, timers, and other components and directs them into desired processors. The CLIC focuses on managing interrupts at the core level (local interrupts), primarily dealing with interrupts generated within the processor itself such as cache misses or MMU faults and system calls. The CLIC is also used when certain peripherals are directly wired into a processor core for efficient interrupt processing (e.g., a camera or sensor peripheral).

In some embodiments of system 1100, the secure interrupt controller may comprise multiple PLIC's and multiple CLIC's operating in a hierarchical fashion.

In other embodiments of system 1100, PLIC and the CLIC both have interrupt privilege level support which means it can prioritize and route interrupts that occur based on the processor privilege level (monitor, hypervisor, supervisor or user). Additionally, the PLIC and CLIC also have enclave identification based routing where a specific interrupt can be directed at a specific enclave. Finally, the PLIC and CLIC have device interrupt access control matrix which allows only specific peripherals to trigger interrupts on specific cores. This allows for a capability that can deliver specific device interrupts for a specific enclave, operating on a specific core, at a specific privilege level. Further, interrupts of higher privilege contexts can pre-empt interrupts of lower-privilege contexts. Furthermore, a PLIC can be chained into a CLIC and therefore forward an interrupt to a CLIC which may then perform additional privilege and access control checks.

In other embodiments of system 1100, the secure interrupt controller HWPEE may handle secure interrupt delivery via an interrupt gateway. In this embodiment there can be multiple interrupt gateways within the PLIC's and CLIC's. The interrupt gateways are responsible for converting global or local interrupt signals into a common interrupt request format, and for controlling the flow of interrupt requests to the PLIC or CLIC. At most one interrupt request per interrupt source may be pending in the PLIC or CLIC at any time, indicated by setting the source's IP bit. The gateway only forwards a new interrupt request to the PLIC or CLIC core after receiving notification that the interrupt handler servicing the previous interrupt request from the same source has completed.

In an embodiment of system 1100 the secure interrupt controller HWPEEs comprise interrupt gateways that can handle level-triggered, edge-triggered or message signaled interrupts. In this embodiment, interrupts are sent from their source to an interrupt gateway that processes the interrupt signal from each source. Interrupt gateway then sends a single interrupt request to the PLIC or CLIC, which latches these in the core interrupt pending bits (IP).

In another embodiment of system 1100, the secure interrupt controller HWPEEs comprises PLIC that forwards an interrupt notification to one or more processors if the processors have any pending interrupts enabled, and the priority of the pending interrupts exceeds a per-core threshold. In this embodiment, when the processor takes the interrupt, it sends an interrupt claim request to retrieve the identifier of the highest priority interrupt source pending for that processor from the PLIC or CLIC. PLIC or CLIC then clears the corresponding interrupt source pending bit. After the processor core has serviced the interrupt, it sends the associated interrupt gateway an interrupt completion message. The interrupt gateway can now forward another interrupt request for the same source to the PLIC or CLIC.

### Mathematical Modeling and Composition of Security Mechanisms

Some embodiments of the system include a mathematical model of the computer platform where the PEE interfaces are modeled and it is shown that there is composition of trusted path security mechanism (TPSM) (code safety, data safety, stack safety, heap safety, and privilege separation) and interface confined security mechanism (ICSM) when multiple PEEs are used in a system. Further, each PEE can be written in a different programming language and still achieve the composition of the aforementioned security mechanisms. In one embodiment of the system, this allows composing PEEs written in high-level languages such as Rust, Python, Java and C # which incorporate a subset of TPSM and ICSM in their programming language by design along with PEEs written in low-level languages such as Verilog, C, C++ and Assembly which do not incorporate TPSM and ICSM by design.

The mathematical model may be modeled with existing assume-guarantee interface confined automated modeling mechanisms as discussed in U.S. Pat. No. 12,367,328 allowing for computer assisted modeling and proving of system security mechanisms. As discussed in U.S. Pat. No. 12,367,328 the assume-guarantee interface confined modeling may employ theorem provers and/or model checkers to prove system security mechanisms. In some embodiments, proving ICSM and TPSM using theorem provers and/or model checkers may generate a counter example in the event the ICSM and TPSM does not hold for a given version of the mathematical model. In such cases, the counter example provides details in terms of what model specifications need changes so that the ICSM and TPSM can hold. The mathematical model specification is then revised using the output of the counter example and the system security mechanisms are proven again using theorem provers and/or model checkers. This allows for an iterative mathematical model specification workflow that allows to ultimately prove that the ICSM and TPSM hold in the mathematical model.

The mathematical model may also model side-channel resistant instruction and data caches via the aforementioned assume-guarantee interface confined automated modeling mechanism as discussed in U.S. Pat. No. 12,367,328. The memory load, store and execute model interfaces are executed via mathematical non-deterministic finite automata (NFA). The memory load and store operations are mapped to the LSU and the memory execute operation to the FE (fetch and execute) unit of the SoC processor. Cache hits and misses are modeled using mathematical NFA and by encoding the instruction and data cache state machines into the memory load, store and execute model interfaces.

Some embodiments of the system may include multi-processor cache coherency modeling where the mesh network-on-chip (NoC) state machine is encoded via mathematical process calculi framework which essentially simulates multiple core cache access and operational semantics. The S-mesh NoC routers are modeled using mathematical sequences which form the underpinning for the NoC packet message passing queue. A write process writes non-deterministic NoC packet data to the NoC queue while the read process reads the data and acts on it. This models NoC1, NoC2 and NoC3 cache update messages sent out between multiple-processors and to the memory controller.

Other embodiments of the system may use “either” primitive of the temporal logic of actions (TLA+) mathematical modeling framework and the PlusCal specification language to model memory load, store and execute in a non-deterministic fashion. The instruction and data cache state machines are encoded as described previously via the “procedure” primitive of the PlusCal language to model cache hits and misses with our memory operations. Instruction cache is similarly modeled via the memory execute operation. For multi-processor cache coherency modeling the mesh network-on-chip (NoC) state machine is encoded via the “process” primitive of the PlusCal language which essentially simulates multiple processors using the temporal logic process calculi framework. In this embodiment, the TLA+ built in message passing mechanisms are used to model the NoC messages using TLA Sequences. Each NoC is modeled via a TLA+ read and write process. These are then translated into appropriate data cache operations on the individual processors.

The high-level mathematical model in accordance with some embodiments of a system of PEEs 113, their functions 208 and their memory state are described and syntax and semantics governing their concurrent execution on a computer platform with multiple processors are introduced.

### Model Syntax

The syntactic constructions for defining a PEE include a system of PEEs, U, that maps a unique identifier to a PEE, which is a tuple consisting of: (1) a language, lang, with which the PEE is implemented; (2) an exclusive memory address space 201 (including the heap), M, owned by the PEE; (3) a set of function 208 declarations, fd; (4) an initialization function, init, that sets up the initial state of the PEE

Instead of modeling the detailed semantics of the source language (e.g., C) or the target language (e.g., x86 Assembly), it is assumed that each PEE takes in, as a parameter, the intermediate language (lang) in which it gets compiled into (e.g., intermediate representation of compilers such as GCC or a more universal intermediate representation such as LLVM).

Generalized commands, gcmd, consist of commands in agreement with the syntax of the language in which the PEE is implemented (lang). For example, in a PEE uid with uid.lang=LLVM, the functions declared in uid.fd are implemented using commands in Low Level Virtual Machine (LLVM) intermediate side-effect free machine representation.

### Memory Model

The layout of the memory for U, with m distinct PEEs includes the heap which is compartmentalized into m separate memory locations [symbol] uid [symbol] _i.M for i≤m. Each heap compartment [symbol] uid [symbol] _i.M is a set of addresses defined as [symbol] uid [symbol] _i.M∈P(Addr), such that for all i≠j≤m, [symbol] uid [symbol] _i.M∩ [symbol] uid [symbol] _j.M=0.

The syntax for defining memory is summarized below. The memory state model also includes the regions preserved for the stack frames (i.e., freelists):
Exclusive heap M∈P(Addr)
Freelist stream F::=F, F
Freelist F∈P\hat{ }ω (addr)
Memory state σ∈Addr [symbol] val

A freelist can be infinitely large and is used by the thread to allocate its local stack locations as needed. It is assumed that a stream of such infinite freelists F is available upon request. The stream of freelists F, is a coinductive definition and consists of freelists of the type F∈P\hat{ }ω (Addr) (i.e., infinite sets of memory addresses). It is assumed that all freelists F in the stream F are mutually disjoint from each other and from the heap locations. Memory state σ is defined as a mapping from the heap and the allocated parts of the stack to values.

### Runtime Constructs

The runtime constructs consist of multiple state-machine states. A state-machine state can correspond to PHC state (when a set of HWPEEs implement a processor or peripheral using a PHC) or a processor state (when a set of SWPEEs execute on a processor implemented by a set of HWPEEs). The following syntax is used:
thread pool T::=·|tid [symbol] [symbol] uid, mainf, lang, F, ρ, a [symbol] , T
single state-machine state k::= [symbol] cid, T [symbol]
multi state-machine state K::= [symbol] F; σ; k; cid

[symbol]

Each state-machine k, is a tuple of a unique state-machine identifier cid and a list of threads T for executing external function calls. A single thread, uniquely identified with tid, consists of: (1) the main function (mainf) that initializes the thread; (2) language of the thread lang.mainf is the language of uid; (3) the freelist F allocated to the thread; (4) the current internal core state ρ of the thread storing key control flow state; and (5) the instance, a, that satisfied the precondition mainf when the thread was initialized. Each multi state-machine state K consists of a stream of freelists F, a mapping from addresses to values, σ, a list of state-machines and the active (running) state-machine cid. The active state-machine cid in a multi state-machine state can switch non-deterministically.

### Interface Specification

For each PEE uid∈dom(U) and every function f∈uid.(fd), an interface {P(x)}uid.f{Q(x)} is fixed and collected in the set Δ_u. P(x) and Q(x) are pre- and post-conditions of the function f, respectively. These are also referred to as uid.f.pre(x) and uid.f.post(x). These pre- and post-conditions are essentially invariants for security mechanisms that hold at the starting and at the end of function f respectively (e.g., data safety, forward edge CFI, backward edge CFI etc.). The memory footprint of the interface for the PEE uid is specified by (uid.M).

In line with function specifications in mathematical separation logic, the precondition uid.f.pre(x) is defined to be parametric in x of type A and has a type A→Prop. A universally quantified version of it, ∀x:A.uid.f.pre(x), is a first-order predicate defined over a global memory state σ (a pair of heap and stack where the heap includes other resources, e.g., processor control registers). σ [symbol] uid.f. pre(a) specifies that the memory a satisfies uid.f.pre(x) when x is instantiated with the instance a. Assume that the predicate is only defined over the heap owned by uid. (i.e., σ|_(uid.M)). The same holds for uid.f.post(x).

Moreover, for the sake of simplicity, assume that A has a simple base type (e.g., a list of integers or a string). For example, the specifications of the function foo owned by a PEE uid can be enforced:
foo:=l_1=*l_0
where:
uid.M={l_0,l_1};
uid.pre.foo(x):=l_0 [symbol] x; and
uid.post.foo(x):=l_1 [symbol] x

### Local Syntax and Semantics

The language parameter, lang, of a PEE dictates the syntax of its internal functions and the semantics by which those functions evaluate. The syntax defines a grammar for commands, gcmd, and describes the internal states, ρ, that manage the local control flow inside a function and the internal call stack (e.g., control continuations).

A pair of a memory state, σ, and an internal state, ρ, describes the PEE program state. The semantics . . . →defines a local transition migrating a program state of the form σ, ρ with respect to a given freelist F:F∥⋅⋅σ, ρ→_ι\hat{ }δσ\hat{ }ι, ρ\hat{ }ι. The label δ indicates the footprint (read and write set) of this step; when δ is empty, it is omitted. The label ι specifies the type of internal step: abt stands for a step that results in an abort, ret stands for function return, and τ stands for effectless internal steps.

The internal and external calls are distinguished as follows: a general command defining internal functions ((fd)^{→}) can make (a) an internal call to the functions defined in fd of the same PEE; or (b) an external call to a function of another PEE. A PEE makes internal steps with internal calls. When an external call is made, it cannot take internal steps until the external call returns.

The final element of lang, the set func includes four functions for initializing the internal state (initCore) and governing transitions related to external calls and returns (extCall, extRet, and halt). The function extCall is called when an external call is made, extRet is called when an external call returns, and halt is called when the current thread is ready to return to its caller. The semantics of a language specifies the behavior of these four functions as follows:
F [symbol] initSM(fv^{→})=ρ initializes a state-machine given function f on arguments v^{→} consulting the declarations in the PEE that owns them.
F [symbol] extCall(ρ)= [symbol] fvd^{→}, ρ\hat{ }′ [symbol] returns a pair [symbol] fv^{→}, ρ\hat{ }′ [symbol] when ρ calls an external function f with arguments v^{→} and puts ρ to a waiting state ρ\hat{ }′.
F [symbol] extRet(ρ, v)=ρ\hat{ }′ updates ρ, waiting for the return of an external call, to a new state ρ\hat{ }′, with a return value v.
F [symbol] halt(σ, ρ)= [symbol] v, p\hat{ }′ [symbol] returns p\hat{ }′ and a return value v iff F [symbol] , ρ→_ret σ, ρ\hat{ }40 with the global memory state σ.

### Operational Semantics

The concurrent multi state-machine semantic rules are of the form [symbol] F; σ; k^{→}; cid [symbol] ⇒_ι\hat{ }δ [symbol] F\hat{ }′, σ\hat{ }′, k^{→}\hat{ }′, [symbol] uid [symbol] \hat{ }′ [symbol] . The δ is inherited from the underlying local internal steps and refers to read/write footprints of the step. The label ι is still used to specify the type of multicore step. For instance, load stands for loading a configuration, call stands for an external call, and ret stands for return.

The execution of a PEE executing on a system with n distinct state-machines and an initial global state memory σ_0, starts with a configuration, C, of the form ( [symbol] uid [symbol] _1.init∥ . . . ∥ [symbol] uid [symbol] _n.init)_(σ_0) , where σ_0 assigns initial values to the heap locations. A configuration is well-defined iff for all i≤n, [symbol] uid [symbol] _i∈dom(U) and for all i≠j≤n, [symbol] uid [symbol] _i≠ [symbol] uid [symbol] _j. A well-defined configuration describes a system of PEEs ready to initialize n distinct PEEs on the state-machines by calling their init (initialization) functions.

The rule LOAD takes care of this initialization: it (1) initializes the internal state-machine state ρ_i, for each [symbol] uid [symbol] _i, using the corresponding initSM function; (2) starts a new thread on each state-machine; (3) assigns n disjoint freelists from F to each thread; and (4) checks that σ_0 satisfies the precondition of each PEEs main function, [symbol] uid [symbol] _i.init.pre(x), for an instance a_i. instantiating x. These threads are run until they return (via one of the rules). At that point, it is necessary to ensure that the post-condition of the thread holds for the exact same instance a_i. Thus, instance a_i is carried in the thread to be used when checking the post-conditions.

Moreover, the LOAD rule requires each heap compartment to be closed (i.e., closeduid.M, σ_0)) states that any pointer stored in an address in the domain of uid.M has to point to another location in uid.M. In other words, a heap compartment cannot store a pointer to another heap compartment or a stack frame. This property implies an instance of respecting borders on the heap: a PEE function cannot find a pointer on its memory that points to a location not accessible to it.

The LOAD rule chooses a state-machine identifier cid∈dom(k^{→}) as the active state-machine. The active state-machine cid can be switched to any other [symbol] cid [symbol] \hat{ }′∈dom(k^{→}) any time using the SWITCH rule, allowing modelling of a preemptive concurrent dynamics.

The rest of the semantic rules, except the last two handling interrupts, are defined based on the internal state of the top thread on the stack of the running state-machine. For example, the CMD rule is fired when the top thread on the stack of the running state-machine wants to take a local (τ) step. The rule ensures that the multi state-machine state also steps accordingly. CMD asserts that the read/write footprint of the internal state-machine state only touches the memory locations the thread has exclusive access to.

If the top thread on the stack of the running state-machine calls a PEE function, the rule PEE-CALL (1) identifies the callee and the arguments passed to it using the function extCall; (2) updates the comment internal state-machine state to wait for its callee to return; and (3) spawns a new thread on top of the state-machine's stack, initializes its internal state-machine state using the function initCore, and assigns a fresh freelist to it. lt also checks that the call respects the specifications by ensuring that σ satisfies the pre-condition of the callee for some b.

To avoid complications of implementing locks in the semantics, they are simulated by adding an extra condition on PEE-CALL that allows initialization of a PEE function of [symbol] uid [symbol] \hat{ }′ as a callee if [symbol] uid [symbol] \hat{ }′ does not appear anywhere on the stack of any of the state-machine in (k_1)^{→} (i.e., if [symbol] uid [symbol] \hat{ }′∉active((k_1)^{→})). If this criterion is not met then the PEE that has the lock on a different state-machine and thus the caller's thread needs to wait (using the WAIT rule) until the lock is released. Note that the implementation of locks may result in Iivelock (e.g., two PEEs may mutually wait for each other).

When the top thread on the stack of the active state-machine halts: If there is at least one other thread on the stack waiting for its result, the rule PEE-RET uses the function extRet to update the internal state-machine ρ based on the return value v. It also ensures that the post-condition of [symbol] mainf [symbol] \hat{ }′ holds for the argument a\hat{ }′. By construction, a\hat{ }′ is the same argument that satisfies the precondition of [symbol] mainf [symbol] \hat{ }′. If there is no other thread waiting on the state-machine, the state-machine is terminated.

Interrupts are modelled as an interrupt handler function within the PEE for each state-machine. For the state-machine cid, the interrupt handler function of PEE [symbol] uid [symbol] _cidInt is appointed. As a PEE, [symbol] uid [symbol] _cidInt has its own assigned memory location, which consists of the state-machine's interrupt description table and its interrupt flag, describing whether interrupts are allowed for the state-machine or not. [symbol] uid [symbol] _cidInt has two distinct functions: init, and setCtx. Other PEEs may call the PEE function setCtx to change the interrupt flag of the state-machine.

The function init (which takes no arguments) checks whether interrupts are available for the state-machine and, if so, it calls an interrupt function of a PEE corresponding to the interrupt service routine. The preemptive model allows init to take control of the state-machine at any point in time, assigning the highest priority to the interrupts. As a result, the init function needs to have an always true pre-condition to ensure that it can always be initialized: [symbol] uid [symbol] _cidInt.init.pre=true.

The INTERRUPT rule models the preemptive semantics. To enforce the locks of PEE functions, the extra premise [symbol] uid [symbol] \hat{ }′∉active((k_1)^{→}) is required. Thus, in this model, an interrupt cannot get interrupted until an end of interrupt acknowledgement is explicitly generated. When the interrupt handler terminates, INTERRUPT-RET hands back the state-machine to the original interrupted thread asserting the post-condition of the interrupt handler's init function. This rule is similar to other return rules, except that the internal state of the interrupted thread is not updated after the return. As a result, this specific return must be distinguished from others (e.g., PEE-RET) A subscript, int, is assigned to the state-machine cid, (i.e., [symbol] cid [symbol] _Int) when the interrupt handler of the state-machine initializes (INTERRUPT), and it is removed it after it returns (INTERRUPT-RET).

### Theory

A set of theorems will now be presented that, when true, provide the result that the abstract compartmentalization disclosed herein yields sound composition of PEE security mechanisms (e.g., TPSM and ICSM) across multiple PEEs across multiple state-machines.

Security mechanisms verified of each PEE in isolation hold on concurrent executions of the whole system. To support this, the property of respecting the interface (i.e., respecting TPSM, ICSM and specified pre- and post-conditions invariants) is shown. A PEE respects the interface iff all of its functions respect the interface. A set of PEEs U respects the interface, if all uid∈U respect the interface.

A guarantee condition of a thread when it evaluates its own code can be defined. The guarantee condition G(δ, σ, F, M) holds iff M is closed with respect to σ and the footprint δ only touches the memory regions in F and M (i.e., closed (M, σ) ∧ [symbol] dom(σ)⊆F∪M [symbol] ). For this, each internal step of a thread must satisfy the guarantee condition.

Any step the thread takes asserts the guarantee condition: it does not leak any references and only changes its own heap and stack. Moreover, the step results in a new configuration that has the same property. Further, if the thread halts, its return value is not a pointer. In the case of an external PEE function call, the caller can assume that its callee only extends the global memory according to the agreed-upon boundaries. The state after the return continues to have the same property.

If each PEE respects the interface in isolation, any concurrent run of the whole system respects the interface. In particular, in any concurrent run, when a function returns, the global memory state satisfies the function's post-condition.

When all functions respect the interface, a given state-machine invariant is preserved in any concurrent execution. This result shows that under the conditions ensuring that a configuration initializes successfully, the state-machine can always progress by taking a step other than SWITCH.

Theorem 1 (Preservation of Interface Confined Invariants): If a system of PEE U respects the interface, then every step of the abstract operational semantics, discussed herein, preserves the invariants governing the interface.

Corollary 1 (Preservation of trusted path security mechanism invariant): If a system of PEE U respects the interface, then every step of the abstract operational semantics, discussed herein, preserves the invariants corresponding to the state-machine trusted path security mechanism.

Corollary 2 (Preservation of Non-interference Interface Confined Security Mechanism invariant): If a system of PEE U respects the interface, then every step of the abstract operational semantics, discussed herein, preserves the invariants corresponding to the state-machine non-interference interface confined security mechanism.

Theorem 2 (Progress). If a system of PEE U respects the interface and is valid with respect to a global memory state σ, then the well-defined configuration ( [symbol] uid [symbol] _1.init∥ ⋅ ⋅ ⋅ ∥ [symbol] uid [symbol] _n. init)_(σ_0), can be successfully initialized and every state-machine in the compositional concurrent run of the configuration enjoys progress, i.e. every core can either take a step other than SWITCH or it terminates (with TERM, DONE, or ABORT).

### Mathematical Model Implementation Validation Mechanism

A system and methods to perform conformance testing of the mathematical model and the PEE implementations in order to ensure that PEE implementation preserves the security mechanisms that are proven in the mathematical model is discussed herein. In one embodiment of this system the conformance testing between mathematical model and PEE implementation can be done in a Continuous Integration/Continuous Development (CI/CD) software development pipeline.

FIG. 14 shows a system 1400 for mathematical model implementation validation mechanism 2001 according to some embodiments. In system 1400, mathematical model implementation validation mechanism 1401 comprises (see connecting lines 1477, 1458 and 1451) one or more test generation mechanism 1402, one or more trace capture mechanism 1403, and one or more trace validation mechanism 1404 respectively. The mathematical model implementation validation mechanism 1401 uses (see connecting line 1460) one or more mathematical model 102. Mathematical model 102 models (see connecting line 1467) one or more computer platform 105 and specifies (see connecting line 1468) one or more system security mechanism 114.

In system 1400, test generation mechanism 1402 outputs (see connecting line 1472 and 1471) one or more state graphs 1405 and one or more test cases respectively. Test generation mechanism 1402 also constrains (see connecting line 1470) one or more state graphs 1405. One or more test cases 1406 run-on (see connecting lines 1465 and 1466) one or more emulated computer platform 1416 and one or more computer platform 105 respectively.

In system 1400, trace capture mechanism 1403 invokes (see connecting line 1459) one or more test cases 1406 and uses (see connecting line 1464) one or more PEE instrumentation 1409 and generates (see connecting line 1457) one or more trace log. Computer platform 105 contains (see connecting line 1462) one or more PEE implementations 1410. Similarly, emulated computer platform 1416 contains (see connecting line 1469) one or more PEE implementation 1410. mathematical model implementation validation mechanism 1401 validates (see connecting line 1461) one or more PEE implementation 1410. PEE instrumentation is performed-on (see connecting line 1463) one or more PEE implementations 1410.

In system 1400, trace validation mechanism 1404 uses (see connecting line 1450 and 1452) one or more mathematical model 102 and one or more trace log 1407 respectively. Trace validation mechanism 1404 generates (see connecting line 1453) one or more implementation validation model 1408. Finally, trace validation mechanism 1404 uses (see connecting lines 1475 and 2054) one or more model checkers 1417 and one or more theorem provers 104 respectively. One or more theorem provers 104 uses (see connecting line 1455) one or more implementation validation model and prove (see connecting line 1456) one or more system security mechanism 114. One or more model checkers 120 uses (see connecting line 1476) one or more implementation validation model and prove (see connecting line 1480) one or more

system security mechanism 114. In one embodiment of the system 1400 the mathematical model 102 models the computer platform 105 as a state machine. The state machine has a set of variables, and each state is an assignment of specific values to those variables. The variable can represent memory state, processor state and/or peripheral state with the memory state including state of the PEE memory regions including PEE functions. The state machine also has a set of allowed actions, which are transitions from one state to the next state. State graphs 1405 can be constructed by drawing states as nodes and allowed actions as edges. A behavior is any path through the graph. The mathematical model 102 may be modeled with existing assume-guarantee interface confined automated modeling mechanisms as discussed in U.S. Pat. No. 12,367,328.

In some embodiments of the system 1400, the mathematical model 102 describes the computer platform and PEE execution as a transition system. In this embodiment a so-called “transition predicate” describes how the system may change its state from one state to another. When the predicate says “true” for two states s1 and s2, the system is allowed to move from state s1 to s2. If the predicate then also says “true” for s2 and some s3, the system can move from s1 to s2 to s3, and so on. Given the transition predicate, and another, “initial” predicate that specifies which states are valid starting states, mathematical model checkers 120 can construct all valid sequences of states. Additionally, the mathematical model can specify a predicate that defines what the “good” and the “bad” states are, and the model checkers 120 can then raise an alarm if a bad state can be reached through some valid sequence of states.

In one embodiment of system 1400, the mathematical model 102 of the computer platform 105 comprises one or more PEE implementation 1410 interfaces (formal representation of PEE functions) that change state when they execute. This state can be a memory state, processor state and/or peripheral state. As mentioned previously for each PEE uid∈dom(U) and every function f∈uid.(fd), an interface {P(x)}uid.f{Q(x)} is fixed and collected in the set Δ_u. P(x) and Q(x) are pre- and post-conditions of the function f, respectively. The mathematical model 102 models functions by defining the transition predicate to be: the pre-condition P(x) holds and the post-condition Q(x) holds.

In some embodiments of the system 1400, the mathematical model 102 specification has a set of behaviors Bspec, and the PEE implementation 1410 has a set of behaviors Bimpl. Mathematical bisimulation is used to prove the PEE implementation 1410 refines the mathematical model 102 specification if Bimpl⊂Bspec and the converse is also true if Bspec⊂Bimpl. mathematical model implementation validation mechanism 1401 checks if the PEE implementation 1410 can produce all possible behaviors described in the mathematical model and vice versa, verifying that the PEE implementation 1410 has preserved all the system security mechanism 114 specified and proven in the mathematical model 102.

In system 1400, the test generation mechanism 1402 generates test cases 1406 that force a set of PEE implementation 1410 to follow a sequence of transitions specified in a mathematical model, thereby ensuring conformance between the implementation and the model. In particular, for every behavior in the specification (Bspec), the test generation mechanism generates a test case that exercises the implementation in a specific sequence of transitions, such that if there is a behavior in the specification that the implementation cannot follow, then Bspec [symbol] Bimpl. In one embodiment, mathematical model checkers 1417 are used to output an entire state graph for the mathematical model specification, which may be constrained to interfaces for a set of PEE implementation 1410.

In one embodiment of system 1400, a Directed Acyclic Graph (DAG) with a finite number of behaviors, each representing a path from an initial state to a final state may be employed to output state graphs 1405. The model checker's 120 output is then parsed, and a unit test is automatically created for each behavior in the DAG. This parsing process may involve traversing the graph using a depth-first search (DFS) algorithm to identify all possible paths from an initial state to a final state, wherein each path is used to generate a test case that exercises the PEE implementation 1410 in a specific sequence of transitions.

In some embodiments, fuzzing tools, such as AFL or LibFuzzer, may be employed to create unit tests for each behavior in the DAG. These fuzzing tools are configured to generate random inputs that exercise the implementation in a specific sequence of transitions, and the resulting test cases are then validated against the expected behavior. Alternatively, a Large Language Model (LLM), such as a neural network or a decision tree, may be used to generate fuzzed inputs for each behavior in the DAG, wherein the LLM is trained on a dataset of valid and invalid inputs.

In one embodiment of system 1400, the test generation mechanism 1402 may also utilize coverage-guided fuzzing tools to create unit tests for each behavior in the DAG. These tools are configured to generate random inputs that maximize code coverage, and the resulting test cases are then validated against the expected behavior. Furthermore, the test generation mechanism may be integrated with existing PEE unit tests in a Continuous Integration/Continuous Deployment (CI/CD) manner, using a test framework such as JUnit or PyUnit to run the automatically generated unit tests.

In other embodiments, the DAG parsing process involves constraining the state graph 1405 to interfaces for a set of PEEs or a single PEE, by applying interface-specific filters to the state graph 1405. The resulting filtered graph is then used to generate test cases 1406 that exercise the PEE implementation 1410 in a specific sequence of transitions.

In system 1400, the trace capture mechanism 1403 generates a trace log file that records a PEE implementation's 1410 state transitions, including all implementation variables that match mathematical model specification variables, for every behavior in Bimpl. If the behavior recorded in the trace is not allowed by the spec, then Bimpl [symbol] Bspec and the test fails. To achieve this, the mechanism involves PEE instrumentation 1409 which modifies PEE functions to detect pre- and post-conditions using two mechanisms: (i) instrumentation interspersed into the PEE functions; and (ii) instrumentation support functions kept in a separate PEE. The instrumentation that is interspersed into the PEE function records the appropriate state details for the pre- and post conditions which involve memory state (heap and stack), processor state and associated peripheral state. Each collected state pair describes the PEE functions state for a set of PEE functions for a given behavior. The instrumentation support functions allow for obtaining relevant stack, heap and processor traces and storing those traces in memory to be later stored to a non-volatile storage media such as the disk. Finally, the trace capture mechanism invokes the set of behaviours by executing the test cases 1406 and collects the corresponding state pairs for the PEE functions that are executed as part of the test case in one or more trace log 1407. The PEE instrumentation 1409 technique employed by the trace capture mechanism 1403 may vary depending on the specific requirements of the PEE implementation 1410.

In some embodiments of system 1400, PEE instrumentation 1409 may be performed using various techniques, including source-level instrumentation by modifying the PEE source code to add logging statements that record pre- and post-conditions, such as through aspect-oriented programming or programming language and compiler plugins. Alternatively, binary-level instrumentation may be employed using tools like binary rewriting or instrumentation frameworks, such as DynamoRIO, allowing for modification of PEE functions without changing the source code. Additionally, eBPF probes can be utilized to add instrumentation to PEE functions, leveraging extended Berkeley Packet Filter feature for tracing and debugging.

In certain embodiments of system 1400, instrumentation support functions may be implemented using eBPF to obtain stack, heap, and processor traces, or utilizing processor performance registers to collect processor-state information. These support functions can store collected traces in memory and later stored to non-volatile storage media, such as disk. Furthermore, kernel or hypervisor APIs can be employed to access low-level system information for tracing and debugging purposes.

In one embodiment of system 1400, the trace capture mechanism 1403 may also involve running test cases within a regular computer platform 105 or an emulated computer platform 1416 including emulators like QEMU, Bochs or dynamic execution engines such as Valgrind or Pin, to collect traces. Moreover, parallel test cases 1406 execution and trace capture can be achieved using containerization technologies, like Docker or Kubernetes, where each test case is executed within its own container for efficient resource utilization.

In a preferred embodiment, the trace capture mechanism 1403 incorporates unforgeable telemetry mechanisms, such as those discussed in U.S. patent application Ser. No. 19/254,764 filed on Jun. 30, 2025, to collect trustworthy and tamper-proof traces that can be used to detect security vulnerabilities or performance issues. Furthermore, hardware-based tracing technologies, including Intel's Processor Trace (PT) or ARM's Embedded Trace Macrocell (ETM), may be utilized to collect detailed information about processor execution and memory access patterns.

In all embodiments, the trace capture mechanism 1403 is designed to collect accurate and reliable traces that can be used to verify the preservation of the system security mechanism 114 of a set of PEE implementation 1410 with respect to a mathematical model specification.

In system 1400, the trace validation mechanism 1404 ensures that PEE implementation 1410 traces comply with mathematical model specification. The trace validation mechanism 1404 summons the state transition predicate of the mathematical model, and checks if the state pairs that are obtained satisfy the predicate for the invariants corresponding to the security mechanism that is modeled. If it doesn't, then the implementation has done something that the mathematical model didn't account for and an alarm is raised (failing the trace validation process). If the state pairs satisfy the predicate for the invariants corresponding to the security mechanism that is modeled, then the implementation preserves all the security mechanism invariants that have been proven in the mathematical model and a success is reported.

In system 1400, the trace validation mechanism 1404 generates an implementation validation model 1408 for this purpose. The implementation validation model 1408 is another mathematical model that is derived from the original mathematical model but includes the state transition predicate and invariant relation and all the collected traces from the unified trace log 1407. The trace validation mechanism 1404 then uses a combination of theorem provers 104 and model checkers 120 in order to prove the invariant relation.

In one embodiment of system 1400, this mathematical model can be specified in temporal logic of actions (TLA+) with the transition relation ‘Next(x, y)’, and the recorded pre- and post-states s and s′. The implementation validation model is created with ‘Init(x)==x=s’ and ‘Next2(x, y)==y=s′∧Next(x, y)’, and the validation check essentially is a mathematical model checking to see if the implementation validation model deadlocks or not. If it does, then the state doesn't conform to the transition relation and therefore the implementation does not meet the mathematical model specification an alarm is raised (failing the trace validation process).

In some embodiments of system 1400, the failure of the trace validation mechanism 1404 may produce a mathematical counter-example which shows the type and details of the failed relation and corresponding states associated with it. This information can be used to fix the PEE implementation 1410 accordingly in order to make it conformant to the mathematical model 102.

### Mathematical Model ICSM Verification Mechanism

The present invention consists of a method to enable composing a previously formally verified software component with an unverified software component or another formally verified software component. The method employs rely-guarantee mathematical reasoning and uses interface confinement in order to achieve compositionality of high-assurance formally verified software modules.

The system of the present invention further comprises an idiomatic code representation mechanism (ICRM) that converts PEE code into an idiomatic code representation (ICR) that describes the operation of the PEE code and allows proving composition of ICSM across PEEs. In one embodiment, the ICR consists of a high-level language representation of a low-level programming language.

The ICRM involves converting low-level programming language code of a PEE (e.g., Verilog, Assembly) into ICR functions which are encoded as higher-level programming language functions amenable to verification (e.g., C, Java, Rust) via pseudo-statements and pseudo-calls (ICR statements).

In one embodiment, for the x86 Assembly language instruction movcr3 involving register eax there is a corresponding ICR function called ci_movl_eax_cr3. Each ICR function comprises ICR statements that are defined in a hardware model and bridges the shift between the reference higher-language semantics and the hardware instructions (e.g. access to memory and to registers). During verification, each ICR statement is replaced by the higher-level programming language source code from the hardware model. The resulting higher-level program is verified for required properties using off-the-shelf high-level program language verification tools (e.g., Frama-C for C language, KeY for Java language, coq-of-rust for Rust language)

ICR faithfully models the low-level language in a PEE and the execution trace of the new PEE with higher-level language and ICR is semantically equivalent to the original higher-level language and low-level language program.

ICR functions are verified to respect the higher-level language application binary interface (ABI), which is crucial for the soundness of verification. During compilation, all ICR statements are replaced by the corresponding low-level language equivalent statement. ICR supports two-way nested high-level language to low-level language function calling with full device modeling. This allows using various verification techniques to prove (higher-level) properties on device states other than just memory and numeric.

The ICR hardware model formalizes the processor and modeling the memory and associated hardware conduit end-points of a given platform and processor architecture. The hardware model is crucial for verifying properties over collections of hardware state (e.g., state of processor registers and memory) and assertions that are part of the ICR function contract. The hardware model also includes an Instruction Set Architecture (ISA) model that models a set of instructions for a particular processor architecture.

One embodiment of the invention uses a modular and layered hardware model where only the required subset of the hardware is modeled and used during verification (e.g., the hardware model for a RISC-V platform with a single address space is simpler than a platform executing with hypervisor privileges). This greatly aids verification automation and facilitates validation of the hardware model against real hardware.

Further, the hardware model is preferably specified in an abstract specification language which can then be automatically synthesized down to desired target languages such as C, Java and Coq. This allows the hardware model to be more readily integrated into existing verification toolchains and methodologies that could be employed to verify a PEE written in different programming languages.

The proposed method does not add any runtime overhead to native low-level programming language code blocks of a given PEE. We re-write the associated low-level programming language code blocks using the ICR for verification purposes and automatically re-generate the corresponding low-level language statements during compilation. This achieves optimal runtime performance.

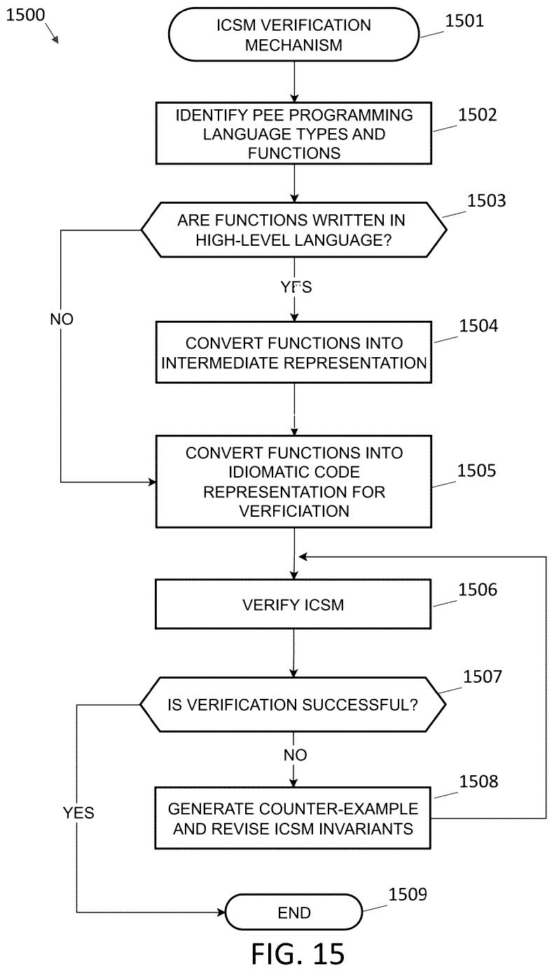

FIG. 15 shows a system 1500 for mathematical model ICSM Verification Mechanism according to some embodiments. In system 1500, the ICSM verification mechanism 1501 performs a series of steps and checks. As a first step, it identifies PEE programming language types and functions 1502. It then performs a check to see if the PEE functions are written in high-level language 1503. If the check at step 1503 is a “YES”, the ICSM verification mechanism converts the PEE functions into intermediate representation 1504. It then converts the PEE functions into idiomatic code representation for verification 1505. If the check at step 1503 is a “NO” the ICSM verification mechanism converts PEE functions into idiomatic code representation for verification 1505. After performing step 1505 the ICSM verification mechanism verifies the ICSM 1506. It then performs a check to see if the verification is successful 1507. If the check at step 1507 is a “YES” then the ICSM verification mechanism ends 1509. If the check at step 1507 is a “NO” the ICSM verification mechanism generates counter-examples and revises ICSM invariants 1508 and proceeds back to step 1506.

In some embodiments of system 1500, the step identify PEE programming language types and functions 1502 consists of the following additional steps:
Module Dissection and Function Identification: The first step in identifying low-level programming language functions that a PEE depends on is to disassemble the PEE code into its constituent components, including inline low-level language code, self-contained low-level language routines, external function calls, and other dependencies. In this embodiment, this may be performed through a combination of static analysis and dynamic instrumentation techniques. In this embodiment, a modular reverse engineering mechanism is employed, where the PEE code is broken down into smaller units, such as functions, procedures, or even individual lines of code, to facilitate easier analysis and identification of dependencies.
Low-level language Code Extraction: In the aforementioned embodiment, once the PEE has been disassembled into smaller units, the next step is to extract any low-level programming language code that may be present or embedded directly within the PEE code. In this embodiment, such low-level programming language code can be used for system operations such as memory management or hardware interaction. In this embodiment, a combination of regular expressions and lexical analysis is employed to identify and extract these low-level programming language code snippets, which are then analyzed further using static analysis to determine their dependencies on external PEE functions.
Function Call Graph Construction: Further in the aforementioned embodiment, a mechanism to identify external function calls that the PEE depends on is employed where a function call graph (FCG) is constructed that represents the relationships between the PEE's functions and procedures. The FCG is built by analyzing the PEE code for function calls, including both explicit calls using function names or pointers, as well as implicit calls through indirect means such as pointer dereferences or function pointers. Once the FCG has been constructed, it is then analyzed to identify any external functions that are being called, along with their formal parameters and return values.
Low-level Programming Language Dependency Identification: Finally, within this embodiment, the low-level programming language code is extracted and the function call graph constructed, and external low-level programming language function dependencies are identified. A combination of static analysis and dynamic instrumentation techniques are used to determine which external functions are being called by the PEE's code snippets. This information is then used to construct a comprehensive list of dependencies on external low-level programming language functions, including both self-contained low-level programming language routines and external function calls, along with their formal parameters and return values.

In one embodiment of system 1500, all the seL4 high-assurance kernel operating on RISC-V Architecture's Assembly language instructions (that are not formally verified) are identified and their corresponding calling interface (input/output parameters) is built with seL4 C code that is formally verified. In this embodiment, first all the seL4 RISC-V Assembly language code blocks are identified and their corresponding calling interface w.r.t the seL4 C code is built. Then an idiomatic code representation (ICR) is created for each identified Assembly language code block with input and output parameters. The ICR definition uses the RISC-V Application Binary Interface (ABI) specifications, identifying the system registers and stack locations that formal parameters and return results occupy.

In some embodiments of system 1500, the step convert functions into intermediate representation 1504 consists of the following additional steps:

In the aforementioned embodiment, the first step is front-end analysis, where the PEE code is parsed and analyzed to identify the syntax and semantics. This is done using a parser generator tool to produce an abstract syntax tree (AST) that represents the PEE code structure. The AST serves as an intermediate representation of the PEE code, providing a platform-independent and language-agnostic way to represent the PEE's control flow. The next step involves semantic analysis, where the AST is traversed to identify the types and properties of each variable, function, and data structure. This information is used to generate type information and metadata that will be used later in the compilation process. Once the semantic analysis has completed, the AST is then transformed into an intermediate representation (IR). This involves creating a series of instruction-level nodes that correspond to the basic blocks in the program. The IR is designed to be architecture-agnostic and machine-independent, providing a common platform for further optimization and transformation. Each node in the IR corresponds to a specific instruction that can be executed on any architecture.

In the aforementioned embodiment, the IR is then further optimized using a series of passes, which apply various transformations to improve code quality and performance. These passes can include optimizations such as dead code elimination, register allocation, and loop unrolling. The goal of these passes is to create an optimal sequence of instructions that minimizes execution time and maximizes efficiency. After optimization has completed, the IR is then lowered into a target-specific machine language, such as x86 or RISC-V assembly code. This process involves replacing high-level operations with their corresponding low-level equivalents, taking into account the target architecture's instruction set and memory model.

In one embodiment of the present invention the ANTLR or yacc parser generator tool produces an abstract syntax tree (AST) that represents the PEE code structure during front-end analysis step. In the semantic analysis step, the LLVM compiler framework is used which uses a data structure called “metadata” (md) to represent the semantic information of the program, which includes details such as type, layout, and attributes. The LLVM compiler framework also generates the LLVM intermediate representation (IR) for the IR transformation step. The LLVM compiler framework additionally includes several passes for the IR optimization phase at various levels of optimization. The LLVM compiler framework finally generates Assembly language code for various platform architectures including RISC-V, x86 and ARM. In some embodiments of system 1500, the step convert functions into idiomatic code representation for verification 1505 consists of encoding the low-level programming language function or intermediate representation statements into ICR function along with ICR statements.

In this embodiment a RISC-V ISA model and the model of the SoC computer platform is used to define the ICR statements.

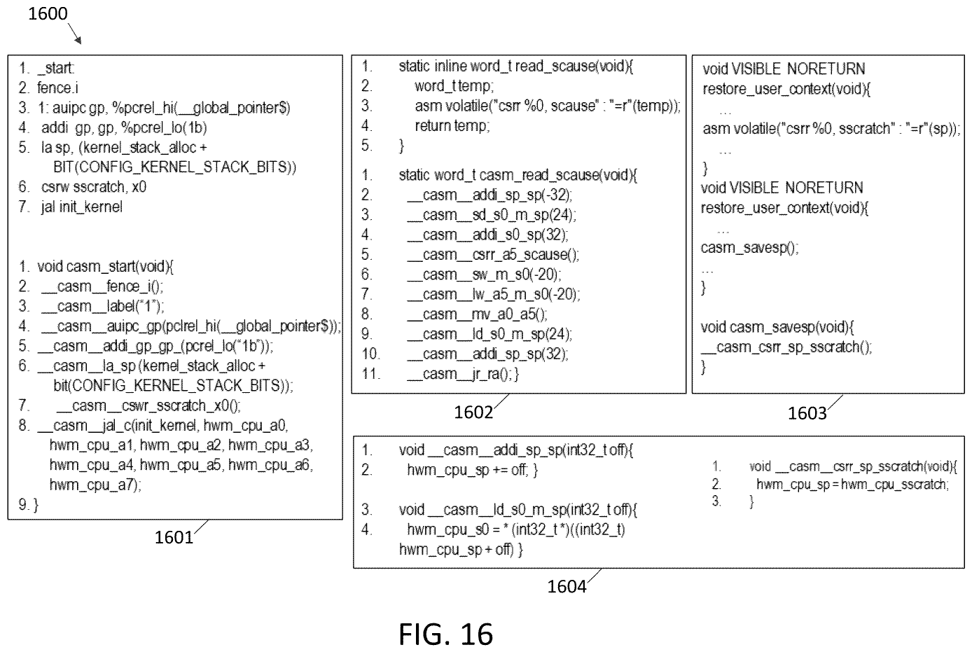

FIG. 16 illustrates an embodiment of system 1500, including example code listings 1601, 1602, 1603 and 1604 for implementing the system 1500 described herein. In this embodiment the seL4 startup Assembly language code and the corresponding ICR function with the input and output parameter specification is shown 1601. First, the RISC-V ABI for system call invocation specifies that all parameters are passed via registers. Thus, the seL4 startup ICR function has the format “casm_start(void)” where (void) signifies no direct parameters on stack. In this embodiment there are two other classes of seL4 Assembly language code blocks: Self-contained inline Assembly 1602 and inline Assembly mixed with C 1603. For the former, we rewrite the entire function as a ICR function while preserving the same C function declaration. For the latter, we encode a new ICR function corresponding to the inline Assembly code block with appropriate parameters and return result declarations per the inline Assembly syntax.

In this embodiment high-assurance kernel seL4's RISC-V Assembly language code block is converted into a formally verifiable ICR function via the ICR RISC-V C-language ISA model. The embodiment focuses on conversion of one function from the three classes of Assembly language code blocks as described previously (self-contained, inline and mixed). For each instruction within a given seL4 Assembly language code block, we write a RISC-V Instruction Set Architecture (ISA) C code which embodies the semantics of the corresponding RISC-V instruction. The seL4 inline Assembly language statement in 1603 is converted to an invocation of “_casm_csrr_sp_sscratch( )” which is a C function defined in the RISC-V C-language ISA model 1604 that in turn uses specific hardware model registers (prefixed with “hwm_”) to encode the semantics of the instruction. In this case it reads from the “scratch” control register and puts the return value into the “sp” register. This mechanism essentially converts a seL4 Assembly language code block into C language function invocations and definitions via our RISC-V C-language ISA model to give us a full C program that can then be formally verified for ICSM invariants and functional correctness.

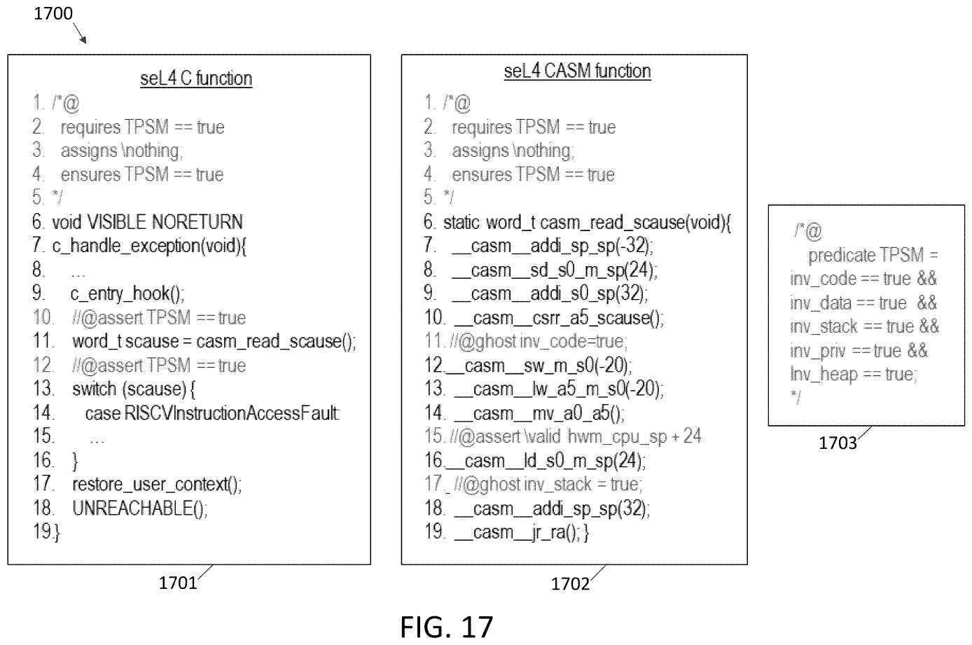

FIG. 17 illustrates an embodiment of system 1500, including example code listings 1701, 1702, and 1703 for implementing the system 1500 described herein. In this embodiment the step verify ICSM 1506 comprises verifying ICSM for Assembly language functions encoded in the ICR 1702. In this embodiment mathematical hoare logic and hoare-triples are employed in order to ensure: (a) heap safety; (b) stack safety; (c) data safety; (d) code safety; and (e) privilege separation. In addition, there are invariants for: (i) processor control state manipulated by processor control instructions; and (ii) caller application binary interface (ABI) safety verification from a higher-level language function that invokes the assembly language function. Together the aforementioned invariants specify TPSM and a non-interference ICSM. In this embodiment, hoare logic (a formal system for reasoning about programs) is used to specify and verify the correctness of the seL4 kernel code by stating preconditions and postconditions, which are assertions about the state of the program before and after execution. Each individual ICR function (that comprises the CASM function corresponding to the Assembly language code) has corresponding hoare-triple assertions expressed which involves specifying a set of pre-conditions and post-conditions. The resulting annotated program is then passed into a verification tool for a given high-level language that the ICR statements and hardware model is specified in and in turn the verification tool can use a set of techniques ranging from abstract domain interpretation to deductive program verification to prove the hoare-triple assertions 1701, 1703 and 1703.

In one embodiment of system 1500, heap safety is ensured by maintaining a predicate (Boolean variable) called inv_heap which is initially set to true upon the ICR function entry. For every ICR statement invocation a pre-condition is then added to check if the memory and registers involved in the ICR statement point anywhere outside of the allowed global memory regions for the specific ICR function. If so, inv_heap is set to false and the verification is aborted.

In another embodiment of system 1500, stack safety is ensured by maintaining a predicate (Boolean variable) called inv_stack which is initially set to true upon ICR function entry. Further, a function stack is modeled via a bounded global stack variable which is populated with: return address, function parameters and local variables as defined by the ICR function. The stack pointer processor hardware model register is then set to point to the top of this global stack upon ICR function entry. For every ICR statement invocation a pre-condition is then added to check if the stack pointer is pointing to a location within the bounded global stack and that the memory and registers involved in the instruction if using the stack pointer register points to a valid location within the global stack. If not, inv_stack is set to false and the verification is aborted.

In yet another embodiment of system 1500, processor control state safety is ensured by maintaining a predicate (Boolean variable) called inv_processorctrl which is initially set to true upon ICR function entry. For every ICR statement invocation that involves a processor control register access, a pre-condition is added to check if the processor control register is in the correct state and a post-condition is added to check if the processor control register state is maintained after the instruction.

In some embodiments of system 1500, caller ABI safety is ensured by maintaining a predicate (Boolean variable) called inv_cabi which is initially set to true upon ICR function entry. At the entry of the ICR function all the processor registers that are part of the caller ABI for the high-level language function that invokes the ICR function are saved into temporary variables or given unique values. Then at the end of the ICR function the same set of processor registers are then checked for the values they held on ICR function entry. If any of the processor registers that are part of the caller ABI have changed values then inv_cabi is set to false and the verification is aborted.

In one embodiment of system 1500, the “is verification successful” step 1507 is true if inv_heap, inv_stack, inv_processorctrl and inv_cabi are all true at the exit of the ICR function. In this embodiment, TPSM and non-interference ICSM holds for the ICR function and it can be safely composed with the higher-level language caller functions for any properties that have been already verified on the higher-level language caller functions. If any one of them is false, then TPSM and non-interference ICSM does not hold. In this embodiment, the pre and post conditions for the aforementioned invariants are encoded using the ICR hardware model registers, program global variables as well as the bounded global stack.

In another embodiment of system 1500, the step to generate counter-example and revise ICSM invariants 1508 is performed using a mathematical theorem prover 104 or mathematical model checker 120. In this embodiment the ICSM invariants are revised in the mathematical specification language using temporal logic of actions. In other embodiments the ICSM invariants are revised using hoare-logic and ACSL specifications on the PEE code.

In the embodiment of system 1500 described in FIG. 17, non-interference ICSM invariant is proven on all the seL4 high-assurance low-level Assembly language blocks 1702 and sel4 high-level C language functions 1701. In this embodiment the non-interference ICSM is proven on all the seL4 PEE code and RISC-V firmware PEE code Assembly Language code blocks expressed as ICR functions. In the embodiment, the sel4 C function “c_handle_exception” invokes the seL4 CASM function “casm_read_scause”. The embodiment employs the ACSL specification language to define the hoare-triple invariants which can then be discharged via the Frama-C code-level verification tool-chain. The ACSL predicate specification is used to define TPSM as a conjunct of inv_code, inv_data, inv_stackm inv_ps and inv_heap. The predicate function is then used within the requires and ensures ACSL clause for each function definition which establishes the hoare-triple and rely-guarantee reasoning between the caller function and the callee function. Finally, the ACSL assert and ghost clauses are employed to define specific validity checks for each of the invariants in conjunction with the ICR RISC-V C-language ISA hardware model. In this embodiment, inv_stack is defined using the \valid ACSL specification, which ensures that stack frame memory location is valid for every access to the stack pointer register. Similarly, ACSL ghost clauses are used to set inv_code values after every memory access function that could potentially manipulate memory related to code. In this embodiment, the use of ACSL as the specification language allows use of automated C verifiers such as Frama-C to discharge the invariants via back-end theorem provers and SAT solvers. The RISC-V C-language ISA hardware model is passed along with the ICR function as one single C program to Frama-C. This allows capturing seL4 and RISC-V firmware Assembly language semantics during the verification process. The abstract interpretation (program over-approximation) technique of Frama-C is employed which allows us to assert on specific values of registers/memory and prove a sound overapproximation of memory/register accesses done by the C and Assembly Language code of seL4 and the RISC-V firmware. In this embodiment, the proof of TPSM and non-interference ICSM ensures that the existing high-level language proofs of seL4 kernel remain unaffected in the presence of other PEEs.

### Verifying PEE Functional Correctness

The system of the present invention provides a mechanism to verify required functional correctness of PEE code. In one embodiment of the present invention, the functional correctness of the KPEE is verified to ensure correct initial setup of privileged modes, IOMMU and interrupt controller configuration as well as data and instruction caches.

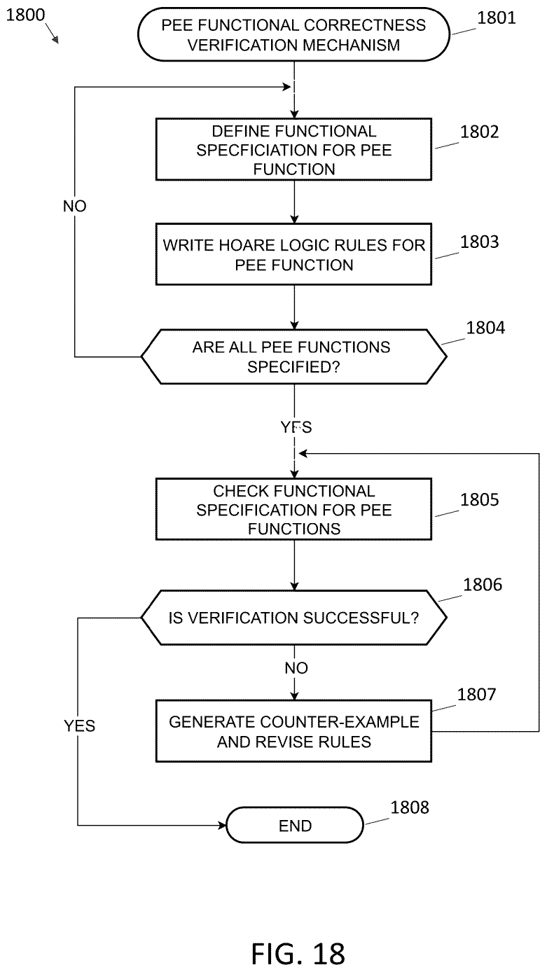

FIG. 18 shows a system 1800 for verifying PEE functional correctness according to some embodiments. In system 1800, the PEE functional correctness (PEEFC) verification mechanism 1801 performs a series of steps and checks. As a first step, it defines functional specification for PEE function 1802. The PEEFC verification mechanism then writes hoare logic rules for the PEE function 1803. It then performs a check to see if all PEE functions have been specified 1804. If the check at step 1804 is a “NO” the PEEFC verification mechanism goes back to step 1802. If the check at step 1804 is a “YES” the PEEFC verification mechanism checks functional specification for PEE functions 1805. It then performs a check to see if verification is successfull 1806. If the check at step 1806 is a “YES” the PEEFC verification mechanism ends 1808. If the check at step 1806 is a “NO” the PEEFC verification mechanism generates counter examples and revises rules 1807 and repeats again from step 1805.

In one embodiment of system 1800, the step define functional specification for PEE function 1802 involves: (a) identifying the input parameters and output values of the function; (b) specify the preconditions that must be satisfied before the function is called; and (c) specify the post conditions that should hold true after the function has completed execution.

In another embodiment of system 1800, the step write hoare logic rules for PEE function 1803 involves writing rules that govern how the PEE state changes during execution. The following rules are written: (a) initial state rule which specify the initial values of the variables and unknown results; (b) one or more statement rules; and (c) Post condition rule that specifies the values of the results.

In some embodiments of system 1800, statement rules are further composed of basic rules, conditional rules, loop-conditional rules, array rules and functional rules. In this embodiment basic rules are further composed of assign rules (If x=E, then: x′=E), sequence rules (If {P} C {Q}, and {R} D {S}, then: {P∧R} C; D {Q∧S}), choice rules (If {P} C {Q}, then: {P} if B then C else D fi {Q}) and loop rules (If {P} while B do C od {Q}, then: {P∧¬B} C {Q}). Further, in this embodiment, conditional rules are composed of if-then rules (If {P} if B then C {R}, then: P∧B} C {R}) and if-else rules (If {P} if B then C else D fi {R}, then: {P} if ¬B then D {R}).

In another embodiment of system 1800, the loop-conditional rules are further composed of while-if rules (If {P} while B do if C then D fi od {Q}, then: {P∧B∧C} D {Q}) and while-cond rules (If {P} while (B and C) do D od {Q}, then: {P∧¬(C)} D {Q}). In this embodiment, the array rules are further composed of array assign rules (If x[i]=E, then: x′[i]=E) and array access rules (If E=x[i], then: E′=x′[i]).

In yet another embodiment of system 1800, the functional rules are further composed of function-call rules(If {P} f(x) {R}, then: {P} call f(x) {R}) and function-return rules(If {P} return E {R}, then: {P} return E {R}).

In other embodiments of system 1800, statement rules can comprise other Hoare Logic rules depending on the specific requirements of the programming language used to implement the PEE.

In one embodiment of system 1800, the step write hoare logic rules for PEE function 1803 is accomplished by analyzing each function and each statement within a given function of the PEE and applying the appropriate rule depending on the function statement encountered. This involves breaking down the statements into different categories, such as loops, conditionals, function calls, and assignments, and applying the relevant rules to each one.

In another embodiment of system 1800 the step check functional specification for PEE functions 1805 involves checking pre-conditions, post-conditions and specifications. This also involves verifying that the final state of the PEE function execution matches what's stated in the post-condition and is accomplished by using a collection of theorem provers that prove specific verification obligations related to the specifications and post-conditions.

In another embodiment of system 1800, the step to generate counter-example and revise rules 1807 is performed using a mathematical theorem prover 104 or mathematical model checker 120. In this embodiment the hoare rules are revised in the mathematical specification language using ACSL.

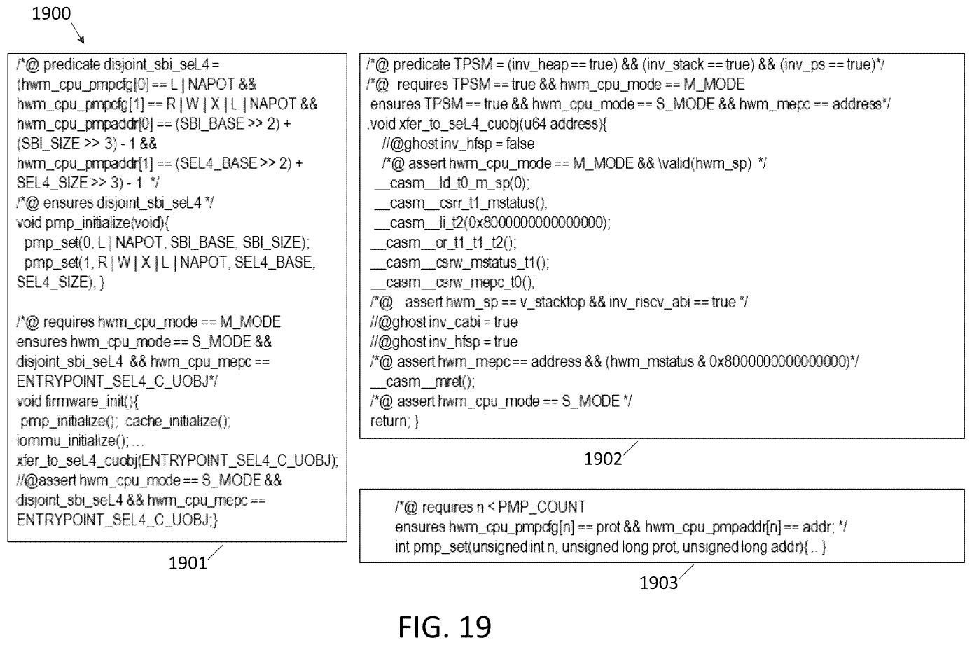

FIG. 19 illustrates an embodiment of system 1800, including example code listings 1901, 1902 and 1903 for implementing the system 1800 described herein. In this embodiment functional correctness on a RISC-V firmware 1901 and seL4 high-assurance kernel Assembly Language code block 1902 is realized. In this embodiment the ‘firmware_init’ function within the RISC-V firmware PEE is responsible for setting up the initial state of the RISC-V Physical Memory Protections (PMP) registers, IOMMU and cache subsystems and transferring control to the seL4 high-assurance kernel running as another PEE in supervisor mode (S-mode).

In the aforementioned embodiment, the firmware_init function is used to set up the PMPs to be disjoint for the firmware and the seL4 PEE functions, so that seL4 PEE cannot read/write to firmware memory regions and can only execute firmware code via a predefined hardware instruction. The PMPs are set up such that the firmware cannot directly execute the seL4 PEE functions but only via a predefined hardware instruction. This is done through the pmp_initialize function, which in turn uses the pmp_set functions to set the RISC-V PMP registers to appropriate base address, size and protection values. The firmware_init function from the RISC-V firmware PEE transfers control to the seL4 PEE function initially with the operating mode set to S-mode, using a special function called xfer_to_seL4_cuobj for this purpose. Further in this embodiment, the functional correctness specifications as well as TPSM invariant specifications are written using the ACSL specification language 1903.

In the aforementioned embodiment, a global predicate called disjoint_sbi_seL4 is defined which ensures that the RISC-V PMP registers with index 0 and 1 are set up with the disjoint RISC-V firmware PEE and seL4 PEE memory regions respectively. The predicate also ensures that the corresponding PMP protection registers have the appropriate protection flags which ensures that seL4 functions cannot directly access RISC-V firmware PEE regions. The predicate uses the RISC-V ISA C hardware model register variables for this purpose. The ACSL requires and ensures clauses are then used to prove that once the firmware_init function is done executing the processor mode is set to S_MODE executing the seL4 PEE function beginning at address ENTRYPOINT_SEL4_C_UOBJ while still ensuring that the disjoint_sbi_seL4 predicate is true.

In the aforementioned embodiment, the pmp_initialize function is verified to ensure that the disjoint_sbi_seL4 predicate is true once it finishes execution. The two functions, pmp_set and xfer_to_seL4_uobj, are invoked from within the pmp_initialize and firmware_init functions of the firmware implementation. xfer_to_seL4_uobj function and its TPSM invariant is first verified as described previously. The ACSL requires and ensures clauses are then used to verify that the processor mode before execution of xfer_to_seL4_uobj is M_MODE (monitor) and after execution is S_MODE (supervisor). The ensures clause is used to prove that the mepc is set to the address provided to xfer_to_seL4_uobj. The requires and ensures clauses establish functional correctness of xfer_to_seL4_uobj, showing that it transfers control to the specified address in S_MODE. The final function verified in this embodiment is pmp_set, which is invoked to set a corresponding RISC-V PMP address and protection configuration register. The ACSL requires and ensures clauses specify that the PMP address (hwm_processor_pmpaddr[ ]) and configuration registers (hwm_processor_pmpcfg[ ]) with the appropriate index (0 through PMP_COUNT-1) are set to the address and prot parameters respectively.

In other embodiments of system 1800, similar techniques are employed towards RISC-V firmware PEE functions which initialize the instruction and data caches as well as the IOMMU via RISC-V CSR register programming (similar to mstatus and mepc registers used within xfer_to_seL4_uobj function).

### Embodiments

A plurality of embodiments of the present invention is disclosed herein.

### Evaluating SSP on Mathematical Model

One embodiment of the system of the present invention comprises a method for analyzing the mathematical invariants to determine whether a SSP for the SoC is satisfied. This analysis may be performed using automated and interactive theorem provers that translate predicates into proof obligations. In some cases, the analysis may also be performed via mathematical model checkers.

In this embodiment, a mechanism is provided for generating a counterexample upon determining that the SSP is not satisfied. This counterexample shows that the SSP does not hold for the SoC operation and provides insight into why this may be the case. This information is used to then revise the mathematical model to fix logic corresponding to the counter-example and model variables. Finally, if there still remains unsatisfied proof-obligations, the SSP is rewritten based on the unsatisfied proof-obligations and the aforementioned steps are repeated until the SSP is satisfied.

In this embodiment, SSP may be defined using the temporal logic of actions mathematical logic. The provided SSP invariants handle memory-safety, control-flow integrity, privilege separation, TPSM, ICSM and non-interference properties all specified using PEEs and their operations.

In other embodiments of the system of the present invention, analyzing the SSPs comprises a computer-assisted theorem proving system, such as Z3, CVC4, or Alt-ergo, to analyze the mathematical invariants and determine if the SSP is satisfied. Alternatively, an interactive theorem prover like Coq may be used for SSP verification. In some cases, analyzing the SSPs involves using an explicit state model checker for temporal logic (TLC) to provide the invariants. The use of a computer-assisted theorem proving system and model checking provides several key benefits. Firstly, it allows for the automated analysis of complex mathematical expressions and the identification of potential security vulnerabilities. This can be particularly valuable in large-scale systems where manual analysis may be impractical or unreliable. Secondly, the theorem proving and model checking system can help to establish a formal proof that the SSP is satisfied, providing a high degree of confidence in the system's security properties. This can be essential for applications where the consequences of a security failure are severe, such as in financial trading systems or critical infrastructure control systems.

### Formally Verified Firmware Bridge

In one embodiment of the system of the present invention, a formally verified firmware bridge SWPEE performs boot-up and initialization of the SoC. In this embodiment, the firmware SWPEE defines functional specifications for its code, writing Hoare Logic rules, applying these rules to the firmware program, and checking post-conditions, thereby ensuring correct functionality required to set up the initial state for other high-assurance kernel operations on top of the firmware SWPEE.

In this embodiment, a system for shared memory communication and enclave orchestration is provided by the firmware SWPEE, enabling efficient inter-enclave communication while maintaining strong isolation guarantees between enclaves through a shared memory access table (SMAT) HWPEE. The firmware SWPEE's management console enclave SWPEE orchestrates the creation and management of multiple virtual machine SWPEEs, allocating resources, initializing operating system kernels or high-assurance kernels, monitoring resource usage, and providing a management interface for user interaction.

In this embodiment, the firmware SWPEE provides flexible and extensible interfaces to other software components on top of the SoC, enabling efficient communication, secure interrupt handling, and thread management while adhering to standardized industry standard architecture APIs (e.g., RISC-V Supervisor Binary Interface (SBI) specification).

In this embodiment, the firmware SWPEE executes as a hybrid M-mode and H-mode software component that takes control of the SoC on boot-up. The firmware SWPEE is implemented so that it boots up in M-mode and performs initialization of PMP, cache and IOMMU operations of the SoC via respective HWPEEs.

In this embodiment, the formally verified firmware SWPEE operates on the SoC realized on a Field Programmable Grid Array (FPGA) using the RISC-V instruction set architecture and in turn runs the seL4 high-assurance formally verified software kernel. The formally verified firmware runs in M-mode while the seL4 kernel runs in S-mode and U-mode. In this embodiment the firmware provides all the required RISC-V Supervisor Binary Interface services that are used by high-assurance seL4 kernel via the M-mode interface using the ECALL instruction. Alternatively, the high-assurance seL4 kernel can use the ECALL instruction to access the firmware in H-mode.

In this embodiment, the firmware SWPEE can be used with traditional classical (trap and emulate) isolation with PMP configuration for isolating different enclave SWPEEs or alternatively employs H-mode hypervisor extension based isolation, which utilizes PMP in conjunction with a second-stage hardware page-tables. The option of using both M-mode and H-mode isolation primitives is very useful for optimizing SoC space whether the firmware is instantiated within a FPGA or silicon (H-mode requires more space), thus allowing the sweet spot between performance and space usage to be achieved; H-mode isolation achieves better performance due to hardware support for interrupt and vprocessor handling as well as banked registers. System devices are isolated as MMIO regions via the PMP and/or the second-stage page tables (in case of H-mode).

### Shared Memory Communication and Enclave Orchestration

In one embodiment of the system of the present invention, a shared memory communication and enclave orchestration mechanism is implemented using a combination of HWPEEs and SWPEEs to enable efficient and secure inter-domain communication between enclaves. In this embodiment, a firmware SWPEE provides a dedicated interface for shared memory communication, allowing enclave SWPEEs to share memory pages with each other.

In this embodiment, the shared memory mechanism uses a shared memory access table (SMAT) implemented by a HWPEE to keep track of which memory pages are shared between enclave SWPEEs. When two enclave SWPEEs want to share memory, they create a shared page in their own memory address space and add an entry to the SMAT, specifying the shared page's memory address and the enclave IDs of the owners. The SMAT ensures that only authorized enclaves have access to each other's shared memory, providing a robust security model.

In this embodiment, the SMAT HWPEE uses a technique called “shared mapping” to map an enclave SWPEE's own memory address space onto the shared page. This allows the enclave SWPEE to access the shared memory directly without having to go through the firmware SWPEE. The use of SMAT HWPEE and shared mapping minimizes the number of processor cycles required to perform inter-enclave SWPEE communication, providing low overhead and high throughput.

In this embodiment, the SMAT HWPEE supports multiple types of inter-enclave SWPEE communication. In addition to simple shared memory operations, the SMAT HWPEE provides a more complex API called “events” that allows enclave SWPEEs to communicate with each other through a producer-consumer model.

In this embodiment, the firmware SWPEE supports the orchestration of two main types of enclave SWPEEs: management console enclave SWPEEs and worker enclave SWPEEs. The management console enclave is a special privileged enclave SWPEE that runs a high-assurance kernel and provides the management interface for managing other enclave SWPEEs. Worker enclave SWPEEs, on the other hand, run other operating system kernels or high-assurance kernels.

In this embodiment, the firmware SWPEE ensures that each enclave SWPEE is executed in a secure and isolated environment, using mechanisms such as page-based memory protection or region-based memory protection. The shared memory mechanism provides efficient inter-enclave communication while maintaining strong isolation guarantees between enclaves.

### Management Console Enclave

In one embodiment of the system of the present invention, a management console enclave is implemented via a SWPEE to orchestrate the creation and management of multiple virtual machines as additional SWPEEs. The management console enclave receives requests to allocate resources, such as memory and processor, for new domains and allocates these resources from its own pool or a dedicated pool for the worker enclave.

In this embodiment, the management console enclave SWPEE creates a new enclave by allocating resources and initializing the enclave's operating system kernel or high-assurance kernel and associated disk image. This process involves loading the OS/kernel into memory, configuring its network stack, and allocating storage devices. The user or administrator specifies configuration parameters for the new enclave, such as processor, memory, and network interfaces, which are stored in a configuration file and passed to the firmware as input when creating the new enclave.

In this embodiment, the management console enclave manages the worker enclaves once they are created, including tasks such as monitoring enclave resource usage, handling interrupts and events generated by the enclave, and providing a management interface for users to interact with the worker enclave. The management console enclave also ensures that each worker enclave is executed in a memory-isolated environment, using mechanisms such as page-based memory protection or region-based memory protection via dedicated HWPEEs.

In this embodiment, the management console enclave is based on Linux OS and provides services to provision and run a high-assurance kernel, such as seL4, in a worker enclave. The firmware instantiates multiple processor collections running Linux and seL4 side-by-side in a provably isolated manner, ensuring that each worker enclave is executed in a secure and isolated environment.

In this embodiment, a user-space application within the Linux management console enclave launches the high-assurance kernel in S-mode by invoking the firmware interface. This application allows for dynamic management and control of enclave instantiation and destruction, and passes relevant configuration information, such as memory allocation, processor affinity, disk devices, network interfaces, and other settings required to boot the high-assurance kernel. The application initiates the boot process of the high-assurance kernel within a specific processor, which is then executed within a memory-isolated SWPEE provided by the firmware, isolated from the Linux management console enclave SWPEE.

### Firmware Service Module

In one embodiment of the system of the present invention, a firmware service module is implemented as a SWPEE that provides interfaces to other SWPEEs, such as a hypervisor, operating system, application, or libraries. The firmware service module is designed to be flexible and extensible, allowing it to support multiple use cases and platform configurations.

In this embodiment, the firmware service module SWPEE defines a set of generic interfaces that can be implemented by different platform-specific implementations across various embodiments of the SoC. The firmware service module also provides a framework for adding new functionality and APIs, making it possible to extend its functionality as needed. This is achieved through the use of a modular design, which enables easy integration of new components and features.

In this embodiment, the firmware service module handles multiple service calls concurrently. This is achieved through the use of a lightweight synchronization mechanism that allows the OS PEE and firmware PEE to communicate efficiently without blocking each other's execution. In addition, the firmware service module PEE provides support for secure platform and processor interrupt initialization and handling, which enables the OS PEE to receive interrupts from hardware devices and process them accordingly.

In this embodiment, the firmware service module SWPEE also provides the ability to save and restore the state of user-level threads as defined by software components on top of the firmware service module. This allows the OS SWPEE or hypervisor SWPEE to securely and efficiently manage multiple threads and ensure that they are executed correctly. The firmware service module SWPEE achieves this through the use of a thread management mechanism, which enables efficient context switching and thread scheduling.

In this embodiment, the firmware service module SWPEE adheres to the RISC-V Supervisor Binary Interface (SBI) specification, which defines a standardized interface between the operating system and the platform-specific firmware. This allows for efficient and secure communication between these two components. The SBI specification and the firmware service module implementation provide a set of APIs that enable the OS to interact with the firmware, including functions such as timer management, interrupt handling, and console output.

In this embodiment, the firmware service module SWPEE is implemented using a combination of C and assembly language code. The firmware service module implementation provides a comprehensive set of SBI-compliant interfaces, including timer management, interrupt handling, and console output on a RISC-V based implementation.

### Softcore RISC-V Processor Using SoC With TPSM

In one embodiment of the system of the present invention, a softcore RISC-V processor with TPSM is realized via a combination of HWPEEs and SWPEEs using the SoC. In this embodiment, the RISC-V processor is implemented as a HWPEE and supports multiple hardware privileged modes (monitor, hypervisor, supervisor and user), providing a secure, flexible and efficient execution environment. The processor's architecture is optimized for secure computing applications, with features such as Privileged Memory Management (PMP) and IOMMU (Input/Output Memory Management Unit) integration along with secure interrupt delivery all implemented as individual HWPEEs.

In this embodiment, the RISC-V processor HWPEE is implemented in Verilog, utilizing the SystemVerilog language to facilitate simulation and verification. A custom instruction set architecture (ISA) is employed, which is compatible with the RISC-V specification. This allows for seamless integration with other RISC-V based systems, enabling a wide range of applications from embedded devices to security-sensitive computing platforms.

In this embodiment, the RISC-V processor HWPEE incorporates data/instruction cache partitioning, allowing for secure and efficient execution of complex workloads. The cache is divided into separate regions for data and instruction storage, ensuring security and optimal performance in scenarios where memory access patterns are highly localized. Additionally, the IOMMU HWPEE provides a secure and isolated environment for device DMA operations, preventing unauthorized access to sensitive data. In this embodiment, the RISC-V processor HWPEE boots a Linux kernel within a SWPEE. In this embodiment, the RISC-V processor HWPEE is loaded into a Field Programmable Grid Array (FPGA) embedded platform.

### Secure OS on a Cyber Physical System

Another embodiment of the system of the present invention consists of the integration of a secure operating system, specifically the seL4 microkernel, with a drone cyber physical platform. This integration enables the secure execution of critical functions on the drone, thereby ensuring the reliable and trustworthy operation of the device.

In this embodiment, the seL4 kernel is executed as a PEE and configured to provide a secure environment for executing sensitive code, including but not limited to, take-off and landing operations, navigation algorithms, and communication protocols. The drone cyber physical platform's software stack is composed of other PEEs and is integrated with the seL4 kernel PEE, allowing the execution of critical functions within the secure operating system.

In this embodiment, the integration of the seL4 kernel PEE with the drone cyber physical platform involves the SoC which is designed for robust security and to optimize performance on multi-core platforms with mathematically verified hardware and software co-design. The SoC enables secure and efficient resource utilization, ensuring that critical functions are executed in a timely manner while minimizing the risk of security breaches.

In this embodiment, the drone cyber physical platform's hardware components, including the processor, MMU, and communication interfaces, are implemented as HWPEEs to provide a secure and efficient computing platform. The seL4 kernel PEE is configured to take advantage of the HWPEE capabilities such as: Physical Memory Protection (PMP) and IOMMU (Input-Output Memory Management Unit), to prevent unauthorized access to sensitive data.

In this embodiment, the Physical Memory Protection (PMP) capabilities to safeguard critical system resources. PMP enables the seL4 kernel PEE to assign specific memory regions for executing sensitive code, preventing unauthorized access and ensuring the integrity of critical functions. Furthermore, the mathematically verified HWPEEs and SWPEEs include DMA attack prevention mechanisms to protect against malicious data transfer operations via SoC peripherals. These mechanisms ensure that only authorized peripherals can transfer data between the drone cyber physical platform's system memory and external peripherals, thereby preventing potential security breaches.

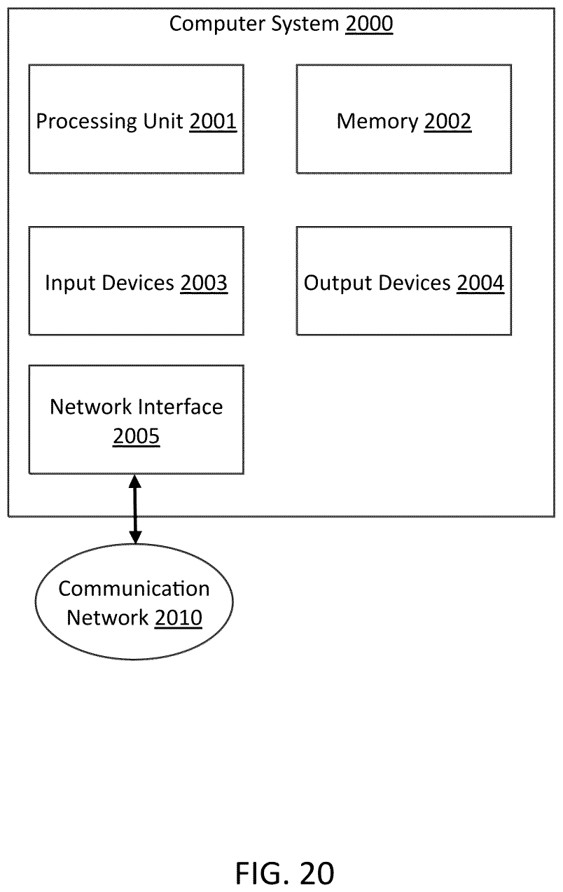

FIG. 20 shows, schematically, an illustrative computer system 2000 on which aspects of the present disclosure may be implemented. For example, computer system 2000 may be used to implement system 100 and/or the subsystems discussed herein. In the example of FIG. 20, the computer system 2000 includes a processing unit 2001 having one or more computer hardware processors and one or more articles of manufacture that comprise at least one non-transitory computer-readable storage medium (e.g., a memory 2002) that may include, for example, volatile and/or non-volatile memory. Memory 2002 may store one or more instructions to program the processing unit 2001 to perform any of the functions described herein. Memory 2002 may also store one or more application programs and/or resources used by application programs (e.g., software libraries). Different portions of memory 2002 may be used for different storage purposes. For example, a non-volatile portion of memory 2002 may be used for long term storage, while volatile memory may be used to facilitate fast access for processing unit 2002. Though, memory 2002 may include any suitable type or combination of types of computer storage media that are able to store data. To perform any of the illustrative functionalities described herein, processing unit 2001 may execute one or more processor-executable instructions stored in memory 2002, which may serve as non-transitory computer-readable media storing processor-executable instructions for execution by the processing unit 2001.

The computer system 2000 may have one or more input devices and/or output devices, such as devices 2003 and 2004 illustrated in FIG. 20. These devices may be used, for instance, to present a user interface. Examples of output devices that may be used to provide a user interface include printers, display screens, and other devices for visual output, speakers and other devices for audible output, braille displays and other devices for haptic output, etc. Examples of input devices that may be used for a user interface include keyboards, pointing devices (e.g., mice, touch pads, and digitizing tablets), microphones, etc. For instance, the input devices 2003 may include a microphone for capturing audio signals, and the output devices 2004 may include a display screen for visually rendering, and/or a speaker for audibly rendering, recognized text.

In the example of FIG. 20, computer system 2000 also includes one or more network interfaces (e.g., a network interface 2005) to enable communication via various networks (e.g., a network 2010). Computer networks include, for example and not limitation, local area networks (e.g., an enterprise network) and wide area networks (e.g., the Internet). Such networks may be based on any suitable technology operating according to any suitable protocol, and may include wireless networks and/or wired networks (e.g., fiber optic networks). It should be appreciated that components of computer system 2000 may be distributed across a computer network; this may be done, for example, to facilitate distributed processing, to achieve connectivity with (e.g., remote) input devices and/or output devices, or for any other suitable reason.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

In this respect, it should be appreciated that one implementation of the above-described embodiments comprises at least one computer-readable medium encoded with a computer program (e.g., a plurality of instructions), which, when executed on a processor, performs some or all of the above-discussed functions of these embodiments. As used herein, the term “computer-readable medium” encompasses only a computer-readable medium that can be considered to be a machine or a manufacture (i.e., article of manufacture). A computer-readable medium may be, for example, a tangible medium on which computer-readable information may be encoded or stored, a storage medium on which computer-readable information may be encoded or stored, and/or a non-transitory medium on which computer-readable information may be encoded or stored. Other non-exhaustive examples of computer-readable media include a computer memory (e.g., a ROM, a RAM, a flash memory, or other type of computer memory), a magnetic disc or tape, an optical disc, and/or other types of computer-readable media that can be considered to be a machine or a manufacture.

As used herein, a “set” may have one or more members. For example, “a set of programs” could have a single program or multiple programs. As used herein “subset” of a set may have the same number of members as the set or fewer members than the set but at least one member of the set. For example, a set of programs consisting of programs A, B, and C could be divided into the following seven subsets A; B; C; A, B; A, C; B, C; and A, B, C. A set may also be formed from other sets. For example, set X may be made up of set Y and set Z; that is set Y and set Z are each a subset of set X.

As used herein, two subsets of a set are “independent” subsets if each subset may include any one or more members of the set without restriction based on the membership of the other subset. Thus, independent subsets may be identical, partially overlapping, or mutually exclusive, however, independent subsets does not require that the subsets be capable of differing in a given implementation.

When recited in the claims that two or more subsets “may overlap,” or “may overlap in whole or in part,” such language indicates that the subsets are not required to be mutually exclusive or distinct. The phrase does not require that overlap occur, nor does it require that the subsets be capable of differing or overlapping in a given implementation. Rather, the phrase is intended to clarify that the claim scope includes implementations in which the subsets are identical, partially overlapping, or mutually exclusive.

As used herein, the term “or” is intended to mean an inclusive “or,” and is used interchangeably with “and/or,” unless the context clearly dictates otherwise. Thus, “A or B” encompasses “A alone,” “B alone,” and “both A and B together.” Only where the specification explicitly describes alternatives as being mutually exclusive, or where such exclusivity is otherwise clearly required by the context, should “or” be construed as an exclusive “or.”

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical values appeared in this specification are deemed modified by a term of degree thereby reflecting their intrinsic uncertainty.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A system comprising:
a set of hardware program execution elements (HWPEEs) for enforcing a trusted path security mechanism;
a computer platform having
programmable hardware implemented as at least one processor by a first subset of the HWPEEs, the first subset of HWPEEs defining internal functionality and operations of the at least one processor; and
at least one non-transitory computer-readable storage medium having stored thereon a set of program execution elements (PEEs), each PEE having a respective privilege level and a respective memory address space, the set of PEEs including the set of HWPEEs; and
a mathematical model of the computer platform, the mathematical model
having a formal representation of the at least one processor, the at least one non-transitory computer-readable storage medium, and the set of PEEs; and
defining and proving the trusted path security mechanism for the set of PEEs, the trusted path security mechanism enforcing permitted patterns of operations of the computer platform, the operations of the computer platform including at least one of (i) memory access operations; (ii) operations of the at least one processor including at least execution of processor instructions; and (iii) operations involving access to and manipulation of a state of the at least one processor (“processor state”), a state of the at least one non-transitory computer-readable storage medium (“memory state”), or a peripheral state.

2. The system of claim 1, wherein
the computer platform further comprises at least one peripheral implemented by a second subset of HWPEEs defining internal functionality and operations of the at least one peripheral, the first and second subsets of HWPEEs may overlap in whole or in part;
the mathematical model further includes a formal representation of the at least one peripheral;
the operations of the computer platform further include (iv) peripheral access operations; and
the peripheral state is the state of the at least one peripheral.

3. The system of claim 1, wherein
the trusted path security mechanism comprises a privilege-separation mechanism that enforces access controls on the operations of the computer platform that involve access to and manipulation of the processor state or the memory state; and
the access controls ensure that each of said operations of the computer platform is executed with a respective required privilege level.

4. The system of claim 1, wherein
the operations of the computer platform include the memory access operations; and
the trusted path security mechanism includes a memory-safety mechanism to ensure that all the memory access operations are valid.

5. The system of claim 1, wherein
the trusted path security mechanism comprises a control-flow integrity (CFI) mechanism to ensure that execution of PEEs follows the permitted patterns.

6. The system of claim 1, wherein
the mathematical model (i) defines operational aspects of hardware elements and software stack elements, (ii) defines predicates for security mechanisms on the computer platform that are translatable to proof obligations in a composable manner, and (iii) interprets and verifies the proof obligations;
the hardware elements comprise a first subset of the set of PEEs; and
the software stack elements comprise a second subset of the set of PEEs, the second subset not including any PEE in the set of HWPEEs.

7. The system of claim 1, wherein
a first subset of the set of PEEs are implemented in a low-level programming language;
a second subset of the set of PEEs are implemented in a high-level programming language;
the PEEs in the first subset enforce the trusted path security mechanism; and
the PEEs in the second subset enforce the trusted path security mechanism.

8. The system of claim 1, wherein the mathematical model
(i) defines a first subset of the set of PEEs that are implemented in a low-level programming language;
(ii) defines a second subset of the set of PEEs that are implemented in a high-level programming language; and
(iii) defines and proves the trusted path security mechanism of the union of the PEEs of the first subset and the PEEs in the second subset.

9. The system of claim 1, wherein
each PEE in a subset of the set of PEEs includes
one or more functions to form an atomic unit of functionality of the PEE; and
a memory map in the respective memory address space, the memory map comprising one or more of the group consisting of code regions, global data variables, heaps, and stacks;
the memory map is randomized at a time the respective PEE is loaded into its respective memory address space.

10. A system comprising:
a set of hardware program execution elements (HWPEEs);
a computer platform having
programmable hardware implemented as at least one processor by a first subset of the HWPEEs, the first subset of HWPEEs defining internal functionality and operations of the at least one processor; and
at least one non-transitory computer-readable storage medium having stored thereon a set of program execution elements (PEEs) each having a respective privilege level in a respective memory address space, the set of PEEs including the set of HWPEEs, the set of PEEs enforcing security through an interface confined security mechanism (ICSM) comprising a subset of the set of PEEs (ICSM PEEs) that establish boundary limiting interactions (bastion interfaces) with resources of the computer platform for a second subset of the set of PEEs; and
a mathematical model of the computer platform having a formal representation of the at least one processor and the at least one non-transitory computer-readable storage medium, the mathematical model defining and proving the ICSM for the set of PEEs, and the mathematical model having at least one adversary model for each of the bastion interfaces,
wherein
the ICSM ensures security mechanisms of the computer platform by enforcing the bastion interfaces, and
the first subset of HWPEEs, the second subset of PEEs and the ICSM PEEs may overlap in whole or in part.

11. The system of claim 10, wherein the computer platform further comprises at least one peripheral, and the formal representation in the mathematical model further includes HWPEEs that define and implement internal functionality and operations of the at least one peripheral.

12. The system of 11, wherein
the ICSM PEEs comprises a privilege-separation mechanism to enforce access controls on operations of the computer platform that involve peripheral access, or access to and manipulation of peripheral state; and
the access controls ensure that each of the operations is executed with a privilege level required to perform the operation.

13. The system of claim 10, wherein
the mathematical model further (i) defines operational aspects of hardware elements and software stack elements, (ii) defines predicates for the security mechanisms of the computer platform that are translatable to proof obligations, and (iii) includes a theorem prover to interpret and verify the proof obligations;
the hardware elements comprise a third subset of the set of PEEs;
the software stack elements comprise a fourth subset of the set of PEEs that does not include HWPEEs; and
the first-fourth subset and the ICSM PEEs may overlap in whole or in part.

14. The system of 10, wherein the ICSM PEEs comprises a memory-safety mechanism to ensure that all memory access operations are valid.

15. The system of 10, wherein the ICSM PEEs comprises a control-flow integrity mechanism to ensure that execution of ICSM PEEs follows authorized patterns.

16. The system of 10, wherein
the ICSM PEEs comprises a privilege-separation mechanism to enforce access controls on operations of the computer platform that involve access to and manipulation of processor state or memory state; and
the access controls ensure that each of the operations is executed with a privilege level required to perform the operation.

17. A system for providing formal verification of a design and operation of a computer platform, the system comprising:
a processor; and
a first non-transitory computer-readable storage medium having stored thereon instructions that, when executed, program the processor to perform acts of
evaluating a mathematical model that
(i) models the computer platform with a formal representation of a set of PEEs, each PEE in the set of PEEs modelled as having a respective privilege level in a respective memory address space of platform memory of the computer platform, the set of PEEs including a set of hardware PEEs (HWPEEs), the set of HWPEEs modelled as executable by a finite-state machine and as defining and implementing internal functionality and operations of one or more platform processors of the computer platform and one or more platform memory controllers of the computer platform; and
(ii) specifies invariants to enforce an interface confined security mechanism (ICSM) with assume-guarantee interface-confined mathematical reasoning; and
determining from the evaluating that the ICSM holds true for the computer platform.

18. The system of claim 17, wherein
the mathematical model has a formal representation of a set of software PEEs (SWPEE);
the set of PEEs is a union of the set of HWPEEs and a set of SWPEEs; and
each PEE in the set of SWPEEs is modelled as executable by the at least one platform processor.

19. The system of claim 17, wherein the ICSM comprises a trusted path security mechanism.

20. The system of claim 17, wherein the mathematical model further comprises an idiomatic representation of the PEE code that describes the operation of the PEE code and allows proving composition of ICSM across the PEEs in the set of PEEs.

21. The system of claim 17, wherein the act of determining comprises determining from the evaluation whether the ICSM holds true for the computer platform regardless of a composition of the PEEs of the set of PEEs of the computer platform.

22. The system of claim 17, wherein the formal representation in the mathematical model further includes a subset of the set of PEEs that are adversary-controlled and at least one adversary model for each of the adversary-controlled PEEs.

23. The system of claim 17, further comprising a mathematical model implementation validation mechanism to validate that the set of PEEs implement the ICSM specified in the mathematical model.

24. The system of claim 17, wherein
a first subset of the set of PEEs are implemented in a low-level programming language;
a second subset of the set of PEEs are implemented in a high-level programming language; and
the mathematical model ensures a composition of the ICSM of the union of the PEEs of the first subset and the PEEs in the second subset.

25. The system of claim 17, wherein the formal representation further comprises (i) an interface defined for each PEE in the set of PEEs, wherein the interface includes conditions that must be met before and after execution of one or more PEE functions of the respective PEE; (ii) a specification of the platform memory and memory regions accessible for each PEE in the set of PEEs; (iii) a representation of conditions as predicates over one or more states of the platform memory and one or more states of the one or more platform processors, where the predicates indicate whether the one or more states of the platform memory and the one or more states of the one or more platform processors satisfy the conditions; and (iv) enforced invariants of the ICSM at a start and at an end of each PEE function execution.

26. The system of claim 17, wherein
the formal representation comprises
first instructions, executable by the processor, for defining an initial configuration of the one or more platform processors and an initial global platform memory state;
second instructions, executable by the processor, for executing a series of concurrent steps on each of the one or more platform processors, wherein each step is associated an operation being performed and a first PEE in the set of PEEs associated with the operation; and
third instructions, executable by the processor, for managing an internal state of each of the one or more platform processors, starting new threads, and assigning memory addresses to each thread; and
the ICSM is enforced by checking corresponding invariants for each PEE function call.

27. The system of claim 17, wherein the mathematical model includes a formal representation of the ICSM, and the ICSM further includes a memory-safety mechanism to ensure that all memory access operations on the computer platform are valid.

28. The system of claim 17, wherein the mathematical model includes a formal representation of the ICSM, and the ICSM further includes a control-flow integrity mechanism that ensures that execution of PEEs by the one or more platform processors follows authorized patterns and do not compromise the integrity of the computer platform.

29. The system of claim 17, wherein
the mathematical model includes a formal representation of the ICSM that further includes a privilege-separation mechanism that enforces access controls on operations of the computer platform that involve peripheral access, or access to and manipulation of the one or more platform processors'state or the platform memory's state; and
the access controls ensure that each of said operations is executed with a privilege level required to perform the operation.

30. A non-transitory computer-readable storage medium storing computer-executable instructions that, when executed by programmable hardware, cause the programmable hardware to perform a respective operation, the computer-executable instructions comprising:
a set of program execution elements (PEEs), each PEE of the set of PEEs, when executed, having a respective privilege level, is in a respective memory address space, the set of PEEs including a set of hardware PEEs (HWPEEs), the set of HWPEEs including a first subset of the HWPEEs that define internal functionality and operations of a platform processor; and
an interface confined security mechanism (ICSM) through which the set of PEEs enforce security, the ICSM comprising a subset of the set of PEEs (ICSM PEEs) that establish boundary limiting interactions (bastion interfaces) with resources of a computer platform for a second subset of the set of PEEs, the ICSM ensuring security mechanisms of the computer platform by enforcing the bastion interfaces,
wherein the first subset of HWPEEs, the second subset of PEEs, and the ICSM PEEs may overlap in whole or in part.
